(19) United States
(12) Patent Application Publication
(10) Pub. No.: US 2026/0350045 A1
(43) Pub. Date: Nov. 5, 2026

(54) SYSTEMS AND METHODS FOR CONFIGURATION, EVALUATION, AND DEPLOYMENT OF RETRIEVAL-AUGMENTED GENERATION APPLICATIONS USING MULTIPLE VECTORIZATION PIPELINES

(71) Applicant: SAS INSTITUTE INC., Cary, NC (US)

(72) Inventors: Saurabh Mishra, Cary, NC (US); Daniele Cazzari, Leini (IT); Joshua Lloyd Anderson, Chicago, IL (US); Benjamin John Nibbelink, Charlotte, NC (US); Timothy Vandenbrande, Geoferdinge (BE)

(73) Assignee: SAS Institute Inc., Cary, NC (US)

(21) Appl. No.: 19/442,465

(22) Filed: Jan. 7, 2026

Related U.S. Application Data
(60) Provisional application No. 63/799,433, filed on May 3, 2025.

(51) Int. Cl. G06F 16/31; G06F 40/289; G06V 30/19; G06V 30/412

(52) U.S. Cl. CPC G06F 16/316; G06F 40/289; G06V 30/19113; G06V 30/412

(57) ABSTRACT

A system, method, and computer-program product includes displaying, via a user interface, a plurality of selectable representations corresponding to a plurality of collection objects; receiving, via the user interface, a selection of a selectable representation of the plurality of selectable representations displayed on the user interface; displaying, via the user interface, a collection-specific configuration page for the respective collection object corresponding to the selectable representation and including a vector configuration data structure comprising a plurality of entries corresponding to a plurality of candidate vector configurations for a retrieval-augmented generation (RAG) application; receiving, via the user interface, a selection of a vector configuration status cell within a respective entry; displaying, in association with the respective entry, an expandable menu including a plurality of selectable vector configuration status options; and receiving, while the expandable menu is being displayed, a selection of a champion vector configuration status option.

### CROSS-REFERENCE TO RELATED APPLICATIONS

This application claims the benefit of priority to U.S. Patent Application No. 63/799,433, filed on May 3 2025, incorporated herein by reference in its entirety for all purposes.

### TECHNICAL FIELD

The embodiments described herein relate generally to information retrieval and natural language processing and, more specifically, to configuration, evaluation, and deployment of retrieval-augmented generation applications.

### BACKGROUND

Systems that generate natural language output based on external data sources are commonly used to support information access, decision support, and automated assistance across a range of computing environments. Such systems often rely on representations of data that enable efficient searching, ranking, or retrieval in response to input queries. The manner in which data is prepared and represented for use by these systems can influence system behavior, performance, and resource consumption.

In many deployments, data preparation and representation processes are performed using combinations of software components that are configured prior to use and remain unchanged during operation. Modifying how data is prepared or represented may involve manual intervention, specialized technical knowledge, or coordination across multiple tools or services. These factors can increase development effort and limit adaptability as data sources, usage patterns, or operational constraints change over time.

### BRIEF SUMMARY OF THE INVENTION

In some embodiments, a computer-program product comprises a non-transitory machine-readable storage medium storing computer instructions that, when executed by processing circuitry, perform operations comprising: displaying, via a user interface, a plurality of selectable representations corresponding to a plurality of collection objects, wherein each selectable representation of the plurality of selectable representations corresponds to a respective collection object of the plurality of collection objects; receiving, via the user interface, a selection of a selectable representation of the plurality of selectable representations displayed on the user interface; in response to receiving the selection of the selectable representation, displaying, via the user interface, a collection-specific configuration page for the respective collection object corresponding to the selectable representation, wherein: the collection-specific configuration page includes a vector configuration data structure comprising a plurality of entries corresponding to a plurality of candidate vector configurations for a retrieval-augmented generation (RAG) application, and each entry of the plurality of entries corresponds to a respective candidate vector configuration of the plurality of candidate vector configurations; receiving, via the user interface, a selection of a vector configuration status cell within a respective entry of the plurality of entries of the vector configuration data structure; displaying, in association with the respective entry, an expandable menu comprising a plurality of selectable vector configuration status options in response to receiving the selection of the vector configuration status cell within the respective entry; receiving, while the expandable menu is being displayed in association with the respective entry, a selection of a champion vector configuration status option of the plurality of selectable vector configuration status options; in response to receiving the selection of the champion vector configuration status option, converting the respective candidate vector configuration corresponding to the respective entry to a champion vector configuration; and deploying the RAG application for responding to user queries based in part on the champion vector configuration.

In some embodiments, the computer instructions, when executed by the processing circuitry, perform the operations further comprising: receiving, via the user interface, a first user input for navigating from a workspace summary view to an automated evaluation view; ceasing displaying, in the collection-specific configuration page, the vector configuration data structure in response to receiving the first user input for navigating to the automated evaluation view; and after receiving the first user input: receiving, via the user interface, a second user input selecting a perform automated evaluation selectable object; in response to receiving the second user input, displaying an automated configuration popover at least comprising a source coverage input element and a confirm automated evaluation control; receiving, via the source coverage input element, a third user input specifying a target percentage of coverage for one or more data sources associated with the respective collection object; receiving a fourth user input selecting the confirm automated evaluation control; in response to receiving the fourth user input, generating a plurality of automated test cases generated to satisfy the target percentage of coverage; and in response to receiving one or more fifth user inputs, executing an automated evaluation of a reference candidate vector configuration based on the plurality of automated test cases.

In some embodiments, the automated configuration popover further includes one or more of: a generator language model selection input element, and a reference candidate vector configuration input element, the computer instructions, when executed by the processing circuitry, perform the operations comprising one or more of: receiving, via the generator language model selection input element, a sixth user input specifying a generator language model; and receiving, via the reference candidate vector configuration input element, a seventh user input specifying the reference candidate vector configuration of the plurality of candidate vector configurations, and the generator language model at least uses vector embeddings associated with the reference candidate vector configuration to generate the plurality of automated test cases.

In some embodiments, the computer instructions, when executed by the processing circuitry, perform the operations further comprising: while the user interface is displaying the automated evaluation view and in response to receiving the fourth user input selecting the confirm automated evaluation control: updating an automated evaluation data table to include a plurality of new entries corresponding to the plurality of automated test cases, wherein each of the plurality of new entries at least includes one or more of: a question generated by a generator language model that contributes toward satisfying the target percentage of coverage across the one or more data sources; a context comprising text of one or more documents retrieved based on a similarity between the question and vector embeddings associated with the reference candidate vector configuration; a ground truth answer that the generator language model produced based on the context; and a total number of tokens used by the generator language model to produce the ground truth answer.

In some embodiments, the computer instructions, when executed by the processing circuitry, perform the operations further comprising: while the user interface is displaying the automated evaluation view and in response to receiving the one or more fifth user inputs: updating an automated evaluation results table to include a new entry corresponding to the automated evaluation of the reference candidate vector configuration, wherein the new entry at least includes one or more of: a first RAG efficacy value determined based on a critic language model and a critic embedding model evaluating responses included in the plurality of automated test cases; a progress status indicator indicating a percentage of completion for the automated evaluation of the reference candidate vector configuration; and a cost value indicating a total computational cost associated with performing the automated evaluation of the reference candidate vector configuration.

In some embodiments, the RAG application comprises a language model configured to respond to the user queries based in part on the respective candidate vector configuration designated as the champion vector configuration, a first respective candidate vector configuration of the plurality of candidate vector configurations is the respective candidate vector configuration corresponding to the respective entry, and the respective entry at least further includes one or more of: a vectorization job status cell that indicates a completion status of a vectorization job associated with the first respective candidate vector configuration; a first RAG efficacy value cell that indicates a first performance of the RAG application on a plurality of automatically generated test cases; and a second RAG efficacy value cell that indicates a second performance of the RAG application on a plurality of user-defined test cases.

In some embodiments, the first RAG efficacy value cell presents the first performance of the RAG application using a combination of a horizonal progress bar and a percentage label, the second RAG efficacy value cell presents the second performance of the RAG as a fraction indicating a number of user-defined test cases that passed out of the plurality of user-defined test cases, and the number of user-defined test cases that passed out of the plurality of user-defined test cases is selectable to display test parameters and results associated with the plurality of user-defined test cases.

In some embodiments, the computer instructions, when executed by the processing circuitry, perform the operations further comprising: in response to receiving the selection of the champion vector configuration status option, updating the vector configuration status cell in the respective entry to a champion status value indicating that the respective candidate vector configuration corresponding to the respective entry is designated as the champion vector configuration.

In some embodiments, the plurality of selectable representations corresponding to the plurality of collection objects are concurrently displayed with a create new collection selectable object, and the computer instructions, when executed by the processing circuitry, perform the operations further comprising: receiving, via the user interface, a selection of the create new collection selectable object; in response to receiving the selection of the create new collection selectable object, inserting at least a collection source selection element into the create new collection selectable object; receiving, via the collection source selection element, a first user input defining one or more data sources; creating a new collection object based at least on the one or more data sources defined via the collection source selection element; and in response to creating the new collection object, adding a new selectable representation corresponding to the new collection object in the user interface.

In some embodiments, a collection name input element and a collection description input element is further inserted into the create new collection selectable object in response to receiving the selection of the create new collection selectable object, the computer instructions, when executed by the processing circuitry, perform the operations further comprising one or more of: receiving, via the collection name input element, a second user input defining a name of the new collection object; and receiving, via the collection description input element, a third user input defining a description of the new collection object, and the new collection object is created based on the one or more data sources defined via the collection source selection element, the name defined via the collection name input element, and the description defined via the collection description input element.

In some embodiments, in response to receiving the selection of the create new collection selectable object, a save selectable object and a cancel selectable object is further inserted into the create new collection selectable object, the new collection object is created based on the one or more data sources when a selection of the save selectable object is detected, and the new collection object is not created based on the one or more data sources when a selection of the cancel selectable object is detected.

In some embodiments, the respective collection object corresponding to the selectable representation represents a grouping of one or more data sources, the plurality of candidate vector configurations, and a set of tests for evaluating a performance of the RAG application, and each remaining collection object of the plurality of collection objects corresponds to a different grouping of data sources, candidate vector configurations, and tests for evaluating different RAG applications.

In some embodiments, a second collection object of the plurality of collection objects is associated with a second plurality of candidate vector configurations, different from the plurality of candidate vector configurations associated with the respective collection object, and the collection-specific configuration page for the respective collection object does not display user interface elements corresponding to the second plurality of candidate vector configurations.

In some embodiments, the computer instructions, when executed by the processing circuitry, perform the operations further comprising: while the respective entry is selected in the vector configuration data structure, receiving a first user input selecting an execute vectorization selectable object displayed in association with the vector configuration data structure; in response to receiving the first user input selecting the execute vectorization selectable object, displaying, via the user interface, a vectorization job submission popover comprising at least an execution provider input element; receiving, via the execution provider input element, a second user input specifying an execution provider; and submitting a vectorization job to the execution provider in response to receiving a third user input selecting a submit vectorization job selectable option.

In some embodiments, the respective collection object is associated with one or more data sources, and a plurality of vector embeddings that numerically represent the one or more data sources are received after submitting the vectorization job to the execution provider, and in response to receiving the plurality of vector embeddings, a vectorization job status cell of the respective entry is updated to a new job status value indicating that the execution provider has finished the vectorization job.

In some embodiments, the vectorization job submission popover further comprises at least one of: a CPU allocation input element, a memory allocation input element, and a hardware device input element, the computer instructions, when executed by the processing circuitry, perform the operations further comprising at least one of: receiving, via the CPU allocation input element, a fourth user input specifying a number of CPU processing units; receiving, via the memory allocation input element, a fifth user input specifying an amount of memory; receiving, via the hardware device input element, a sixth user input specifying a target hardware device, and the vectorization job submitted to the execution provider requests the execution provider to convert one or more data sources associated with the respective collection object to a plurality of vector embeddings using the number of CPU processing units, the amount of memory, and the target hardware device.

In some embodiments, the computer instructions, when executed by the processing circuitry, perform the operations further comprising: receiving, via the user interface, a first user input selecting a create new candidate vector configuration object displayed in association with the vector configuration data structure; in response to receiving the first user input, displaying, via the user interface, a candidate vector configuration creation popover comprising at least a first selectable configuration section, wherein the first selectable configuration section at least comprises a vector configuration update strategy selectable option; receiving, via the vector configuration update strategy selectable option, a second user input selecting an update strategy for updating corresponding vector embeddings when changes to one or more data sources associated with the respective collection object are detected; and in response to receiving a third user input selecting a save selectable object: creating a new candidate vector configuration based at least on the update strategy selected via the vector configuration update strategy selectable option, and adding a new entry corresponding to the new candidate vector configuration to the vector configuration data structure.

In some embodiments, the first selectable configuration section further comprises at least one of: a configuration name input field, a configuration description input field, an embedding model selection input element, a compression enablement control element, a quantization enablement control element, and a vector database destination selection input element, and the computer instructions, when executed by the processing circuitry, perform the operations further comprising at least one of: receiving, via the configuration name input field, a fourth user input specifying a name of the new candidate vector configuration; receiving, via the configuration description input field, a fifth user input specifying a description of the new candidate vector configuration; receiving, via the embedding model selection input element, a sixth user input selecting an embedding model associated with the new candidate vector configuration; receiving, via the compression enablement control element, a seventh user input indicating whether to compress vector embeddings associated with the new candidate vector configuration; receiving, via the quantization enablement control element, an eighth user input indicating whether to quantize the vector embeddings associated with the new candidate vector configuration; and receiving, via the vector database destination selection input element, a ninth user input selecting a vector database destination to store the vector embeddings associated with the new candidate vector configuration, and the new candidate vector configuration is further created based on the fourth, the fifth, the sixth, the seventh, the eighth, and the ninth user input.

In some embodiments, the respective collection object is associated with one or more data sources comprising a plurality of documents, the candidate vector configuration creation popover at least further comprises a second selectable configuration section, wherein the second selectable configuration section at least comprises a data source ingestion subsection, the data source ingestion subsection of the second selectable configuration section at least includes a plurality of selectable document formats, the computer instructions, when executed by the processing circuitry, perform the operations further comprising: receiving a fourth user input selecting a subset of the plurality of document formats, and the new candidate vector configuration is configured to ignore a subset of the plurality of documents that correspond to the subset of the plurality of document formats during vectorization of the one or more data sources.

In some embodiments, the data source ingestion subsection further includes a text cleaning selectable element, the computer instructions, when executed by the processing circuitry, perform the operations further comprising: receiving, via the text cleaning selectable element, a fifth user input indicating whether automatic text cleaning is enabled, and the new candidate vector configuration is further configured to automatically clean a remainder of the plurality of documents during vectorization of the one or more data sources if the fifth user input enabled the automatic text cleaning.

In some embodiments, the respective collection object is associated with one or more data sources comprising a plurality of documents, the candidate vector configuration creation popover at least further comprises a second selectable configuration section, wherein the second selectable configuration selection at least comprises a chunking policy subsection, the chunking policy subsection of the second selectable configuration section at least includes a chunk overlap input element, the computer instructions, when executed by the processing circuitry, perform the operations further comprising: receiving, via the chunk overlap input element, a fourth user input specifying a chunk overlap value, and the new candidate vector configuration is configured to segment text associated with the plurality of documents into a plurality of chunks in accordance with the chunk overlap value.

In some embodiments, the chunking policy subsection further includes at least one of: a chunk size input element; and a minimum chunk size input element, and the computer instructions, when executed by the processing circuitry, perform the operations further comprising at least one of: receiving, via the chunk size input element, a fifth user input specifying a maximum chunk size; and receiving, via the minimum chunk size input element, a sixth user input specifying a minimum chunk size, and the new candidate vector configuration is further configured to segment the text associated with the plurality of documents into the plurality of chunks in accordance with the chunk overlap value, the maximum chunk size, and the minimum chunk size.

In some embodiments, the respective collection object is associated with one or more data sources comprising a plurality of documents, the candidate vector configuration creation popover at least further comprises a second selectable configuration section, wherein the second selectable configuration section includes an optical character recognition (OCR) settings subsection that is displayed when an OCR control element is enabled, the OCR settings subsection includes one or more of: an OCR library selection input element and an OCR language selection input element; the computer instructions, when executed by the processing circuitry, perform the operations further comprising at least one of: receiving, via the OCR library selection input element, a fourth user input specifying an OCR library; and receiving, via the OCR language selection input element, a fifth user input specifying an OCR language, and the new candidate vector configuration is configured to extract text from the plurality of documents using the OCR library and the OCR language.

In some embodiments, the second selectable configuration section further includes a table extraction settings subsection that is displayed when an export tables control element is enabled, the table extraction settings subsection at least includes a table detection threshold input element, the computer instructions, when executed by the processing circuitry, perform the operations further comprising: receiving, via the table detection threshold input element, a sixth user input specifying a maximum number of tables to extract from the one or more data sources, and the new candidate vector configuration is configured to extract the text and a plurality of tables from the plurality of documents using the OCR library and the OCR language in accordance with the maximum number of tables.

In some embodiments, the table extraction settings subsection further includes one or more of: a table export format selection input element, an implicit row detection control element, and an implicit column detection control element, the computer instructions, when executed by the processing circuitry, perform the operations further comprising one or more of: receiving, via the table export format selection input element, a seventh user input specifying an export format for the plurality of tables, receiving, via the implicit row detection control element, an eight user input indicating whether implicit rows are to be detected in the one or more data sources; and receiving, via the implicit column detection control element, a ninth user input indicating whether implicit columns are to be detected in the one or more data sources, and the new candidate vector configuration is configured to extract the plurality of tables from the plurality of documents in accordance with the seventh, the eighth, and the ninth user input.

In some embodiments, the computer instructions, when executed by the processing circuitry, perform the operations further comprising: receiving, via the user interface, a first user input selecting a chat selectable object; displaying a chat settings configuration page in response to receiving the first user input, wherein the chat settings configuration page at least includes a collection selection input element displaying a second plurality of entries corresponding to the plurality of collection objects; receiving, via the collection selection input element, a second user input selecting a second respective entry corresponding to the respective collection object and one or more third respective entries corresponding to one or more second collection objects; and displaying, in the chat settings configuration page, a chat session configured based at least on the second user input selecting the second respective entry corresponding to the respective collection object and the one or more third respective entries corresponding to the one or more second collection objects.

In some embodiments, the chat settings configuration page further includes a language model selection input element and a retrieval settings input element, the computer instructions, when executed by the processing circuitry, perform the operations further comprising one or more of: receiving, via the language model selection input element, a third user input specifying a language model to generate responses for the chat session; and receiving, via the retrieval settings input element, a fourth user input specifying a retrieval setting that determines how context is retrieved from the respective collection object, and the chat session is further configured based on the third user input specifying the language model and the fourth user input specifying the retrieval setting.

In some embodiments, each entry of the plurality of entries further includes at least one RAG efficacy value that indicates a performance of the RAG application when using the respective candidate vector configuration, the vector configuration data structure corresponds to a table, the plurality of entries correspond to rows of the table, the respective collection object is associated with one or more data sources, and the computer instructions, when executed by the processing circuitry, perform the operations further comprising: receiving, via the chat session, a user prompt comprising a question, displaying, via the chat session, a response to the user prompt generated by the language model based at least in part on vector embeddings associated with the respective collection object, wherein the response is displayed in association with a citation selectable object that is selectable to display one or more portions of the one or more data sources used by the language model to generate the response.

In some embodiments, a computer-implemented method may comprise displaying, via a user interface, a plurality of selectable representations corresponding to a plurality of collection objects, wherein each selectable representation of the plurality of selectable representations corresponds to a respective collection object of the plurality of collection objects; receiving, via the user interface, a selection of a selectable representation of the plurality of selectable representations displayed on the user interface; in response to receiving the selection of the selectable representation, displaying, via the user interface, a collection-specific configuration page for the respective collection object corresponding to the selectable representation, wherein: the collection-specific configuration page includes a vector configuration data structure comprising a plurality of entries corresponding to a plurality of candidate vector configurations for a retrieval-augmented generation (RAG) application, and each entry of the plurality of entries corresponds to a respective candidate vector configuration of the plurality of candidate vector configurations; receiving, via the user interface, a selection of a vector configuration status cell within a respective entry of the plurality of entries of the vector configuration data structure; displaying, in association with the respective entry, an expandable menu comprising a plurality of selectable vector configuration status options in response to receiving the selection of the vector configuration status cell within the respective entry; receiving, while the expandable menu is being displayed in association with the respective entry, a selection of a champion vector configuration status option of the plurality of selectable vector configuration status options; in response to receiving the selection of the champion vector configuration status option, converting the respective candidate vector configuration corresponding to the respective entry to a champion vector configuration; and deploying the RAG application for responding to user queries based in part on the champion vector configuration.

In some embodiments, a computer-implemented system may comprise processing circuitry; a memory; and a computer-readable medium operably coupled to the processing circuitry the computer-readable medium having computer-readable instructions stored thereon that, when executed by the processing circuitry, cause a computing device to perform operations comprising: displaying, via a user interface, a plurality of selectable representations corresponding to a plurality of collection objects, wherein each selectable representation of the plurality of selectable representations corresponds to a respective collection object of the plurality of collection objects; receiving, via the user interface, a selection of a selectable representation of the plurality of selectable representations displayed on the user interface; in response to receiving the selection of the selectable representation, displaying, via the user interface, a collection-specific configuration page for the respective collection object corresponding to the selectable representation, wherein: the collection-specific configuration page includes a vector configuration data structure comprising a plurality of entries corresponding to a plurality of candidate vector configurations for a retrieval-augmented generation (RAG) application, and each entry of the plurality of entries corresponds to a respective candidate vector configuration of the plurality of candidate vector configurations; receiving, via the user interface, a selection of a vector configuration status cell within a respective entry of the plurality of entries of the vector configuration data structure; displaying, in association with the respective entry, an expandable menu comprising a plurality of selectable vector configuration status options in response to receiving the selection of the vector configuration status cell within the respective entry; receiving, while the expandable menu is being displayed in association with the respective entry, a selection of a champion vector configuration status option of the plurality of selectable vector configuration status options; in response to receiving the selection of the champion vector configuration status option, converting the respective candidate vector configuration corresponding to the respective entry to a champion vector configuration; and deploying the RAG application for responding to user queries based in part on the champion vector configuration.

In some embodiments, a computer-program product comprising a non-transitory machine-readable storage medium storing computer instructions that, when executed by processing circuity, perform operations comprising: at a first stage of a retrieval-augmented-generation (RAG) application development pipeline: receiving, at a graphical user interface displaying a collection object, a set of vector configuration parameters for controlling a vectorization of one or more unstructured data sources associated with the collection object; in response to receiving the set of vector configuration parameters, generating, within the collection object, a vector configuration data object that includes the set of vector configuration parameters; generating, using a vectorization service of the RAG application development pipeline, a plurality of vector embeddings that numerically represent the one or more unstructured data sources in response to the vectorization service receiving a request to perform the vectorization of the one or more unstructured data sources; and associating the plurality of vector embeddings generated for the one or more unstructured data sources with the vector configuration data object; at a second stage of the RAG application development pipeline: executing an application performance assessment that assesses a behavior of a RAG application in generating responses based in part on the plurality of vector embeddings associated with the vector configuration data object; and electing the vector configuration data object as a champion vector configuration based on application performance findings outputted by the application performance assessment; and at a third stage of the RAG application development pipeline: deploying the RAG application, wherein the RAG application is operably configured to respond to natural language input using a large language model and the champion vector configuration.

In some embodiments, the computer instructions, when executed by the processing circuity, perform operations further comprising: instantiating a vector configuration popover in response to receiving an input from a user selecting a new vector configuration button displayed on the graphical user interface, wherein: the graphical user interface further displays the vector configuration popover, and the vector configuration popover includes a set of user interface control elements that receives the set of vector configuration parameters from the user.

In some embodiments, the set of vector configuration parameters includes: a set of document ingestion parameters specifying which unstructured documents included in the one or more unstructured data sources are to be vectorized by the vectorization service, a set of text extraction parameters that controls a text extraction process performed by the vectorization service, wherein the text extraction process extracts textual content from the unstructured documents, a set of text chunking parameters that controls a text chunking process performed by the vectorization service, wherein the text chunking process segments the textual content into a plurality of text segments, and a set of embedding generation parameters that controls an embedding generation process performed by the vectorization service, wherein the embedding generation process generates the plurality of vector embeddings based on the plurality of text segments.

In some embodiments, the set of document ingestion parameters includes: a set of prohibited file extensions selected by a user, wherein each unstructured document of the unstructured documents has a file extension that does not correspond to any file extension included in the set of prohibited file extensions, and a text cleaning parameter that instructs the vectorization service to remove characters corresponding to a target character type from the textual content.

In some embodiments, the set of text extraction parameters includes: an optical character recognition (OCR) parameter that instructs the text extraction process to extract the textual content from the unstructured documents by executing an OCR process; an OCR algorithm parameter that specifies a target OCR algorithm of a plurality of predetermined OCR algorithms to be used by the OCR process for extracting the textual content from the unstructured documents, and an OCR language parameter that specifies a human language associated with the unstructured documents.

In some embodiments, the set of text extraction parameters further includes: a data table parameter that instructs the text extraction process to extract data tables from the unstructured documents by executing a tabular data extraction process; a borderless data table detection parameter that instructs the tabular data extraction process to detect and extract borderless-type data tables from the unstructured documents, a data table export parameter that specifies a target format for representing the data tables and the borderless-type data tables extracted from the unstructured documents, and a data table detection sensitivity value, wherein the tabular data extraction process uses the data table detection sensitivity value to control whether a respective portion of the unstructured documents is detected as a tabular data structure.

In some embodiments, the set of text extraction parameters further includes: an implicit row detection parameter that instructs the tabular data extraction process to detect and extract tabular rows included in the unstructured documents that are not explicitly separated by row boundaries, and an implicit column detection parameter that instructs the tabular data extraction process to detect and extract tabular columns included in the unstructured documents that are not explicitly separated by column boundaries.

In some embodiments, the set of text chunking parameters includes: a maximum text chunk size value, a minimum text chunk size value, and a text chunk overlap value, wherein the maximum text chunk size value, the minimum text chunk size value, and the text chunk overlap value instruct the text chunking process to generate each of the plurality of text segments (i) between the maximum text chunk size value and the minimum text chunk size value and (ii) includes one or more text strings of a preceding text segment based on the text chunk overlap value.

In some embodiments, the set of embedding generation parameters includes: an embedding model parameter that instructs the embedding generation process to generate the plurality of vector embeddings using a target embedding model, a vector compression parameter that instructs the embedding generation process to execute a vector compression operation on the plurality of vector embeddings, a vector quantization parameter that instructs the embedding generation process to execute a vector quantization operation on the plurality of vector embeddings, a vector storage parameter that instructs , and a vector synchronization parameter that instructs the vectorization service to automatically execute a vector update operation of a plurality of predefined vector update operations in response to detecting a modification to the one or more unstructured data sources.

In some embodiments, the modification to the one or more unstructured data sources includes adding a new document to the one or more unstructured data sources, and in response to detecting the new document added to the one or more unstructured data sources, automatically executing the vector update operation, wherein automatically executing the vector update operation includes: automatically generating, using the target embedding model, a new set of vector embeddings that numerically represents the new document; and adding the new set of vector embeddings to the target vector database.

In some embodiments, the modification to the one or more unstructured data sources includes adding a new document to the one or more unstructured data sources, and in response to detecting the new document added to the one or more unstructured data sources, automatically executing the vector update operation, wherein automatically executing the vector update operation includes: automatically removing, from the target vector database, the plurality of vector embeddings that corresponds to the unstructured documents; automatically generating, using the target embedding model, a new set of vector embeddings that numerically represents the new document; and automatically adding the new set of vector embeddings to the target vector database.

In some embodiments, the modification to the one or more unstructured data sources includes modifying a text string included in one of the unstructured documents to a modified text string, and in response to detecting the modification to the one of the unstructured documents, automatically executing the vector update operation, wherein automatically executing the vector update operation includes: automatically generating, using the target embedding model, an additional vector embedding that corresponds to the modified text string; and adding the additional vector embedding that numerically represents the modified text string to the target vector database.

In some embodiments, the modification to the one or more unstructured data sources includes modifying a text string included in one of the unstructured documents to a modified text string, and in response to detecting the modification to the one of the unstructured documents, automatically executing the vector update operation, wherein automatically executing the vector update operation includes: automatically generating, using the target embedding model, an additional vector embedding that corresponds to the modified text string; and adding the additional vector embedding that numerically represents the modified text string to the target vector database.

In some embodiments, the modification to the one or more unstructured data sources includes modifying a text string included in one of the unstructured documents to a modified text string, and in response to detecting the modification to the one of the unstructured documents, automatically executing the vector update operation, wherein automatically executing the vector update operation includes: automatically removing, from the target vector database, a respective vector embedding of the plurality of vector embeddings that corresponds to the text string of the one of the unstructured documents; automatically generating, using the target embedding model, an additional vector embedding that corresponds to the modified text string; and automatically adding the additional vector embedding that numerically represents the modified text string to the target vector database.

In some embodiments, the computer instructions, when executed by the processing circuity, perform operations further comprising: instantiating a vectorization job configuration popover that is overlaid on the graphical user interface; receiving, at the vectorization job configuration popover, a set of job execution parameters instructing the vectorization service to configure an Open Neural Network Exchange (ONNX) inference session, wherein the set of job execution parameters include: a central processing unit parameter that specifies a total number of central processing units to allocate to the ONNX inference session, a memory parameter that specifies a total amount of memory to allocate to the ONNX inference session, an execution provider parameter that specifies a target execution provider for the ONNX inference session, and a device parameter that specifies a compute device compatible with the target execution provider; and the request to perform the vectorization of the one or more unstructured data sources includes the set of job execution parameters.

In some embodiments, the computer instructions, when executed by the processing circuity, perform operations further comprising: in response the vectorization service receiving the request to perform the vectorization of the one or more unstructured data sources: configuring the ONNX inference session based on the set of job execution parameters; and executing, using the ONNX inference session, the target embedding model based on providing the plurality of text segments to the target embedding model, wherein the plurality of vector embeddings are generated in response to the target embedding model processing the plurality of text segments.

In some embodiments, the vectorization service performs the vectorization of the one or more unstructured data sources in accordance with the set of job execution parameters and the set of vector configuration parameters.

In some embodiments, the computer instructions, when executed by the processing circuity, perform operations further comprising: before executing the application performance assessment that assesses the behavior of the RAG application: receiving, at an application assessment configuration user interface, a set of application assessment tests created by a user, wherein a respective application assessment test of the set of application assessment tests includes: a respective query to provide to the RAG application when executing the application performance assessment, a set of output tokens the user requires to be included in a target response generated by the RAG application when the RAG application processes the respective query, and a test passage criterion specifying a minimum percentage of required output tokens that must appear in the target response to pass the respective application assessment test.

In some embodiments, executing the respective application assessment test of the set of application assessment tests includes: providing the respective query of the respective application assessment test to the RAG application; converting, using an embedding model of the RAG application, the respective query to an embedding value; detecting, by the RAG application, a subset of vector embeddings of the plurality of vector embeddings that have a vector distance within a predefined distance threshold of the embedding value associated with the respective query; retrieving, by the RAG application, textual content that corresponds to the subset of vector embeddings; providing, by the RAG application, the respective query of the respective application assessment test and the textual content that corresponds to the subset of vector embeddings to the large language model; generating, using the large language model of the RAG application, a corresponding response to the respective query based on the large language model receiving the respective query of the respective application assessment test and the textual content that corresponds to the subset of vector embeddings; and outputting a test assessment finding indicating whether the corresponding response satisfies the test passage criterion.

In some embodiments, executing the application performance assessment includes executing a set of application assessment tests created by a user, the computer instructions, when executed by the processing circuity, perform operations further comprising: in response to executing the set of application assessment tests created by the user, generating an aggregated test assessment finding that indicates a total number of application assessment tests of the set of application assessment tests passed by the RAG application relative to a total number of tests in the set of application assessment tests; and displaying, on the graphical user interface, a representation of the vector configuration data object in association with the aggregated test assessment finding.

In some embodiments, the computer instructions, when executed by the processing circuity, perform operations further comprising: instantiating, within the graphical user interface displaying the collection object, an automated test generation popover in response to receiving an input from a user selecting an automated test generation button displayed on the graphical user interface; receiving, from the user at the automated test generation popover, one or more test generation parameters that control an automated generation of a set of application assessment tests, wherein the one or more test generation parameters includes: a data source coverage parameter specifying a maximum percentage of content from the one or more unstructured data sources to be tested by the set of application assessment tests, a large language model parameter that specifies a target large language model for generating the set of application assessment tests, and a reference configuration parameter that specifies the vector configuration data object to be used by the RAG application during execution of the set of application assessment tests; and in response to the RAG application development pipeline receiving the one or more test generation parameters, automatically generating, using the target large language model, the set of application assessment tests.

In some embodiments, executing the application performance assessment includes executing the set of application assessment tests created by the target large language model, the computer instructions, when executed by the processing circuity, perform operations further comprising: computing a RAG application performance efficacy value for the RAG application in response to executing the set of application assessment tests created by the target large language model, and displaying, on the graphical user interface, a representation of the vector configuration data object in association with the RAG application performance efficacy value.

In some embodiments, the computer instructions, when executed by the processing circuity, perform operations further comprising: computing a first application performance efficacy value for the RAG application in response to executing the application performance assessment; and before electing the vector configuration data object as the champion vector configuration: generating, within the collection object, a second vector configuration data object based on a second set of vector configuration parameters provided by a user; executing, using the vectorization service, a second vectorization of the one or more unstructured data sources in accordance with the second set of vector configuration parameters; automatically associating a second plurality of vector embeddings generated from the second vectorization of the one or more unstructured data sources with the second vector configuration data object; automatically configuring the RAG application to use the second plurality of vector embeddings associated with the second vector configuration data object instead of the plurality of vector embeddings associated with the vector configuration data object; automatically executing a second application performance assessment that assesses a response generation behavior of the RAG application configured to use the second plurality of vector embeddings; and automatically computing, in response to executing the second application performance assessment, a second application performance efficacy value for the RAG application configured to use the second plurality of vector embeddings.

In some embodiments, the computer instructions, when executed by the processing circuity, perform operations further comprising: displaying, on the graphical user interface displaying the collection object, (i) a representation of the vector configuration data object in association with the first application performance efficacy value and (ii) a representation of the second vector configuration data object in association with the second application performance efficacy value, wherein: the vector configuration data object is elected as the champion vector configuration based on the first application performance efficacy value being greater than the second application performance efficacy value.

In some embodiments, the first application performance efficacy value includes a first retrieval-augmented generation assessment score (RAGAS) value, and the second application performance efficacy value includes a second retrieval-augmented generation assessment score (RAGAS) value.

In some embodiments, the computer instructions, when executed by the processing circuity, perform operations comprising: receiving, from a user, a request to generate the collection object, wherein the collection object is generated in response to the RAG application development pipeline receiving the request to generate the collection object; and in response to generating the collection object: automatically generating a user access security policy controlling user access to the collection object; and automatically configuring the user access security policy to include a user account of the user, wherein adding the user account to the user access security policy authorizes the user to access, modify, and manage the collection object.

In some embodiments, the computer instructions, when executed by the processing circuity, perform operations further comprising: receiving, from the user, a request to grant an additional user access to the collection object; and in response to receiving the request to grant the additional user access to the collection object, adapting the user access security policy to authorize the additional user to access and modify the collection object.

In some embodiments, the computer instructions, when executed by the processing circuity, perform operations further comprising: before electing the vector configuration data object as the champion vector configuration: computing a respective RAG application performance efficacy value for the RAG application that generates the responses based in part on the plurality of vector embeddings associated with the vector configuration data object; generating, within the collection object, a plurality of additional vector configuration data objects, wherein each additional vector configuration data object of the plurality of additional vector configuration data objects: corresponds to a distinct set of vector configuration parameters received from a user via the graphical user interface, and is associated with a distinct set of vector embeddings that numerically represent the one or more unstructured data sources, wherein the vectorization service generates the distinct set of vector embeddings by performing a respective vectorization of the one or more unstructured data sources according to the distinct set of vector configuration parameters; executing, for each additional vector configuration data object of the plurality of additional vector configuration data objects, a respective application performance assessment assessing a response generation behavior of a corresponding instance of the RAG application operably configured to use the distinct set of vector embeddings corresponding to that additional vector configuration data object; and attributing, to each additional vector configuration data object of the plurality of additional vector configuration data objects, a respective RAG application performance efficacy value that quantitatively represents the response generation behavior of the RAG application when using the distinct set of vector embeddings associated with that additional vector configuration data object, wherein: the vector configuration data object associated with the plurality of vector embeddings is elected as the champion vector configuration based on the RAG application performance efficacy value computed for the vector configuration data object associated with the plurality of vector embeddings being greater than the respective RAG application performance efficacy values attributed to each of the plurality of additional vector configuration data objects.

In some embodiments, executing the application performance assessment that assesses the behavior of the RAG application in generating the responses based in part on the plurality of vector embeddings associated with the vector configuration data object includes executing a first set of application assessment tests created by the user and a second set of application assessment tests created by a machine learning model, and executing, for each additional vector configuration data object of the plurality of additional vector configuration data objects, the respective application performance assessment assessing the response generation behavior of the corresponding instance of the RAG application includes executing the first set of application assessment tests created by the user and the second set of application assessment tests created by the machine learning model.

In some embodiments, a computer-implemented method comprises at a first stage of a retrieval-augmented-generation (RAG) application development pipeline: receiving, at a graphical user interface displaying a collection object, a set of vector configuration parameters for controlling a vectorization of one or more unstructured data sources associated with the collection object; in response to receiving the set of vector configuration parameters, generating, within the collection object, a vector configuration data object that includes the set of vector configuration parameters; generating, using a vectorization service of the RAG application development pipeline, a plurality of vector embeddings that numerically represent the one or more unstructured data sources in response to the vectorization service receiving a request to perform the vectorization of the one or more unstructured data sources; and associating the plurality of vector embeddings generated for the one or more unstructured data sources with the vector configuration data object; at a second stage of the RAG application development pipeline: executing an application performance assessment that assesses a behavior of a RAG application in generating responses based in part on the plurality of vector embeddings associated with the vector configuration data object; and electing the vector configuration data object as a champion vector configuration based on application performance findings outputted by the application performance assessment; and at a third stage of the RAG application development pipeline: deploying the RAG application, wherein the RAG application is operably configured to respond to natural language input using a large language model and the champion vector configuration.

In some embodiments, a computer-implemented system comprises processing circuitry; a memory; and a computer-readable medium operably coupled to the processing circuitry the computer-readable medium having computer-readable instructions stored thereon that, when executed by the processing circuitry, cause a computing device to perform operations comprising: at a first stage of a retrieval-augmented-generation (RAG) application development pipeline: receiving, at a graphical user interface displaying a collection object, a set of vector configuration parameters for controlling a vectorization of one or more unstructured data sources associated with the collection object; in response to receiving the set of vector configuration parameters, generating, within the collection object, a vector configuration data object that includes the set of vector configuration parameters; generating, using a vectorization service of the RAG application development pipeline, a plurality of vector embeddings that numerically represent the one or more unstructured data sources in response to the vectorization service receiving a request to perform the vectorization of the one or more unstructured data sources; and associating the plurality of vector embeddings generated for the one or more unstructured data sources with the vector configuration data object; at a second stage of the RAG application development pipeline: executing an application performance assessment that assesses a behavior of a RAG application in generating responses based in part on the plurality of vector embeddings associated with the vector configuration data object; and electing the vector configuration data object as a champion vector configuration based on application performance findings outputted by the application performance assessment; and at a third stage of the RAG application development pipeline: deploying the RAG application, wherein the RAG application is operably configured to respond to natural language input using a large language model and the champion vector configuration.

In some embodiments, a computer-program product comprising a non-transitory machine-readable storage medium storing computer instructions that, when executed by processing circuity, perform operations comprising: at a first stage of a retrieval-augmented-generation (RAG) application development pipeline: generating a collection object that is operably configured to access one or more unstructured data sources specified by a user; receiving, at a graphical user interface displaying the collection object, a set of vector configuration parameters for controlling a vectorization of the one or more unstructured data sources; in response to receiving the set of vector configuration parameters, generating, within the collection object, a vector configuration data object that includes the set of vector configuration parameters; generating, using a vectorization service of the RAG application development pipeline, a plurality of vector embeddings that numerically represent the one or more unstructured data sources in response to the vectorization service receiving a request to perform the vectorization of the one or more unstructured data sources; and associating the plurality of vector embeddings generated for the one or more unstructured data sources with the vector configuration data object; at a second stage of the RAG application development pipeline: configuring a RAG application to interface with a target set of large language models based on receiving, at the graphical user interface, one or more user inputs selecting the target set of large language models from a predetermined set of large language models; executing an application performance assessment that assesses a behavior of the RAG application in generating responses based in part on the plurality of vector embeddings associated with the vector configuration data object; and electing the vector configuration data object as a champion vector configuration in response to receiving, at the graphical user interface, a champion configuration election request from the user; and at a third stage of the RAG application development pipeline: deploying, into a production environment, the RAG application, wherein the RAG application is operably configured to respond to natural language input using the target set of large language models and the champion vector configuration.

In some embodiments, the computer instructions, when executed by the processing circuity, perform operations further comprising: instantiating a vector configuration popover in response to receiving an input from the user selecting a new vector configuration button displayed on the graphical user interface, wherein: the graphical user interface further displays the vector configuration popover, and the vector configuration popover includes a set of user interface control elements that receives the set of vector configuration parameters from the user.

In some embodiments, the set of vector configuration parameters includes: a set of document ingestion parameters specifying which unstructured documents included in the one or more unstructured data sources are to be vectorized by the vectorization service, a set of text extraction parameters that controls a text extraction process performed by the vectorization service, wherein the text extraction process extracts textual content from the unstructured documents, a set of text chunking parameters that controls a text chunking process performed by the vectorization service, wherein the text chunking process segments the textual content into a plurality of text segments, and a set of embedding generation parameters that controls an embedding generation process performed by the vectorization service, wherein the embedding generation process generates the plurality of vector embeddings based on the plurality of text segments.

In some embodiments, the set of document ingestion parameters includes: a set of prohibited file extensions selected by the user, wherein each unstructured document of the unstructured documents has a file extension that does not correspond to any file extension included in the set of prohibited file extensions, and a text cleaning parameter that instructs the vectorization service to remove characters corresponding to a target character type from the textual content.

In some embodiments, the set of text extraction parameters includes: an optical character recognition (OCR) parameter that instructs the text extraction process to extract the textual content from the unstructured documents by executing an OCR process; an OCR algorithm parameter that specifies a target OCR algorithm of a plurality of predetermined OCR algorithms to be used by the OCR process for extracting the textual content from the unstructured documents, and an OCR language parameter that specifies a human language associated with the unstructured documents.

In some embodiments, the set of text extraction parameters further includes: a data table parameter that instructs the text extraction process to extract data tables from the unstructured documents by executing a tabular data extraction process; a borderless data table detection parameter that instructs the tabular data extraction process to detect and extract borderless-type data tables from the unstructured documents, a data table export parameter that specifies a target format for representing the data tables and the borderless-type data tables extracted from the unstructured documents, and a data table detection sensitivity value, wherein the tabular data extraction process uses the data table detection sensitivity value to control whether a respective portion of the unstructured documents is detected as a tabular data structure.

In some embodiments, the set of text extraction parameters further includes: an implicit row detection parameter that instructs the tabular data extraction process to detect and extract tabular rows included in the unstructured documents that are not explicitly separated by row boundaries, and an implicit column detection parameter that instructs the tabular data extraction process to detect and extract tabular columns included in the unstructured documents that are not explicitly separated by column boundaries.

In some embodiments, the set of text chunking parameters includes: a maximum text chunk size value, a minimum text chunk size value, and a text chunk overlap value, wherein the maximum text chunk size value, the minimum text chunk size value, and the text chunk overlap value instruct the text chunking process to generate each of the plurality of text segments (i) between the maximum text chunk size value and the minimum text chunk size value and (ii) includes one or more text strings of a preceding text segment based on the text chunk overlap value.

In some embodiments, the set of embedding generation parameters includes: an embedding model parameter that instructs the embedding generation process to generate the plurality of vector embeddings using a target embedding model, a vector compression parameter that instructs the embedding generation process to execute a vector compression operation on the plurality of vector embeddings, a vector quantization parameter that instructs the embedding generation process to execute a vector quantization operation on the plurality of vector embeddings, a vector storage parameter that instructs the embedding generation process to store the plurality of vector embeddings in a target vector database, and a vector synchronization parameter that instructs the vectorization service to automatically execute a vector update operation of a plurality of predefined vector update operations in response to detecting a modification to the one or more unstructured data sources.

In some embodiments, the modification to the one or more unstructured data sources includes adding a new document to the one or more unstructured data sources, and in response to detecting the new document added to the one or more unstructured data sources, automatically executing the vector update operation, wherein automatically executing the vector update operation includes: automatically generating, using the target embedding model, a new set of vector embeddings that numerically represents the new document; and adding the new set of vector embeddings to the target vector database.

In some embodiments, the modification to the one or more unstructured data sources includes adding a new document to the one or more unstructured data sources, and in response to detecting the new document added to the one or more unstructured data sources, automatically executing the vector update operation, wherein automatically executing the vector update operation includes: automatically removing, from the target vector database, the plurality of vector embeddings that corresponds to the unstructured documents; automatically generating, using the target embedding model, a new set of vector embeddings that numerically represents the new document; automatically adding the new set of vector embeddings to the target vector database.

In some embodiments, the modification to the one or more unstructured data sources includes modifying a text string included in one of the unstructured documents to a modified text string, and in response to detecting the modification to the one of the unstructured documents, automatically executing the vector update operation, wherein automatically executing the vector update operation includes: automatically generating, using the target embedding model, an additional vector embedding that corresponds to the modified text string; and adding the additional vector embedding that numerically represents the modified text string to the target vector database.

In some embodiments, the modification to the one or more unstructured data sources includes modifying a text string included in one of the unstructured documents to a modified text string, and in response to detecting the modification to the one of the unstructured documents, automatically executing the vector update operation, wherein automatically executing the vector update operation includes: automatically removing, from the target vector database, a respective vector embedding of the plurality of vector embeddings that corresponds to the text string of the one of the unstructured documents; automatically generating, using the target embedding model, an additional vector embedding that corresponds to the modified text string; and automatically adding the additional vector embedding that numerically represents the modified text string to the target vector database.

In some embodiments, the computer instructions, when executed by the processing circuity, perform operations further comprising: instantiating a vectorization job configuration popover that is overlaid on the graphical user interface; receiving, at the vectorization job configuration popover, a set of job execution parameters instructing the vectorization service to configure an Open Neural Network Exchange (ONNX) inference session, wherein the set of job execution parameters include: a central processing unit parameter that specifies a total number of central processing units to allocate to the ONNX inference session, a memory parameter that specifies a total amount of memory to allocate to the ONNX inference session, an execution provider parameter that specifies a target execution provider for the ONNX inference session, and a device parameter that specifies a compute device compatible with the target execution provider; and the request to perform the vectorization of the one or more unstructured data sources includes the set of job execution parameters.

In some embodiments, the computer instructions, when executed by the processing circuity, perform operations further comprising: in response the vectorization service receiving the request to perform the vectorization of the one or more unstructured data sources: configuring the ONNX inference session based on the set of job execution parameters; and executing, using the ONNX inference session, the target embedding model based on providing the plurality of text segments to the target embedding model, wherein the plurality of vector embeddings are generated in response to the target embedding model processing the plurality of text segments.

In some embodiments, the vectorization service performs the vectorization of the one or more unstructured data sources in accordance with the set of job execution parameters and the set of vector configuration parameters.

In some embodiments, the computer instructions, when executed by the processing circuity, perform operations further comprising: before executing the application performance assessment that assesses the behavior of the RAG application: receiving, at an application assessment configuration user interface, a set of application assessment tests created by the user, wherein a respective application assessment test of the set of application assessment tests includes: a respective query to provide to the RAG application when executing the application performance assessment, a set of output tokens the user requires to be included in a target response generated by the RAG application when the RAG application processes the respective query, and a test passage criterion specifying a minimum percentage of required output tokens that must appear in the target response to pass the respective application assessment test.

In some embodiments, executing the respective application assessment test of the set of application assessment tests includes: providing the respective query of the respective application assessment test to the RAG application; converting, using an embedding model of the RAG application, the respective query to an embedding value; detecting, by the RAG application, a subset of vector embeddings of the plurality of vector embeddings that have a vector distance within a predefined distance threshold of the embedding value associated with the respective query; retrieving, by the RAG application, textual content that corresponds to the subset of vector embeddings; providing, by the RAG application, the respective query of the respective application assessment test and the textual content that corresponds to the subset of vector embeddings to the target set of large language models; generating, using the target set of large language models of the RAG application, a corresponding response to the respective query based on the target set of large language models receiving the respective query of the respective application assessment test and the textual content that corresponds to the subset of vector embeddings; and outputting a test assessment finding indicating whether the corresponding response satisfies the test passage criterion.

In some embodiments, executing the application performance assessment includes executing a set of application assessment tests created by the user, the computer instructions, when executed by the processing circuity, perform operations further comprising: in response to executing the set of application assessment tests created by the user, generating an aggregated test assessment finding that indicates a total number of application assessment tests of the set of application assessment tests passed by the RAG application relative to a total number of tests in the set of application assessment tests; and displaying, on the graphical user interface, a representation of the vector configuration data object in association with the aggregated test assessment finding.

In some embodiments, the computer instructions, when executed by the processing circuity, perform operations further comprising: instantiating, within the graphical user interface displaying the collection object, an automated test generation popover in response to receiving an input from the user selecting an automated test generation button displayed on the graphical user interface; receiving, from the user at the automated test generation popover, one or more test generation parameters that control an automated generation of a set of application assessment tests, wherein the one or more test generation parameters includes: a data source coverage parameter specifying a maximum percentage of content from the one or more unstructured data sources to be tested by the set of application assessment tests, a large language model parameter that specifies a target large language model for generating the set of application assessment tests, and a reference configuration parameter that specifies the vector configuration data object to be used by the RAG application during execution of the set of application assessment tests; and in response to the RAG application development pipeline receiving the one or more test generation parameters, automatically generating, using the target large language model, the set of application assessment tests.

In some embodiments, executing the application performance assessment includes executing the set of application assessment tests created by the target large language model, the computer instructions, when executed by the processing circuity, perform operations further comprising: computing a RAG application performance efficacy value for the RAG application in response to executing the set of application assessment tests created by the target large language model, and displaying, on the graphical user interface, a representation of the vector configuration data object in association with the RAG application performance efficacy value.

In some embodiments, the computer instructions, when executed by the processing circuity, perform operations further comprising: computing a first application performance efficacy value for the RAG application in response to executing the application performance assessment; and before electing the vector configuration data object as the champion vector configuration: generating, within the collection object, a second vector configuration data object based on a second set of vector configuration parameters provided by the user; executing, using the vectorization service, a second vectorization of the one or more unstructured data sources in accordance with the second set of vector configuration parameters; automatically associating a second plurality of vector embeddings generated from the second vectorization of the one or more unstructured data sources with the second vector configuration data object; automatically configuring the RAG application to use the second plurality of vector embeddings associated with the second vector configuration data object instead of the plurality of vector embeddings associated with the vector configuration data object; automatically executing a second application performance assessment that assesses a response generation behavior of the RAG application configured to use the second plurality of vector embeddings; and automatically computing, in response to executing the second application performance assessment, a second application performance efficacy value for the RAG application configured to use the second plurality of vector embeddings.

In some embodiments, the computer instructions, when executed by the processing circuity, perform operations further comprising: displaying, on the graphical user interface displaying the collection object, (i) a representation of the vector configuration data object in association with the first application performance efficacy value and (ii) a representation of the second vector configuration data object in association with the second application performance efficacy value, wherein: the vector configuration data object is elected as the champion vector configuration based on the first application performance efficacy value being greater than the second application performance efficacy value.

In some embodiments, the first application performance efficacy value includes a first retrieval-augmented generation assessment score (RAGAS) value, and the second application performance efficacy value includes a second retrieval-augmented generation assessment score (RAGAS) value.

In some embodiments, the computer instructions, when executed by the processing circuity, perform operations comprising: receiving, from the user, a request to generate the collection object, wherein the collection object is generated in response to the RAG application development pipeline receiving the request to generate the collection object; and in response to generating the collection object: automatically generating a user access security policy controlling user access to the collection object; and automatically configuring the user access security policy to include a user account of the user, wherein adding the user account to the user access security policy authorizes the user to access, modify, and manage the collection object..

In some embodiments, the computer instructions, when executed by the processing circuity, perform operations further comprising: receiving, from the user, a request to grant an additional user access to the collection object; and in response to receiving the request to grant the additional user access to the collection object, adapting the user access security policy to authorize the additional user to access and modify the collection object.

In some embodiments, the computer instructions, when executed by the processing circuity, perform operations further comprising: before electing the vector configuration data object as the champion vector configuration: computing a respective RAG application performance efficacy value for the RAG application that generates the responses based in part on the plurality of vector embeddings associated with the vector configuration data object; generating, within the collection object, a plurality of additional vector configuration data objects, wherein each additional vector configuration data object of the plurality of additional vector configuration data objects: corresponds to a distinct set of vector configuration parameters received from the user via the graphical user interface, and is associated with a distinct set of vector embeddings that numerically represent the one or more unstructured data sources, wherein the vectorization service generates the distinct set of vector embeddings by performing a respective vectorization of the one or more unstructured data sources according to the distinct set of vector configuration parameters; executing, for each additional vector configuration data object of the plurality of additional vector configuration data objects, a respective application performance assessment assessing a response generation behavior of a corresponding instance of the RAG application operably configured to use the distinct set of vector embeddings corresponding to that additional vector configuration data object; and attributing, to each additional vector configuration data object of the plurality of additional vector configuration data objects, a respective RAG application performance efficacy value that quantitatively represents the response generation behavior of the RAG application when using the distinct set of vector embeddings associated with that additional vector configuration data object, wherein: the vector configuration data object associated with the plurality of vector embeddings is elected as the champion vector configuration based on the RAG application performance efficacy value computed for the vector configuration data object associated with the plurality of vector embeddings being greater than the respective RAG application performance efficacy values attributed to each of the plurality of additional vector configuration data objects.

In some embodiments, executing the application performance assessment that assesses the behavior of the RAG application in generating the responses based in part on the plurality of vector embeddings associated with the vector configuration data object includes executing a first set of application assessment tests created by the user and a second set of application assessment tests created by a machine learning model, and executing, for each additional vector configuration data object of the plurality of additional vector configuration data objects, the respective application performance assessment assessing the response generation behavior of the corresponding instance of the RAG application includes executing the first set of application assessment tests created by the user and the second set of application assessment tests created by the machine learning model.

### BRIEF DESCRIPTION OF THE FIGURES

FIG. 1 illustrates a block diagram that provides an illustration of the hardware components of a computing system, according to some embodiments of the present technology.

FIG. 2 illustrates an example network including an example set of devices communicating with each other over an exchange system and via a network, according to some embodiments of the present technology.

FIG. 3 illustrates a representation of a conceptual model of a communications protocol system, according to some embodiments of the present technology.

FIG. 4 illustrates a communications grid computing system including a variety of control and worker nodes, according to some embodiments of the present technology.

FIG. 5 illustrates a flow chart showing an example process for adjusting a communications grid or a work project in a communications grid after a failure of a node, according to some embodiments of the present technology.

FIG. 6 illustrates a portion of a communications grid computing system including a control node and a worker node, according to some embodiments of the present technology.

FIG. 7 illustrates a flow chart showing an example process for executing a data analysis or processing project, according to some embodiments of the present technology.

FIG. 8 illustrates a block diagram including components of an Event Stream Processing Engine (ESPE), according to some embodiments of the present technology.

FIG. 9 illustrates a flow chart showing an example process including operations performed by an event stream processing engine, according to some embodiments of the present technology.

FIG. 10 illustrates an ESP system interfacing between a publishing device and multiple event subscribing devices, according to some embodiments of the present technology.

FIG. 11 illustrates a flow chart of an example of a process for generating and using a machine-learning model according to some aspects, according to some embodiments of the present technology.

FIG. 12 illustrates an example of a machine-learning model as a neural network, according to some embodiments of the present technology.

FIG. 13 illustrates various aspects of the use of containers as a mechanism to allocate processing, storage and/or other resources of a processing system to the performance of various analyses, according to some embodiments of the present technology.

FIGS. 14 and 14A illustrate an example process flow in accordance with some embodiments of the present technology.

FIGS. 15 and 16 illustrate example vectorization procedures in accordance with some embodiments of the present technology.

FIGS. 17 and 17A illustrate an example vectorization pipeline test procedure in accordance with some embodiments of the present technology.

FIG. 18 illustrates an example vectorization pipeline selection procedure in accordance with some embodiments of the present technology.

FIG. 19 illustrates an example vectorization configuration procedure in accordance with some embodiments of the present technology.

FIG. 20 illustrates an collection object generation procedure in accordance with some embodiments of the present technology.

FIG. 21 illustrates an example collection object security configuration procedure in accordance with some embodiments of the present technology.

FIGS. 22 and 22A illustrate a user-created application assessment test creation procedure in accordance with some embodiments of the present technology.

FIG. 23 illustrates an example automated application assessment test creation procedure in accordance with some embodiments of the present technology.

FIG. 24 illustrates an example collection object modification procedure in accordance with some embodiments of the present technology.

FIG. 25 illustrates an example vectorization pipeline selection procedure in accordance with some embodiments of the present technology.

FIG. 26 illustrates an example process flow in accordance with some embodiments of the present technology.

FIGS. 27A through 27Z -2 illustrate user interface views in accordance with some embodiments of the present technology.

### DESCRIPTION OF THE PREFERRED EMBODIMENTS

The following description of the preferred embodiments of the inventions are not intended to limit the inventions to these preferred embodiments, but rather to enable any person skilled in the art to make and use these inventions.

### DETAILED DESCRIPTION

In the following description, for the purposes of explanation, specific details are set forth in order to provide a thorough understanding of embodiments of the technology. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the technology as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional operations not included in a figure. A process may correspond to a method, a function, a procedure, a subroutine, a subprogram, etc. When a process corresponds to a function, its termination can correspond to a return of the function to the calling function or the main function.

### EXAMPLE SYSTEMS

Systems depicted in some of the figures may be provided in various configurations. In some embodiments, the systems may be configured as a distributed system where one or more components of the system are distributed across one or more networks in a cloud computing system.

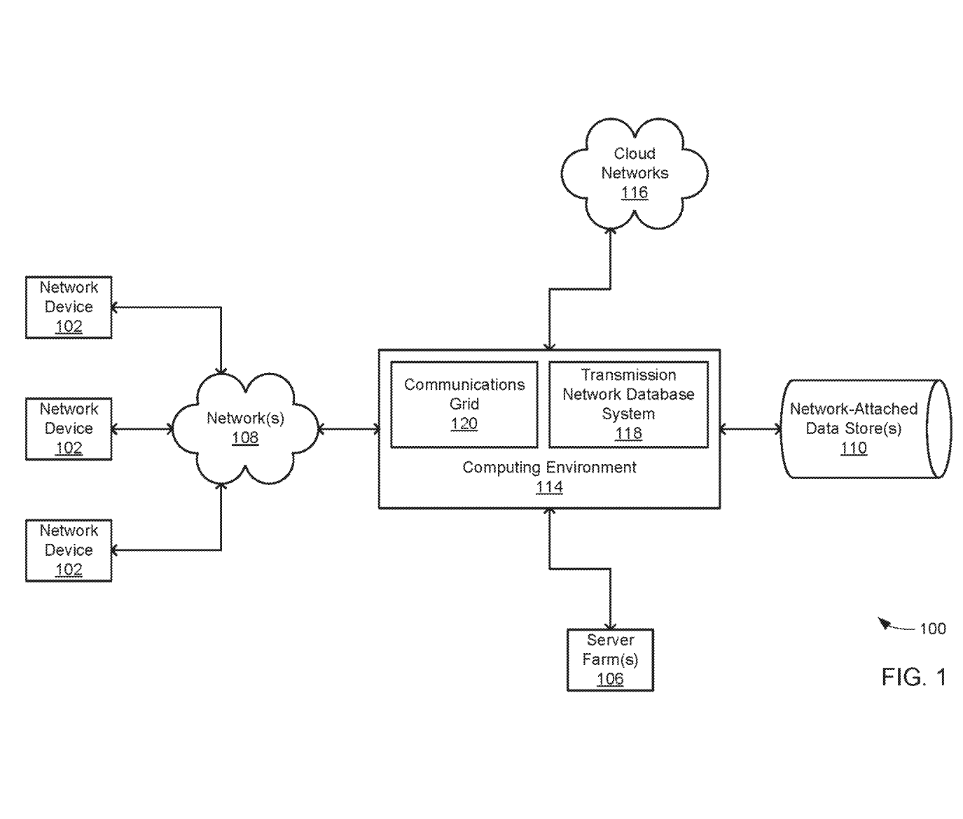

FIG. 1 is a block diagram that provides an illustration of the hardware components of a data transmission network 100, according to embodiments of the present technology. Data transmission network 100 is a specialized computer system that may be used for processing large amounts of data where a large number of computer processing cycles are required.

Data transmission network 100 may also include computing environment 114. Computing environment 114 may be a specialized computer or other machine that processes the data received within the data transmission network 100. Data transmission network 100 also includes one or more network devices 102. Network devices 102 may include client devices that attempt to communicate with computing environment 114. For example, network devices 102 may send data to the computing environment 114 to be processed, may send signals to the computing environment 114 to control different aspects of the computing environment or the data it is processing, among other reasons. Network devices 102 may interact with the computing environment 114 through a number of ways, such as, for example, over one or more networks 108. As shown in FIG. 1, computing environment 114 may include one or more other systems. For example, computing environment 114 may include a database system 118 and/or a communications grid 120.

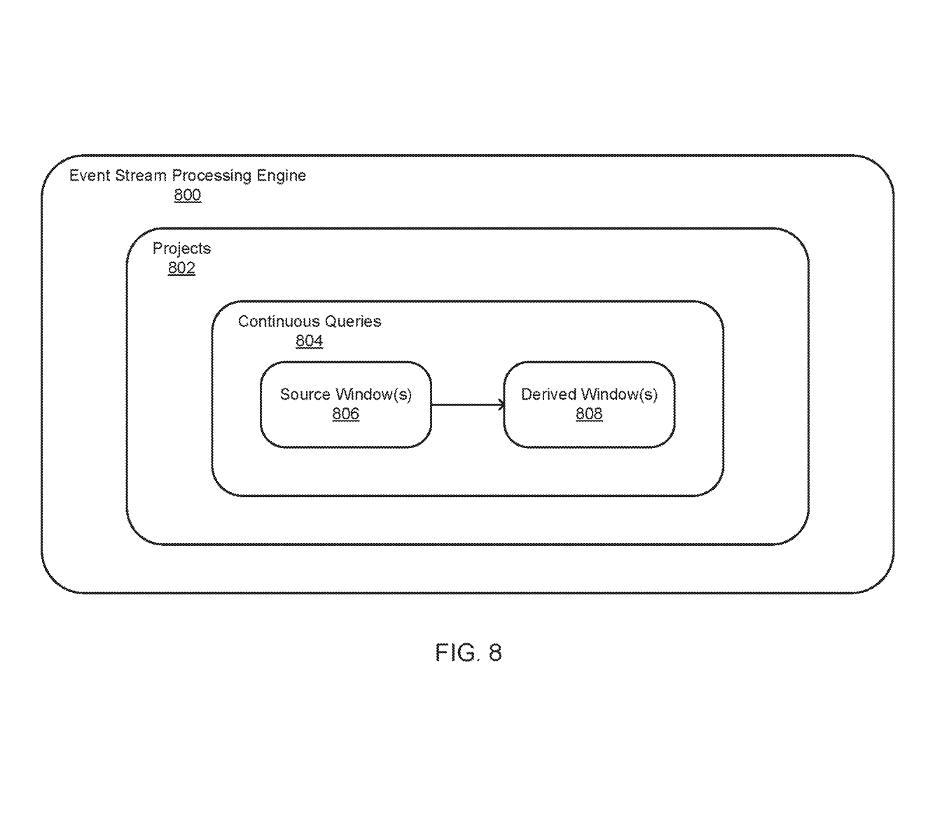

In other embodiments, network devices may provide a large amount of data, either all at once or streaming over a period of time (e.g., using event stream processing (ESP), described further with respect to FIGS. 8-10), to the computing environment 114 via networks 108. For example, network devices 102 may include network computers, sensors, databases, or other devices that may transmit or otherwise provide data to computing environment 114. For example, network devices may include local area network devices, such as routers, hubs, switches, or other computer networking devices. These devices may provide a variety of stored or generated data, such as network data or data specific to the network devices themselves. Network devices may also include sensors that monitor their environment or other devices to collect data regarding that environment or those devices, and such network devices may provide data they collect over time. Network devices may also include devices within the internet of things, such as devices within a home automation network. Some of these devices may be referred to as edge devices and may involve edge computing circuitry. Data may be transmitted by network devices directly to computing environment 114 or to network-attached data stores, such as network-attached data stores 110 for storage so that the data may be retrieved later by the computing environment 114 or other portions of data transmission network 100.

Data transmission network 100 may also include one or more network-attached data stores 110. Network-attached data stores 110 are used to store data to be processed by the computing environment 114 as well as any intermediate or final data generated by the computing system in non-volatile memory. However, in certain embodiments, the configuration of the computing environment 114 allows its operations to be performed such that intermediate and final data results can be stored solely in volatile memory (e.g., RAM), without a requirement that intermediate or final data results be stored to non-volatile types of memory (e.g., disk). This can be useful in certain situations, such as when the computing environment 114 receives ad hoc queries from a user and when responses, which are generated by processing large amounts of data, need to be generated on-the-fly. In this non-limiting situation, the computing environment 114 may be configured to retain the processed information within memory so that responses can be generated for the user at different levels of detail as well as allow a user to interactively query against this information.

Network-attached data stores may store a variety of different types of data organized in a variety of different ways and from a variety of different sources. For example, network-attached data storage may include storage other than primary storage located within computing environment 114 that is directly accessible by processors located therein. Network-attached data storage may include secondary, tertiary or auxiliary storage, such as large hard drives, servers, virtual memory, among other types. Storage devices may include portable or non-portable storage devices, optical storage devices, and various other mediums capable of storing, containing data. A machine-readable storage medium or computer-readable storage medium may include a non-transitory medium in which data can be stored and that does not include carrier waves and/or transitory electronic signals. Examples of a non-transitory medium may include, for example, a magnetic disk or tape, optical storage media such as compact disk or digital versatile disk, flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. Furthermore, the data stores may hold a variety of different types of data. For example, network-attached data stores 110 may hold unstructured (e.g., raw) data, such as manufacturing data (e.g., a database containing records identifying products being manufactured with parameter data for each product, such as colors and models) or product sales databases (e.g., a database containing individual data records identifying details of individual product sales).

The unstructured data may be presented to the computing environment 114 in different forms such as a flat file or a conglomerate of data records and may have data values and accompanying time stamps. The computing environment 114 may be used to analyze the unstructured data in a variety of ways to determine the best way to structure (e.g., hierarchically) that data, such that the structured data is tailored to a type of further analysis that a user wishes to perform on the data. For example, after being processed, the unstructured time stamped data may be aggregated by time (e.g., into daily time period units) to generate time series data and/or structured hierarchically according to one or more dimensions (e.g., parameters, attributes, and/or variables). For example, data may be stored in a hierarchical data structure, such as a ROLAP OR MOLAP database, or may be stored in another tabular form, such as in a flat-hierarchy form.

Data transmission network 100 may also include one or more server farms 106. Computing environment 114 may route select communications or data to the one or more server farms 106 or one or more servers within the server farms. Server farms 106 can be configured to provide information in a predetermined manner. For example, server farms 106 may access data to transmit in response to a communication. Server farms 106 may be separately housed from each other device within data transmission network 100, such as computing environment 114, and/or may be part of a device or system.

Server farms 106 may host a variety of different types of data processing as part of data transmission network 100. Server farms 106 may receive a variety of different data from network devices, from computing environment 114, from cloud network 116, or from other sources. The data may have been obtained or collected from one or more sensors, as inputs from a control database, or may have been received as inputs from an external system or device. Server farms 106 may assist in processing the data by turning raw data into processed data based on one or more rules implemented by the server farms. For example, sensor data may be analyzed to determine changes in an environment over time or in real-time.

Data transmission network 100 may also include one or more cloud networks 116. Cloud network 116 may include a cloud infrastructure system that provides cloud services. In certain embodiments, services provided by the cloud network 116 may include a host of services that are made available to users of the cloud infrastructure system on demand. Cloud network 116 is shown in FIG. 1 as being connected to computing environment 114 (and therefore having computing environment 114 as its client or user), but cloud network 116 may be connected to or utilized by any of the devices in FIG. 1. Services provided by the cloud network can dynamically scale to meet the needs of its users. The cloud network 116 may include one or more computers, servers, and/or systems. In some embodiments, the computers, servers, and/or systems that make up the cloud network 116 are different from the user’s own on-premises computers, servers, and/or systems. For example, the cloud network 116 may host an application, and a user may, via a communication network such as the Internet, on demand, order and use the application.

While each device, server and system in FIG. 1 is shown as a single device, it will be appreciated that multiple devices may instead be used. For example, a set of network devices can be used to transmit various communications from a single user, or remote server 140 may include a server stack. As another example, data may be processed as part of computing environment 114.

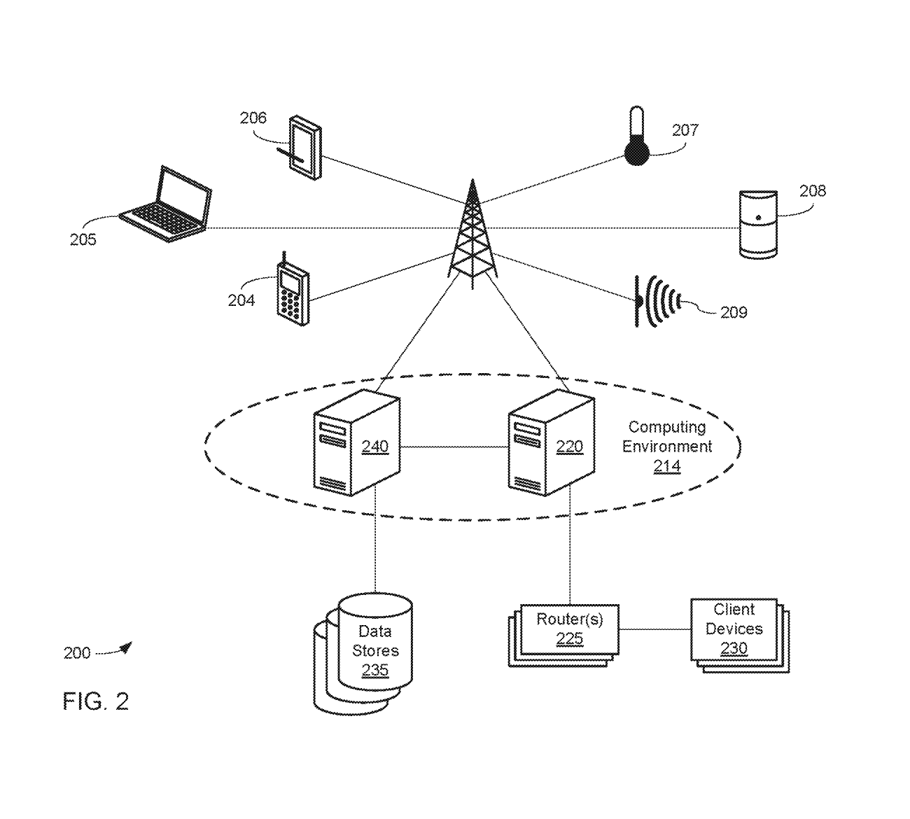

Each communication within data transmission network 100 (e.g., between client devices, between servers 106 and computing environment 114 or between a server and a device) may occur over one or more networks 108. Networks 108 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or combination of wireless interfaces. As an example, a network in the one or more networks 108 may include a short-range communication channel, such as a BLUETOOTH® communication channel or a BLUETOOTH® Low Energy communication channel. A wired network may include a wired interface. The wired and/or wireless networks may be implemented using routers, access points, bridges, gateways, or the like, to connect devices in the network 114, as will be further described with respect to FIG. 2. The one or more networks 108 can be incorporated entirely within or can include an intranet, an extranet, or a combination thereof. In one embodiment, communications between two or more systems and/or devices can be achieved by a secure communications protocol, such as secure sockets layer (SSL) or transport layer security (TLS). In addition, data and/or transactional details may be encrypted.

Some aspects may utilize the Internet of Things (IoT), where things (e.g., machines, devices, phones, sensors) can be connected to networks and the data from these things can be collected and processed within the things and/or external to the things. For example, the IoT can include sensors in many different devices, and high value analytics can be applied to identify hidden relationships and drive increased efficiencies. This can apply to both big data analytics and real-time (e.g., ESP) analytics. This will be described further below with respect to FIG. 2.

As noted, computing environment 114 may include a communications grid 120 and a transmission network database system 118. Communications grid 120 may be a grid-based computing system for processing large amounts of data. The transmission network database system 118 may be for managing, storing, and retrieving large amounts of data that are distributed to and stored in the one or more network-attached data stores 110 or other data stores that reside at different locations within the transmission network database system 118. The compute nodes in the grid-based computing system 120 and the transmission network database system 118 may share the same processor hardware, such as processors that are located within computing environment 114.

FIG. 2 illustrates an example network including an example set of devices communicating with each other over an exchange system and via a network, according to embodiments of the present technology. As noted, each communication within data transmission network 100 may occur over one or more networks. System 200 includes a network device 204 configured to communicate with a variety of types of client devices, for example client devices 230, over a variety of types of communication channels.

As shown in FIG. 2, network device 204 can transmit a communication over a network (e.g., a cellular network via a base station 210). The communication can be routed to another network device, such as network devices 205-209, via base station 210. The communication can also be routed to computing environment 214 via base station 210. For example, network device 204 may collect data either from its surrounding environment or from other network devices (such as network devices 205-209) and transmit that data to computing environment 214.

Although network devices 204-209 are shown in FIG. 2 as a mobile phone, laptop computer, tablet computer, temperature sensor, motion sensor, and audio sensor respectively, the network devices may be or include sensors that are sensitive to detecting aspects of their environment. For example, the network devices may include sensors such as water sensors, power sensors, electrical current sensors, chemical sensors, optical sensors, pressure sensors, geographic or position sensors (e.g., GPS), velocity sensors, acceleration sensors, flow rate sensors, among others. Examples of characteristics that may be sensed include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, and electrical current, among others. The sensors may be mounted to various components used as part of a variety of different types of systems (e.g., an oil drilling operation). The network devices may detect and record data related to the environment that it monitors and transmit that data to computing environment 214.

As noted, one type of system that may include various sensors that collect data to be processed and/or transmitted to a computing environment according to certain embodiments includes an oil drilling system. For example, the one or more drilling operation sensors may include surface sensors that measure a hook load, a fluid rate, a temperature and a density in and out of the wellbore, a standpipe pressure, a surface torque, a rotation speed of a drill pipe, a rate of penetration, a mechanical specific energy, etc. and downhole sensors that measure a rotation speed of a bit, fluid densities, downhole torque, downhole vibration (axial, tangential, lateral), a weight applied at a drill bit, an annular pressure, a differential pressure, an azimuth, an inclination, a dog leg severity, a measured depth, a vertical depth, a downhole temperature, etc. Besides the raw data collected directly by the sensors, other data may include parameters either developed by the sensors or assigned to the system by a client or other controlling device. For example, one or more drilling operation control parameters may control settings such as a mud motor speed to flow ratio, a bit diameter, a predicted formation top, seismic data, weather data, etc. Other data may be generated using physical models such as an earth model, a weather model, a seismic model, a bottom hole assembly model, a well plan model, an annular friction model, etc. In addition to sensor and control settings, predicted outputs, of for example, the rate of penetration, mechanical specific energy, hook load, flow in fluid rate, flow out fluid rate, pump pressure, surface torque, rotation speed of the drill pipe, annular pressure, annular friction pressure, annular temperature, equivalent circulating density, etc. may also be stored in the data warehouse.

In another example, another type of system that may include various sensors that collect data to be processed and/or transmitted to a computing environment according to certain embodiments includes a home automation or similar automated network in a different environment, such as an office space, school, public space, sports venue, or a variety of other locations. Network devices in such an automated network may include network devices that allow a user to access, control, and/or configure various home appliances located within the user’s home (e.g., a television, radio, light, fan, humidifier, sensor, microwave, iron, and/or the like), or outside of the user’s home (e.g., exterior motion sensors, exterior lighting, garage door openers, sprinkler systems, or the like). For example, network device 102 may include a home automation switch that may be coupled with a home appliance. In another embodiment, a network device can allow a user to access, control, and/or configure devices, such as office-related devices (e.g., copy machine, printer, or fax machine), audio and/or video related devices (e.g., a receiver, a speaker, a projector, a DVD player, or a television), media-playback devices (e.g., a compact disc player, a CD player, or the like), computing devices (e.g., a home computer, a laptop computer, a tablet, a personal digital assistant (PDA), a computing device, or a wearable device), lighting devices (e.g., a lamp or recessed lighting), devices associated with a security system, devices associated with an alarm system, devices that can be operated in an automobile (e.g., radio devices, navigation devices), and/or the like. Data may be collected from such various sensors in raw form, or data may be processed by the sensors to create parameters or other data either developed by the sensors based on the raw data or assigned to the system by a client or other controlling device.

In another example, another type of system that may include various sensors that collect data to be processed and/or transmitted to a computing environment according to certain embodiments includes a power or energy grid. A variety of different network devices may be included in an energy grid, such as various devices within one or more power plants, energy farms (e.g., wind farm, solar farm, among others) energy storage facilities, factories, homes and businesses of consumers, among others. One or more of such devices may include one or more sensors that detect energy gain or loss, electrical input or output or loss, and a variety of other efficiencies. These sensors may collect data to inform users of how the energy grid, and individual devices within the grid, may be functioning and how they may be made more efficient.

Network device sensors may also perform processing on data it collects before transmitting the data to the computing environment 114, or before deciding whether to transmit data to the computing environment 114. For example, network devices may determine whether data collected meets certain rules, for example by comparing data or values calculated from the data and comparing that data to one or more thresholds. The network device may use this data and/or comparisons to determine if the data should be transmitted to the computing environment 214 for further use or processing.

Computing environment 214 may include machines 220 and 240. Although computing environment 214 is shown in FIG. 2 as having two machines, 220 and 240, computing environment 214 may have only one machine or may have more than two machines. The machines that make up computing environment 214 may include specialized computers, servers, or other machines that are configured to individually and/or collectively process large amounts of data. The computing environment 214 may also include storage devices that include one or more databases of structured data, such as data organized in one or more hierarchies, or unstructured data. The databases may communicate with the processing devices within computing environment 214 to distribute data to them. Since network devices may transmit data to computing environment 214, that data may be received by the computing environment 214 and subsequently stored within those storage devices. Data used by computing environment 214 may also be stored in data stores 235, which may also be a part of or connected to computing environment 214.

Computing environment 214 can communicate with various devices via one or more routers 225 or other inter-network or intra-network connection components. For example, computing environment 214 may communicate with devices 230 via one or more routers 225. Computing environment 214 may collect, analyze and/or store data from or pertaining to communications, client device operations, client rules, and/or user-associated actions stored at one or more data stores 235. Such data may influence communication routing to the devices within computing environment 214, how data is stored or processed within computing environment 214, among other actions.

Notably, various other devices can further be used to influence communication routing and/or processing between devices within computing environment 214 and with devices outside of computing environment 214. For example, as shown in FIG. 2, computing environment 214 may include a web server 240. Thus, computing environment 214 can retrieve data of interest, such as client information (e.g., product information, client rules, etc.), technical product details, news, current or predicted weather, and so on.

In addition to computing environment 214 collecting data (e.g., as received from network devices, such as sensors, and client devices or other sources) to be processed as part of a big data analytics project, it may also receive data in real time as part of a streaming analytics environment. As noted, data may be collected using a variety of sources as communicated via different kinds of networks or locally. Such data may be received on a real-time streaming basis. For example, network devices may receive data periodically from network device sensors as the sensors continuously sense, monitor and track changes in their environments. Devices within computing environment 214 may also perform pre-analysis on data it receives to determine if the data received should be processed as part of an ongoing project. The data received and collected by computing environment 214, no matter what the source or method or timing of receipt, may be processed over a period of time for a client to determine results data based on the client’s needs and rules.

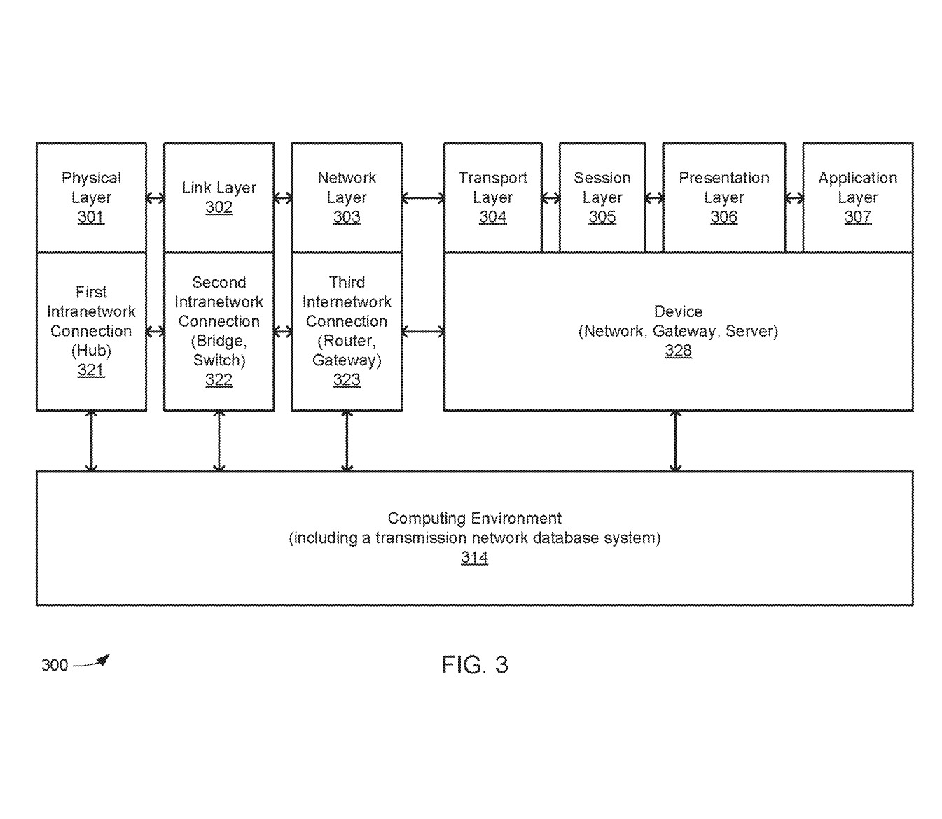

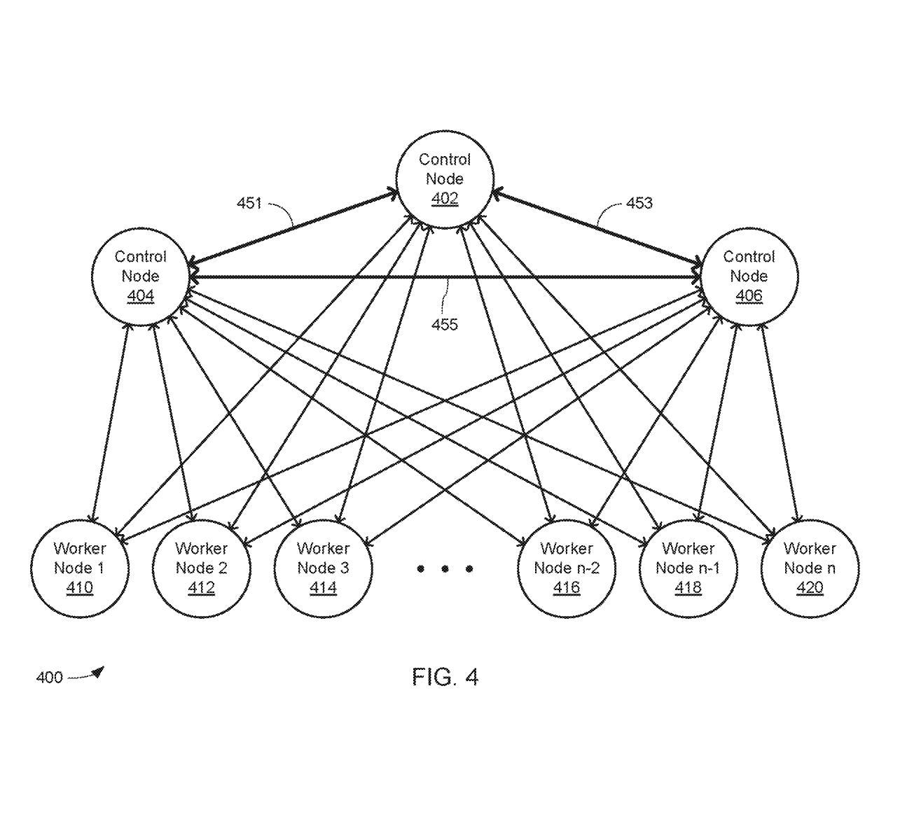

FIG. 3 illustrates a representation of a conceptual model of a communications protocol system, according to embodiments of the present technology. More specifically, FIG. 3 identifies operation of a computing environment in an Open Systems Interaction model that corresponds to various connection components. The model 300 shows, for example, how a computing environment, such as computing environment 314 (or computing environment 214 in FIG. 2) may communicate with other devices in its network, and control how communications between the computing environment and other devices are executed and under what conditions.

The model can include layers 301-307. The layers are arranged in a stack. Each layer in the stack serves the layer one level higher than it (except for the application layer, which is the highest layer), and is served by the layer one level below it (except for the physical layer, which is the lowest layer). The physical layer is the lowest layer because it receives and transmits raw bites of data and is the farthest layer from the user in a communications system. On the other hand, the application layer is the highest layer because it interacts directly with a software application.

As noted, the model includes a physical layer 301. Physical layer 301 represents physical communication and can define parameters of that physical communication. For example, such physical communication may come in the form of electrical, optical, or electromagnetic signals. Physical layer 301 also defines protocols that may control communications within a data transmission network.

Link layer 302 defines links and mechanisms used to transmit (i.e., move) data across a network. The link layer 302 manages node-to-node communications, such as within a grid computing environment. Link layer 302 can detect and correct errors (e.g., transmission errors in the physical layer 301). Link layer 302 can also include a media access control (MAC) layer and logical link control (LLC) layer.

Network layer 303 defines the protocol for routing within a network. In other words, the network layer coordinates transferring data across nodes in a same network (e.g., such as a grid computing environment). Network layer 303 can also define the processes used to structure local addressing within the network.

Transport layer 304 can manage the transmission of data and the quality of the transmission and/or receipt of that data. Transport layer 304 can provide a protocol for transferring data, such as, for example, a Transmission Control Protocol (TCP). Transport layer 304 can assemble and disassemble data frames for transmission. The transport layer can also detect transmission errors occurring in the layers below it.

Session layer 305 can establish, maintain, and manage communication connections between devices on a network. In other words, the session layer controls the dialogues or nature of communications between network devices on the network. The session layer may also establish checkpointing, adjournment, termination, and restart procedures.

Presentation layer 306 can provide translation for communications between the application and network layers. In other words, this layer may encrypt, decrypt and/or format data based on data types and/or encodings known to be accepted by an application or network layer.

Application layer 307 interacts directly with software applications and end users and manages communications between them. Application layer 307 can identify destinations, local resource states or availability and/or communication content or formatting using the applications.

Intra-network connection components 321 and 322 are shown to operate in lower levels, such as physical layer 301 and link layer 302, respectively. For example, a hub can operate in the physical layer, a switch can operate in the link layer, and a router can operate in the network layer. Inter-network connection components 323 and 328 are shown to operate on higher levels, such as layers 303-307. For example, routers can operate in the network layer and network devices can operate in the transport, session, presentation, and application layers.

As noted, a computing environment 314 can interact with and/or operate on, in various embodiments, one, more, all or any of the various layers. For example, computing environment 314 can interact with a hub (e.g., via the link layer) so as to adjust which devices the hub communicates with. The physical layer may be served by the link layer, so it may implement such data from the link layer. For example, the computing environment 314 may control which devices it will receive data from. For example, if the computing environment 314 knows that a certain network device has turned off, broken, or otherwise become unavailable or unreliable, the computing environment 314 may instruct the hub to prevent any data from being transmitted to the computing environment 314 from that network device. Such a process may be beneficial to avoid receiving data that is inaccurate or that has been influenced by an uncontrolled environment. As another example, computing environment 314 can communicate with a bridge, switch, router or gateway and influence which device within the system (e.g., system 200) the component selects as a destination. In some embodiments, computing environment 314 can interact with various layers by exchanging communications with equipment operating on a particular layer by routing or modifying existing communications. In another embodiment, such as in a grid computing environment, a node may determine how data within the environment should be routed (e.g., which node should receive certain data) based on certain parameters or information provided by other layers within the model.

As noted, the computing environment 314 may be a part of a communications grid environment, the communications of which may be implemented as shown in the protocol of FIG. 3. For example, referring back to FIG. 2, one or more of machines 220 and 240 may be part of a communications grid computing environment. A gridded computing environment may be employed in a distributed system with non-interactive workloads where data resides in memory on the machines, or compute nodes. In such an environment, analytic code, instead of a database management system, controls the processing performed by the nodes. Data is co-located by pre-distributing it to the grid nodes, and the analytic code on each node loads the local data into memory. Each node may be assigned a particular task such as a portion of a processing project, or to organize or control other nodes within the grid.

FIG. 4 illustrates a communications grid computing system 400 including a variety of control and worker nodes, according to embodiments of the present technology. Communications grid computing system 400 includes three control nodes and one or more worker nodes. Communications grid computing system 400 includes control nodes 402, 404, and 406. The control nodes are communicatively connected via communication paths 451, 453, and 455. Therefore, the control nodes may transmit information (e.g., related to the communications grid or notifications), to and receive information from each other. Although communications grid computing system 400 is shown in FIG. 4 as including three control nodes, the communications grid may include more or less than three control nodes.

Communications grid computing system (or just “communications grid”) 400 also includes one or more worker nodes. Shown in FIG. 4 are six worker nodes 410-420. Although FIG. 4 shows six worker nodes, a communications grid according to embodiments of the present technology may include more or less than six worker nodes. The number of worker nodes included in a communications grid may be dependent upon how large the project or data set is being processed by the communications grid, the capacity of each worker node, the time designated for the communications grid to complete the project, among others. Each worker node within the communications grid 400 may be connected (wired or wirelessly, and directly or indirectly) to control nodes 402-406. Therefore, each worker node may receive information from the control nodes (e.g., an instruction to perform work on a project) and may transmit information to the control nodes (e.g., a result from work performed on a project). Furthermore, worker nodes may communicate with each other (either directly or indirectly). For example, worker nodes may transmit data between each other related to a job being performed or an individual task within a job being performed by that worker node. However, in certain embodiments, worker nodes may not, for example, be connected (communicatively or otherwise) to certain other worker nodes. In an embodiment, worker nodes may only be able to communicate with the control node that controls it and may not be able to communicate with other worker nodes in the communications grid, whether they are other worker nodes controlled by the control node that controls the worker node, or worker nodes that are controlled by other control nodes in the communications grid.

A control node may connect with an external device with which the control node may communicate (e.g., a grid user, such as a server or computer, may connect to a controller of the grid). For example, a server or computer may connect to control nodes and may transmit a project or job to the node. The project may include a data set. The data set may be of any size. Once the control node receives such a project including a large data set, the control node may distribute the data set or projects related to the data set to be performed by worker nodes. Alternatively, for a project including a large data set, the data set may be received or stored by a machine other than a control node (e.g., a HADOOP® standard-compliant data node employing the HADOOP® Distributed File System, or HDFS).

Control nodes may maintain knowledge of the status of the nodes in the grid (i.e., grid status information), accept work requests from clients, subdivide the work across worker nodes, and coordinate the worker nodes, among other responsibilities. Worker nodes may accept work requests from a control node and provide the control node with results of the work performed by the worker node. A grid may be started from a single node (e.g., a machine, computer, server, etc.). This first node may be assigned or may start as the primary control node that will control any additional nodes that enter the grid.

When a project is submitted for execution (e.g., by a client or a controller of the grid) it may be assigned to a set of nodes. After the nodes are assigned to a project, a data structure (i.e., a communicator) may be created. The communicator may be used by the project for information to be shared between the project codes running on each node. A communication handle may be created on each node. A handle, for example, is a reference to the communicator that is valid within a single process on a single node, and the handle may be used when requesting communications between nodes.

A control node, such as control node 402, may be designated as the primary control node. A server, computer or other external device may connect to the primary control node. Once the control node receives a project, the primary control node may distribute portions of the project to its worker nodes for execution. For example, when a project is initiated on communications grid 400, primary control node 402 controls the work to be performed for the project in order to complete the project as requested or instructed. The primary control node may distribute work to the worker nodes based on various factors, such as which subsets or portions of projects may be completed most efficiently and in the correct amount of time. For example, a worker node may perform analysis on a portion of data that is already local (e.g., stored on) the worker node. The primary control node also coordinates and processes the results of the work performed by each worker node after each worker node executes and completes its job. For example, the primary control node may receive a result from one or more worker nodes, and the control node may organize (e.g., collect and assemble) the results received and compile them to produce a complete result for the project received from the end user.

Any remaining control nodes, such as control nodes 404 and 406, may be assigned as backup control nodes for the project. In an embodiment, backup control nodes may not control any portion of the project. Instead, backup control nodes may serve as a backup for the primary control node and take over as primary control node if the primary control node were to fail. If a communications grid were to include only a single control node, and the control node were to fail (e.g., the control node is shut off or breaks) then the communications grid as a whole may fail and any project or job being run on the communications grid may fail and may not complete. While the project may be run again, such a failure may cause a delay (severe delay in some cases, such as overnight delay) in completion of the project. Therefore, a grid with multiple control nodes, including a backup control node, may be beneficial.

To add another node or machine to the grid, the primary control node may open a pair of listening sockets, for example. A socket may be used to accept work requests from clients, and the second socket may be used to accept connections from other grid nodes. The primary control node may be provided with a list of other nodes (e.g., other machines, computers, servers) that will participate in the grid, and the role that each node will fill in the grid. Upon startup of the primary control node (e.g., the first node on the grid), the primary control node may use a network protocol to start the server process on every other node in the grid. Command line parameters, for example, may inform each node of one or more pieces of information, such as: the role that the node will have in the grid, the host name of the primary control node, the port number on which the primary control node is accepting connections from peer nodes, among others. The information may also be provided in a configuration file, transmitted over a secure shell tunnel, recovered from a configuration server, among others. While the other machines in the grid may not initially know about the configuration of the grid, that information may also be sent to each other node by the primary control node. Updates of the grid information may also be subsequently sent to those nodes.

For any control node other than the primary control node added to the grid, the control node may open three sockets. The first socket may accept work requests from clients, the second socket may accept connections from other grid members, and the third socket may connect (e.g., permanently) to the primary control node. When a control node (e.g., primary control node) receives a connection from another control node, it first checks to see if the peer node is in the list of configured nodes in the grid. If it is not on the list, the control node may clear the connection. If it is on the list, it may then attempt to authenticate the connection. If authentication is successful, the authenticating node may transmit information to its peer, such as the port number on which a node is listening for connections, the host name of the node, information about how to authenticate the node, among other information. When a node, such as the new control node, receives information about another active node, it will check to see if it already has a connection to that other node. If it does not have a connection to that node, it may then establish a connection to that control node.

Any worker node added to the grid may establish a connection to the primary control node and any other control nodes on the grid. After establishing the connection, it may authenticate itself to the grid (e.g., any control nodes, including both primary and backup, or a server or user controlling the grid). After successful authentication, the worker node may accept configuration information from the control node.

When a node joins a communications grid (e.g., when the node is powered on or connected to an existing node on the grid or both), the node is assigned (e.g., by an operating system of the grid) a universally unique identifier (UUID). This unique identifier may help other nodes and external entities (devices, users, etc.) to identify the node and distinguish it from other nodes. When a node is connected to the grid, the node may share its unique identifier with the other nodes in the grid. Since each node may share its unique identifier, each node may know the unique identifier of every other node on the grid. Unique identifiers may also designate a hierarchy of each of the nodes (e.g., backup control nodes) within the grid. For example, the unique identifiers of each of the backup control nodes may be stored in a list of backup control nodes to indicate an order in which the backup control nodes will take over for a failed primary control node to become a new primary control node. However, a hierarchy of nodes may also be determined using methods other than using the unique identifiers of the nodes. For example, the hierarchy may be predetermined or may be assigned based on other predetermined factors.

The grid may add new machines at any time (e.g., initiated from any control node). Upon adding a new node to the grid, the control node may first add the new node to its table of grid nodes. The control node may also then notify every other control node about the new node. The nodes receiving the notification may acknowledge that they have updated their configuration information.

Primary control node 402 may, for example, transmit one or more communications to backup control nodes 404 and 406 (and, for example, to other control or worker nodes within the communications grid). Such communications may be sent periodically, at fixed time intervals, between known fixed stages of the project’s execution, among other protocols. The communications transmitted by primary control node 402 may be of varied types and may include a variety of types of information. For example, primary control node 402 may transmit snapshots (e.g., status information) of the communications grid so that backup control node 404 always has a recent snapshot of the communications grid. The snapshot or grid status may include, for example, the structure of the grid (including, for example, the worker nodes in the grid, unique identifiers of the nodes, or their relationships with the primary control node) and the status of a project (including, for example, the status of each worker node’s portion of the project). The snapshot may also include analysis or results received from worker nodes in the communications grid. The backup control nodes may receive and store the backup data received from the primary control node. The backup control nodes may transmit a request for such a snapshot (or other information) from the primary control node, or the primary control node may send such information periodically to the backup control nodes.

As noted, the backup data may allow the backup control node to take over as primary control node if the primary control node fails without requiring the grid to start the project over from scratch. If the primary control node fails, the backup control node that will take over as primary control node may retrieve the most recent version of the snapshot received from the primary control node and use the snapshot to continue the project from the stage of the project indicated by the backup data. This may prevent failure of the project as a whole.

A backup control node may use various methods to determine that the primary control node has failed. In one example of such a method, the primary control node may transmit (e.g., periodically) a communication to the backup control node that indicates that the primary control node is working and has not failed, such as a heartbeat communication. The backup control node may determine that the primary control node has failed if the backup control node has not received a heartbeat communication for a certain predetermined period of time. Alternatively, a backup control node may also receive a communication from the primary control node itself (before it failed) or from a worker node that the primary control node has failed, for example because the primary control node has failed to communicate with the worker node.

Different methods may be performed to determine which backup control node of a set of backup control nodes (e.g., backup control nodes 404 and 406) will take over for failed primary control node 402 and become the new primary control node. For example, the new primary control node may be chosen based on a ranking or “hierarchy” of backup control nodes based on their unique identifiers. In an alternative embodiment, a backup control node may be assigned to be the new primary control node by another device in the communications grid or from an external device (e.g., a system infrastructure or an end user, such as a server or computer, controlling the communications grid). In another alternative embodiment, the backup control node that takes over as the new primary control node may be designated based on bandwidth or other statistics about the communications grid.

A worker node within the communications grid may also fail. If a worker node fails, work being performed by the failed worker node may be redistributed amongst the operational worker nodes. In an alternative embodiment, the primary control node may transmit a communication to each of the operable worker nodes still on the communications grid that each of the worker nodes should purposefully fail also. After each of the worker nodes fail, they may each retrieve their most recently saved checkpoint of their status and re-start the project from that checkpoint to minimize lost progress on the project being executed.

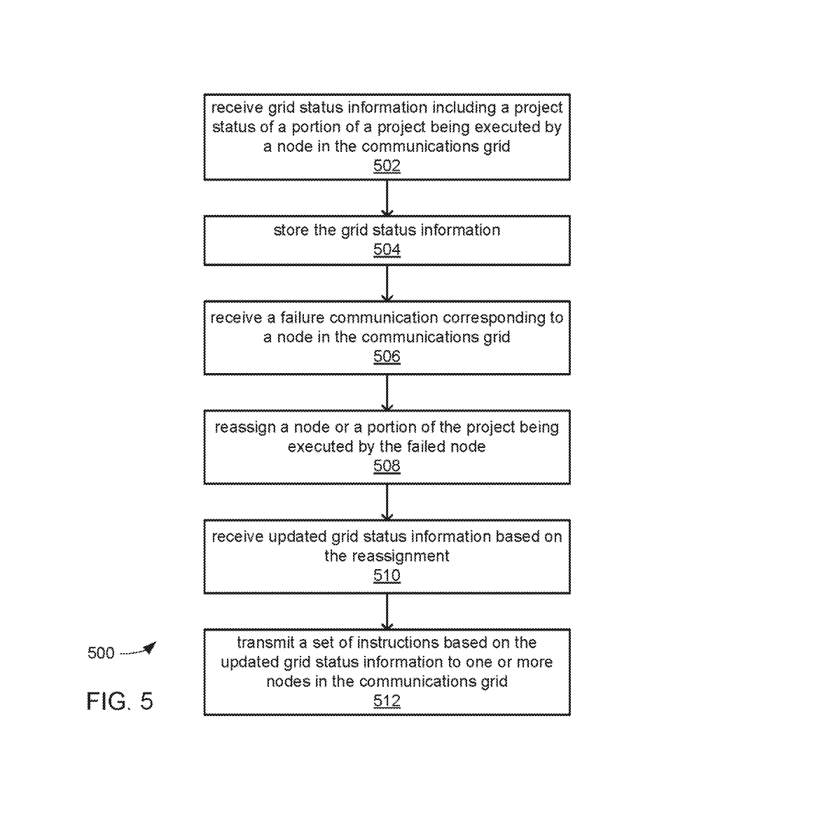

FIG. 5 illustrates a flow chart showing an example process 500 for adjusting a communications grid or a work project in a communications grid after a failure of a node, according to embodiments of the present technology. The process may include, for example, receiving grid status information including a project status of a portion of a project being executed by a node in the communications grid, as described in operation 502. For example, a control node (e.g., a backup control node connected to a primary control node and a worker node on a communications grid) may receive grid status information, where the grid status information includes a project status of the primary control node or a project status of the worker node. The project status of the primary control node and the project status of the worker node may include a status of one or more portions of a project being executed by the primary and worker nodes in the communications grid. The process may also include storing the grid status information, as described in operation 504. For example, a control node (e.g., a backup control node) may store the received grid status information locally within the control node. Alternatively, the grid status information may be sent to another device for storage where the control node may have access to the information.

The process may also include receiving a failure communication corresponding to a node in the communications grid in operation 506. For example, a node may receive a failure communication including an indication that the primary control node has failed, prompting a backup control node to take over for the primary control node. In an alternative embodiment, a node may receive a failure that a worker node has failed, prompting a control node to reassign the work being performed by the worker node. The process may also include reassigning a node or a portion of the project being executed by the failed node, as described in operation 508. For example, a control node may designate the backup control node as a new primary control node based on the failure communication upon receiving the failure communication. If the failed node is a worker node, a control node may identify a project status of the failed worker node using the snapshot of the communications grid, where the project status of the failed worker node includes a status of a portion of the project being executed by the failed worker node at the failure time.

The process may also include receiving updated grid status information based on the reassignment, as described in operation 510, and transmitting a set of instructions based on the updated grid status information to one or more nodes in the communications grid, as described in operation 512. The updated grid status information may include an updated project status of the primary control node or an updated project status of the worker node. The updated information may be transmitted to the other nodes in the grid to update their stale stored information.

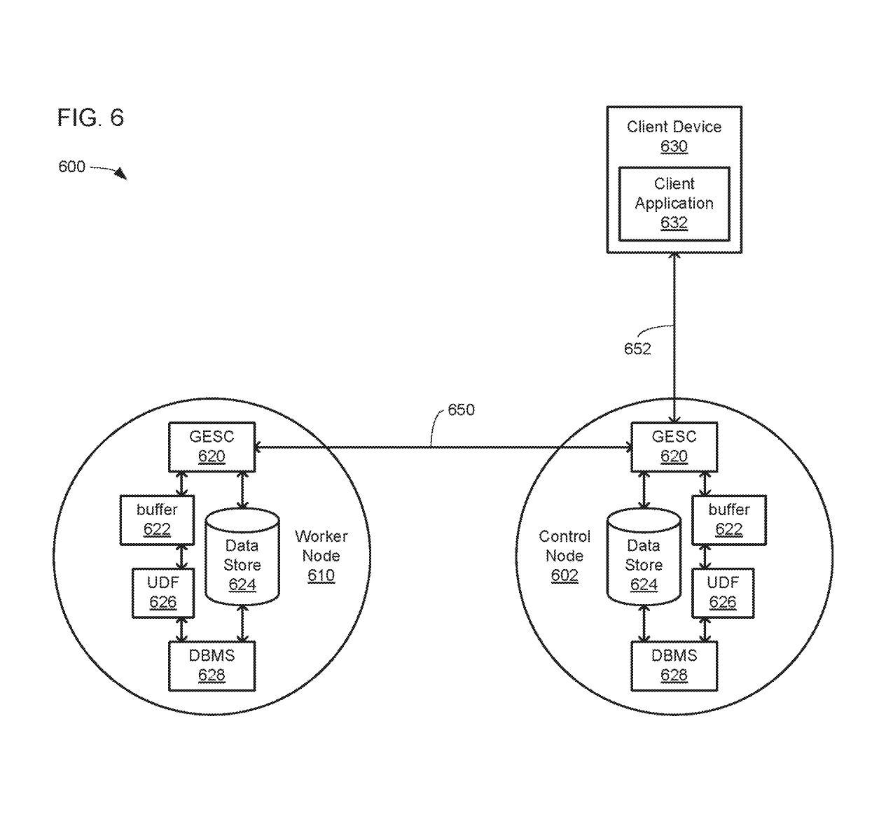

FIG. 6 illustrates a portion of a communications grid computing system 600 including a control node and a worker node, according to embodiments of the present technology. Communications grid 600 computing system includes one control node (control node 602) and one worker node (worker node 610) for purposes of illustration but may include more worker and/or control nodes. The control node 602 is communicatively connected to worker node 610 via communication path 650. Therefore, control node 602 may transmit information (e.g., related to the communications grid or notifications), to and receive information from worker node 610 via path 650.

Similar to in FIG. 4, communications grid computing system (or just “communications grid”) 600 includes data processing nodes (control node 602 and worker node 610). Nodes 602 and 610 include multi-core data processors. Each node 602 and 610 includes a grid-enabled software component (GESC) 620 that executes on the data processor associated with that node and interfaces with buffer memory 622 also associated with that node. Each node 602 and 610 includes database management software (DBMS) 628 that executes on a database server (not shown) at control node 602 and on a database server (not shown) at worker node 610.

Each node also includes a data store 624. Data stores 624, similar to network-attached data stores 110 in FIG. 1 and data stores 235 in FIG. 2, are used to store data to be processed by the nodes in the computing environment. Data stores 624 may also store any intermediate or final data generated by the computing system after being processed, for example in non-volatile memory. However, in certain embodiments, the configuration of the grid computing environment allows its operations to be performed such that intermediate and final data results can be stored solely in volatile memory (e.g., RAM), without a requirement that intermediate or final data results be stored to non-volatile types of memory. Storing such data in volatile memory may be useful in certain situations, such as when the grid receives queries (e.g., ad hoc) from a client and when responses, which are generated by processing large amounts of data, need to be generated quickly or on-the-fly. In such a situation, the grid may be configured to retain the data within memory so that responses can be generated at different levels of detail and so that a client may interactively query against this information.

Each node also includes a user-defined function (UDF) 626. The UDF provides a mechanism for the DBMS 628 to transfer data to or receive data from the database stored in the data stores 624 that are managed by the DBMS. For example, UDF 626 can be invoked by the DBMS to provide data to the GESC for processing. The UDF 626 may establish a socket connection (not shown) with the GESC to transfer the data. Alternatively, the UDF 626 can transfer data to the GESC by writing data to shared memory accessible by both the UDF and the GESC.

The GESC 620 at the nodes 602 and 620 may be connected via a network, such as network 108 shown in FIG. 1. Therefore, nodes 602 and 620 can communicate with each other via the network using a predetermined communication protocol such as, for example, the Message Passing Interface (MPI). Each GESC 620 can engage in point-to-point communication with the GESC at another node or in collective communication with multiple GESCs via the network. The GESC 620 at each node may contain identical (or nearly identical) software instructions. Each node may be capable of operating as either a control node or a worker node. The GESC at the control node 602 can communicate, over a communication path 652, with a client device 630. More specifically, control node 602 may communicate with client application 632 hosted by the client device 630 to receive queries and to respond to those queries after processing large amounts of data.

DBMS 628 may control the creation, maintenance, and use of database or data structure (not shown) within a node 602 or 610. The database may organize data stored in data stores 624. The DBMS 628 at control node 602 may accept requests for data and transfer the appropriate data for the request. With such a process, collections of data may be distributed across multiple physical locations. In this example, each node 602 and 610 stores a portion of the total data managed by the management system in its associated data store 624.

Furthermore, the DBMS may be responsible for protecting against data loss using replication techniques. Replication includes providing a backup copy of data stored on one node on one or more other nodes. Therefore, if one node fails, the data from the failed node can be recovered from a replicated copy residing at another node. However, as described herein with respect to FIG. 4, data or status information for each node in the communications grid may also be shared with each node on the grid.

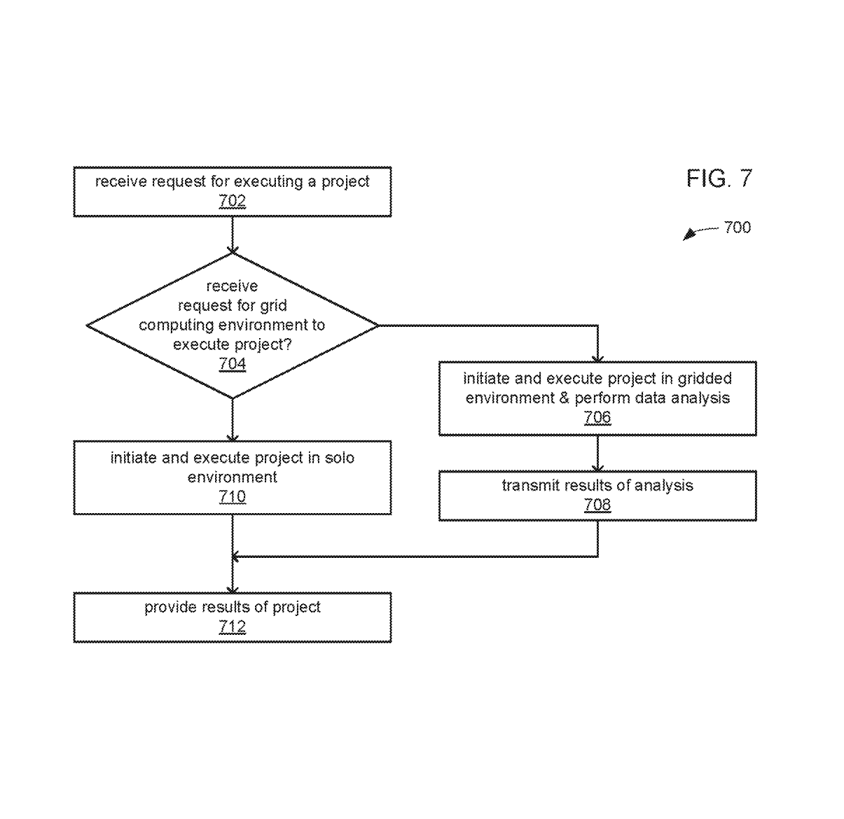

FIG. 7 illustrates a flow chart showing an example method 700 for executing a project within a grid computing system, according to embodiments of the present technology. As described with respect to FIG. 6, the GESC at the control node may transmit data with a client device (e.g., client device 630) to receive queries for executing a project and to respond to those queries after large amounts of data have been processed. The query may be transmitted to the control node, where the query may include a request for executing a project, as described in operation 702. The query can contain instructions on the type of data analysis to be performed in the project and whether the project should be executed using the grid-based computing environment, as shown in operation 704.

To initiate the project, the control node may determine if the query requests use of the grid-based computing environment to execute the project. If the determination is no, then the control node initiates execution of the project in a solo environment (e.g., at the control node), as described in operation 710. If the determination is yes, the control node may initiate execution of the project in the grid-based computing environment, as described in operation 706. In such a situation, the request may include a requested configuration of the grid. For example, the request may include a number of control nodes and a number of worker nodes to be used in the grid when executing the project. After the project has been completed, the control node may transmit results of the analysis yielded by the grid, as described in operation 708. Whether the project is executed in a solo or grid-based environment, the control node provides the results of the project, as described in operation 712.

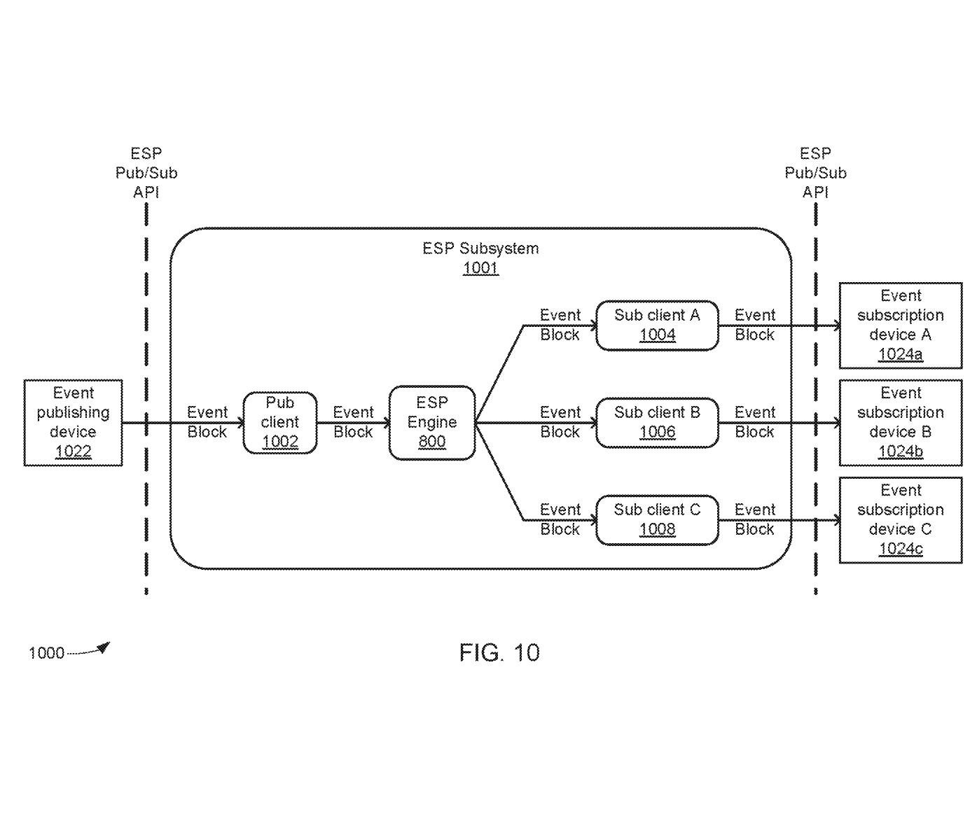

As noted with respect to FIG. 2, the computing environments described herein may collect data (e.g., as received from network devices, such as sensors, such as network devices 204-209 in FIG. 2, and client devices or other sources) to be processed as part of a data analytics project, and data may be received in real time as part of a streaming analytics environment (e.g., ESP). Data may be collected using a variety of sources as communicated via different kinds of networks or locally, such as on a real-time streaming basis. For example, network devices may receive data periodically from network device sensors as the sensors continuously sense, monitor and track changes in their environments. More specifically, an increasing number of distributed applications develop or produce continuously flowing data from distributed sources by applying queries to the data before distributing the data to geographically distributed recipients. An event stream processing engine (ESPE) may continuously apply the queries to the data as it is received and determines which entities should receive the data. Clients or other devices may also subscribe to the ESPE or other devices processing ESP data so that they can receive data after processing, based on for example the entities determined by the processing engine. For example, client devices 230 in FIG. 2 may subscribe to the ESPE in computing environment 214. In another example, event subscription devices 1024a-c, described further with respect to FIG. 10, may also subscribe to the ESPE. The ESPE may determine or define how input data or event streams from network devices or other publishers (e.g., network devices 204-209 in FIG. 2) are transformed into meaningful output data to be consumed by subscribers, such as for example client devices 230 in FIG. 2.

FIG. 8 illustrates a block diagram including components of an Event Stream Processing Engine (ESPE), according to embodiments of the present technology. ESPE 800 may include one or more projects 802. A project may be described as a second-level container in an engine model managed by ESPE 800 where a thread pool size for the project may be defined by a user. Each project of the one or more projects 802 may include one or more continuous queries 804 that contain data flows, which are data transformations of incoming event streams. The one or more continuous queries 804 may include one or more source windows 806 and one or more derived windows 808.

The ESPE may receive streaming data over a period of time related to certain events, such as events or other data sensed by one or more network devices. The ESPE may perform operations associated with processing data created by the one or more devices. For example, the ESPE may receive data from the one or more network devices 204-209 shown in FIG. 2. As noted, the network devices may include sensors that sense different aspects of their environments and may collect data over time based on those sensed observations. For example, the ESPE may be implemented within one or more of machines 220 and 240 shown in FIG. 2. The ESPE may be implemented within such a machine by an ESP application. An ESP application may embed an ESPE with its own dedicated thread pool or pools into its application space where the main application thread can do application-specific work and the ESPE processes event streams at least by creating an instance of a model into processing objects.

The engine container is the top-level container in a model that manages the resources of the one or more projects 802. In an illustrative embodiment, for example, there may be only one ESPE 800 for each instance of the ESP application, and ESPE 800 may have a unique engine name. Additionally, the one or more projects 802 may each have unique project names, and each query may have a unique continuous query name and begin with a uniquely named source window of the one or more source windows 806. ESPE 800 may or may not be persistent.

Continuous query modeling involves defining directed graphs of windows for event stream manipulation and transformation. A window in the context of event stream manipulation and transformation is a processing node in an event stream processing model. A window in a continuous query can perform aggregations, computations, pattern-matching, and other operations on data flowing through the window. A continuous query may be described as a directed graph of source, relational, pattern matching, and procedural windows. The one or more source windows 806 and the one or more derived windows 808 represent continuously executing queries that generate updates to a query result set as new event blocks stream through ESPE 800. A directed graph, for example, is a set of nodes connected by edges, where the edges have a direction associated with them.

An event object may be described as a packet of data accessible as a collection of fields, with at least one of the fields defined as a key or unique identifier (ID). The event object may be created using a variety of formats including binary, alphanumeric, XML, etc. Each event object may include one or more fields designated as a primary identifier (ID) for the event so ESPE 800 can support operation codes (opcodes) for events including insert, update, upsert, and delete. Upsert opcodes update the event if the key field already exists; otherwise, the event is inserted. For illustration, an event object may be a packed binary representation of a set of field values and include both metadata and field data associated with an event. The metadata may include an opcode indicating if the event represents an insert, update, delete, or upsert, a set of flags indicating if the event is a normal, partial-update, or a retention generated event from retention policy management, and a set of microsecond timestamps that can be used for latency measurements.

An event block object may be described as a grouping or package of event objects. An event stream may be described as a flow of event block objects. A continuous query of the one or more continuous queries 804 transforms a source event stream made up of streaming event block objects published into ESPE 800 into one or more output event streams using the one or more source windows 806 and the one or more derived windows 808. A continuous query can also be thought of as data flow modeling.

The one or more source windows 806 are at the top of the directed graph and have no windows feeding into them. Event streams are published into the one or more source windows 806, and from there, the event streams may be directed to the next set of connected windows as defined by the directed graph. The one or more derived windows 808 are all instantiated windows that are not source windows and that have other windows streaming events into them. The one or more derived windows 808 may perform computations or transformations on the incoming event streams. The one or more derived windows 808 transform event streams based on the window type (that is operators such as join, filter, compute, aggregate, copy, pattern match, procedural, union, etc.) and window settings. As event streams are published into ESPE 800, they are continuously queried, and the resulting sets of derived windows in these queries are continuously updated.

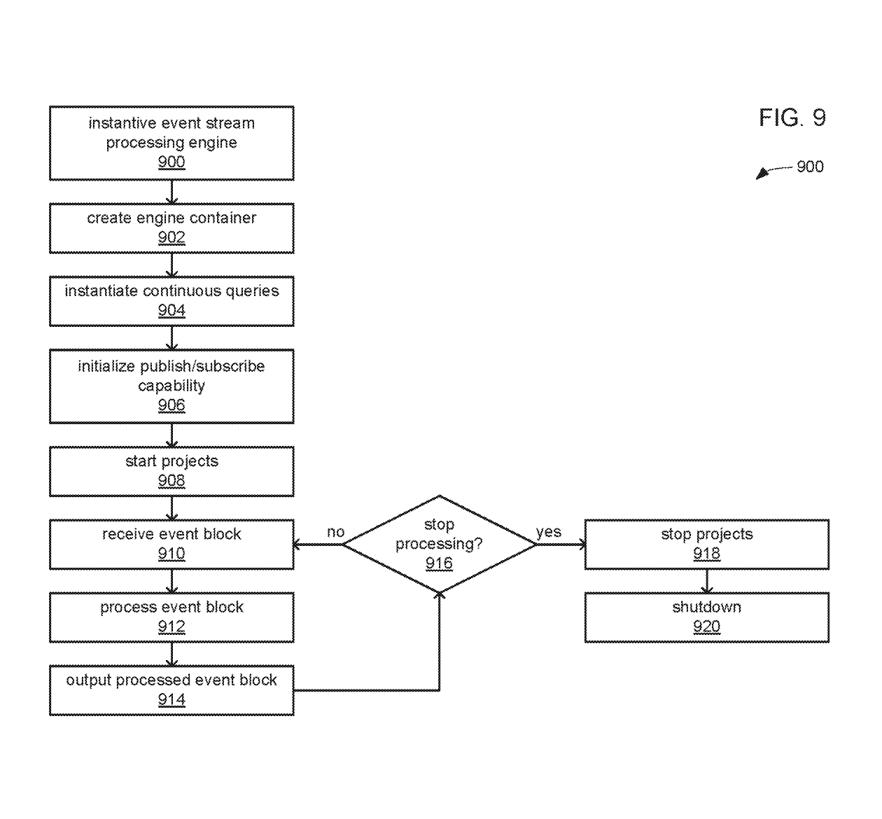

FIG. 9 illustrates a flow chart showing an example process including operations performed by an event stream processing engine, according to some embodiments of the present technology. As noted, the ESPE 800 (or an associated ESP application) defines how input event streams are transformed into meaningful output event streams. More specifically, the ESP application may define how input event streams from publishers (e.g., network devices providing sensed data) are transformed into meaningful output event streams consumed by subscribers (e.g., a data analytics project being executed by a machine or set of machines).

Within the application, a user may interact with one or more user interface windows presented to the user in a display under control of the ESPE independently or through a browser application in an order selectable by the user. For example, a user may execute an ESP application, which causes presentation of a first user interface window, which may include a plurality of menus and selectors such as drop down menus, buttons, text boxes, hyperlinks, etc. associated with the ESP application as understood by a person of skill in the art. As further understood by a person of skill in the art, various operations may be performed in parallel, for example, using a plurality of threads.

At operation 900, an ESP application may define and start an ESPE, thereby instantiating an ESPE at a device, such as machine 220 and/or 240. In an operation 902, the engine container is created. For illustration, ESPE 800 may be instantiated using a function call that specifies the engine container as a manager for the model.

In an operation 904, the one or more continuous queries 804 are instantiated by ESPE 800 as a model. The one or more continuous queries 804 may be instantiated with a dedicated thread pool or pools that generate updates as new events stream through ESPE 800. For illustration, the one or more continuous queries 804 may be created to model business processing logic within ESPE 800, to predict events within ESPE 800, to model a physical system within ESPE 800, to predict the physical system state within ESPE 800, etc. For example, as noted, ESPE 800 may be used to support sensor data monitoring and management (e.g., sensing may include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, or electrical current, etc.).

ESPE 800 may analyze and process events in motion or “event streams.” Instead of storing data and running queries against the stored data, ESPE 800 may store queries and stream data through them to allow continuous analysis of data as it is received. The one or more source windows 806 and the one or more derived windows 808 may be created based on the relational, pattern matching, and procedural algorithms that transform the input event streams into the output event streams to model, simulate, score, test, predict, etc. based on the continuous query model defined and application to the streamed data.

In an operation 906, a publish/subscribe (pub/sub) capability is initialized for ESPE 800. In an illustrative embodiment, a pub/sub capability is initialized for each project of the one or more projects 802. To initialize and enable pub/sub capability for ESPE 800, a port number may be provided. Pub/sub clients can use a host name of an ESP device running the ESPE and the port number to establish pub/sub connections to ESPE 800.

FIG. 10 illustrates an ESP system 1000 interfacing between publishing device 1022 and event subscribing devices 1024a-c, according to embodiments of the present technology. ESP system 1000 may include ESP device or subsystem 851, event publishing device 1022, an event subscribing device A 1024a, an event subscribing device B 1024b, and an event subscribing device C 1024c. Input event streams are output to ESP device 851 by publishing device 1022. In alternative embodiments, the input event streams may be created by a plurality of publishing devices. The plurality of publishing devices further may publish event streams to other ESP devices. The one or more continuous queries instantiated by ESPE 800 may analyze and process the input event streams to form output event streams output to event subscribing device A 1024a, event subscribing device B 1024b, and event subscribing device C 1024c. ESP system 1000 may include a greater or a fewer number of event subscribing devices of event subscribing devices.

Publish-subscribe is a message-oriented interaction paradigm based on indirect addressing. Processed data recipients specify their interest in receiving information from ESPE 800 by subscribing to specific classes of events, while information sources publish events to ESPE 800 without directly addressing the receiving parties. ESPE 800 coordinates the interactions and processes the data. In some cases, the data source receives confirmation that the published information has been received by a data recipient.

A publish/subscribe API may be described as a library that enables an event publisher, such as publishing device 1022, to publish event streams into ESPE 800 or an event subscriber, such as event subscribing device A 1024a, event subscribing device B 1024b, and event subscribing device C 1024c, to subscribe to event streams from ESPE 800. For illustration, one or more publish/subscribe APIs may be defined. Using the publish/subscribe API, an event publishing application may publish event streams into a running event stream processor project source window of ESPE 800, and the event subscription application may subscribe to an event stream processor project source window of ESPE 800.

The publish/subscribe API provides cross-platform connectivity and endianness compatibility between ESP application and other networked applications, such as event publishing applications instantiated at publishing device 1022, and event subscription applications instantiated at one or more of event subscribing device A 1024a, event subscribing device B 1024b, and event subscribing device C 1024c.

Referring back to FIG. 9, operation 906 initializes the publish/subscribe capability of ESPE 800. In an operation 908, the one or more projects 802 are started. The one or more started projects may run in the background on an ESP device. In an operation 910, an event block object is received from one or more computing devices of the event publishing device 1022.

ESP subsystem 800 may include a publishing client 1002, ESPE 800, a subscribing client A 1004, a subscribing client B 1006, and a subscribing client C 1008. Publishing client 1002 may be started by an event publishing application executing at publishing device 1022 using the publish/subscribe API. Subscribing client A 1004 may be started by an event subscription application A, executing at event subscribing device A 1024a using the publish/subscribe API. Subscribing client B 1006 may be started by an event subscription application B executing at event subscribing device B 1024b using the publish/subscribe API. Subscribing client C 1008 may be started by an event subscription application C executing at event subscribing device C 1024c using the publish/subscribe API.

An event block object containing one or more event objects is injected into a source window of the one or more source windows 806 from an instance of an event publishing application on event publishing device 1022. The event block object may be generated, for example, by the event publishing application and may be received by publishing client 1002. A unique ID may be maintained as the event block object is passed between the one or more source windows 806 and/or the one or more derived windows 808 of ESPE 800, and to subscribing client A 1004, subscribing client B 1006, and subscribing client C 1008 and to event subscription device A 1024a, event subscription device B 1024b, and event subscription device C 1024c. Publishing client 1002 may further generate and include a unique embedded transaction ID in the event block object as the event block object is processed by a continuous query, as well as the unique ID that publishing device 1022 assigned to the event block object.

In an operation 912, the event block object is processed through the one or more continuous queries 804. In an operation 914, the processed event block object is output to one or more computing devices of the event subscribing devices 1024a-c. For example, subscribing client A 1004, subscribing client B 1006, and subscribing client C 1008 may send the received event block object to event subscription device A 1024a, event subscription device B 1024b, and event subscription device C 1024c, respectively.

ESPE 800 maintains the event block containership aspect of the received event blocks from when the event block is published into a source window and works its way through the directed graph defined by the one or more continuous queries 804 with the various event translations before being output to subscribers. Subscribers can correlate a group of subscribed events back to a group of published events by comparing the unique ID of the event block object that a publisher, such as publishing device 1022, attached to the event block object with the event block ID received by the subscriber.

In an operation 916, a determination is made concerning whether or not processing is stopped. If processing is not stopped, processing continues in operation 910 to continue receiving the one or more event streams containing event block objects from the, for example, one or more network devices. If processing is stopped, processing continues in an operation 918. In operation 918, the started projects are stopped. In operation 920, the ESPE is shutdown.

As noted, in some embodiments, big data is processed for an analytics project after the data is received and stored. In other embodiments, distributed applications process continuously flowing data in real-time from distributed sources by applying queries to the data before distributing the data to geographically distributed recipients. As noted, an event stream processing engine (ESPE) may continuously apply the queries to the data as it is received and determines which entities receive the processed data. This allows for large amounts of data being received and/or collected in a variety of environments to be processed and distributed in real time. For example, as shown with respect to FIG. 2, data may be collected from network devices that may include devices within the internet of things, such as devices within a home automation network. However, such data may be collected from a variety of different resources in a variety of different environments. In any such situation, embodiments of the present technology allow for real-time processing of such data.

Aspects of the current disclosure provide technical solutions to technical problems, such as computing problems that arise when an ESP device fails which results in a complete service interruption and potentially significant data loss. The data loss can be catastrophic when the streamed data is supporting mission critical operations such as those in support of an ongoing manufacturing or drilling operation. An embodiment of an ESP system achieves a rapid and seamless failover of ESPE running at the plurality of ESP devices without service interruption or data loss, thus significantly improving the reliability of an operational system that relies on the live or real-time processing of the data streams. The event publishing systems, the event subscribing systems, and each ESPE not executing at a failed ESP device are not aware of or effected by the failed ESP device. The ESP system may include thousands of event publishing systems and event subscribing systems. The ESP system keeps the failover logic and awareness within the boundaries of out-messaging network connector and out-messaging network device.

In one example embodiment, a system is provided to support a failover when event stream processing (ESP) event blocks. The system includes, but is not limited to, an out-messaging network device and a computing device. The computing device includes, but is not limited to, a processor and a computer-readable medium operably coupled to the processor. The processor is configured to execute an ESP engine (ESPE). The computer-readable medium has instructions stored thereon that, when executed by the processor, cause the computing device to support the failover. An event block object is received from the ESPE that includes a unique identifier. A first status of the computing device as active or standby is determined. When the first status is active, a second status of the computing device as newly active or not newly active is determined. Newly active is determined when the computing device is switched from a standby status to an active status. When the second status is newly active, a last published event block object identifier that uniquely identifies a last published event block object is determined. A next event block object is selected from a non-transitory computer-readable medium accessible by the computing device. The next event block object has an event block object identifier that is greater than the determined last published event block object identifier. The selected next event block object is published to an out-messaging network device. When the second status of the computing device is not newly active, the received event block object is published to the out-messaging network device. When the first status of the computing device is standby, the received event block object is stored in the non-transitory computer-readable medium.

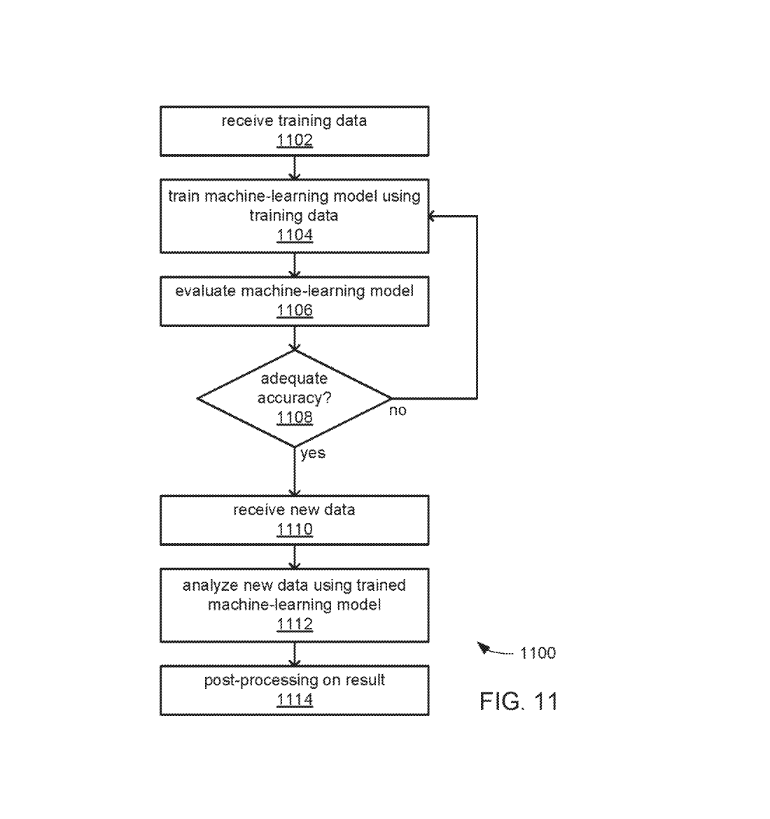

FIG. 11 is a flow chart of an example of a process for generating and using a machine-learning model according to some aspects. Machine learning is a branch of artificial intelligence that relates to mathematical models that can learn from, categorize, and make predictions about data. Such mathematical models, which can be referred to as machine-learning models, can classify input data among two or more classes; cluster input data among two or more groups; predict a result based on input data; identify patterns or trends in input data; identify a distribution of input data in a space; or any combination of these. Examples of machine-learning models can include (i) neural networks; (ii) decision trees, such as classification trees and regression trees; (iii) classifiers, such as Naïve bias classifiers, logistic regression classifiers, ridge regression classifiers, random forest classifiers, least absolute shrinkage and selector (LASSO) classifiers, and support vector machines; (iv) clusterers, such as k-means clusterers, mean-shift clusterers, and spectral clusterers; (v) factorizers, such as factorization machines, principal component analyzers and kernel principal component analyzers; and (vi) ensembles or other combinations of machine-learning models. In some examples, neural networks can include deep neural networks, feed-forward neural networks, recurrent neural networks, convolutional neural networks, radial basis function (RBF) neural networks, echo state neural networks, long short-term memory neural networks, bi-directional recurrent neural networks, gated neural networks, hierarchical recurrent neural networks, stochastic neural networks, modular neural networks, spiking neural networks, dynamic neural networks, cascading neural networks, neuro-fuzzy neural networks, or any combination of these.

Different machine-learning models may be used interchangeably to perform a task. Examples of tasks that can be performed at least partially using machine-learning models include various types of scoring; bioinformatics; cheminformatics; software engineering; fraud detection; customer segmentation; generating online recommendations; adaptive websites; determining customer lifetime value; search engines; placing advertisements in real time or near real time; classifying DNA sequences; affective computing; performing natural language processing and understanding; object recognition and computer vision; robotic locomotion; playing games; optimization and metaheuristics; detecting network intrusions; medical diagnosis and monitoring; or predicting when an asset, such as a machine, will need maintenance.

Any number and combination of tools can be used to create machine-learning models. Examples of tools for creating and managing machine-learning models can include SAS® Enterprise Miner, SAS® Rapid Predictive Modeler, and SAS® Model Manager, SAS Cloud Analytic Services (CAS) ®, SAS Viya ® of all which are by SAS Institute Inc. of Cary, North Carolina.

Machine-learning models can be constructed through an at least partially automated (e.g., with little or no human involvement) process called training. During training, input data can be iteratively supplied to a machine-learning model to enable the machine-learning model to identify patterns related to the input data or to identify relationships between the input data and output data. With training, the machine-learning model can be transformed from an untrained state to a trained state. Input data can be split into one or more training sets and one or more validation sets, and the training process may be repeated multiple times. The splitting may follow a k-fold cross-validation rule, a leave-one-out-rule, a leave-p-out rule, or a holdout rule. An overview of training and using a machine-learning model is described below with respect to the flow chart of FIG. 11.

In block 1102, training data is received. In some examples, the training data is received from a remote database or a local database, constructed from various subsets of data, or input by a user. The training data can be used in its raw form for training a machine-learning model or pre-processed into another form, which can then be used for training the machine-learning model. For example, the raw form of the training data can be smoothed, truncated, aggregated, clustered, or otherwise manipulated into another form, which can then be used for training the machine-learning model.

In block 1104, a machine-learning model is trained using the training data. The machine-learning model can be trained in a supervised, unsupervised, or semi-supervised manner. In supervised training, each input in the training data is correlated to a desired output. This desired output may be a scalar, a vector, or a different type of data structure such as text or an image. This may enable the machine-learning model to learn a mapping between the inputs and desired outputs. In unsupervised training, the training data includes inputs, but not desired outputs, so that the machine-learning model has to find structure in the inputs on its own. In semi-supervised training, only some of the inputs in the training data are correlated to desired outputs.

In block 1106, the machine-learning model is evaluated. For example, an evaluation dataset can be obtained, for example, via user input or from a database. The evaluation dataset can include inputs correlated to desired outputs. The inputs can be provided to the machine-learning model and the outputs from the machine-learning model can be compared to the desired outputs. If the outputs from the machine-learning model closely correspond with the desired outputs, the machine-learning model may have a high degree of accuracy. For example, if 90% or more of the outputs from the machine-learning model are the same as the desired outputs in the evaluation dataset, the machine-learning model may have a high degree of accuracy. Otherwise, the machine-learning model may have a low degree of accuracy. The 90% number is an example only. A realistic and desirable accuracy percentage is dependent on the problem and the data.

In some examples, if, at 1108, the machine-learning model has an inadequate degree of accuracy for a particular task, the process can return to block 1104, where the machine-learning model can be further trained using additional training data or otherwise modified to improve accuracy. However, if, at 1108. the machine-learning model has an adequate degree of accuracy for the particular task, the process can continue to block 1110.

In block 1110, new data is received. In some examples, the new data is received from a remote database or a local database, constructed from various subsets of data, or input by a user. The new data may be unknown to the machine-learning model. For example, the machine-learning model may not have previously processed or analyzed the new data.

In block 1112, the trained machine-learning model is used to analyze the new data and provide a result. For example, the new data can be provided as input to the trained machine-learning model. The trained machine-learning model can analyze the new data and provide a result that includes a classification of the new data into a particular class, a clustering of the new data into a particular group, a prediction based on the new data, or any combination of these.

In block 1114, the result is post-processed. For example, the result can be added to, multiplied with, or otherwise combined with other data as part of a job. As another example, the result can be transformed from a first format, such as a time series format, into another format, such as a count series format. Any number and combination of operations can be performed on the result during post-processing.

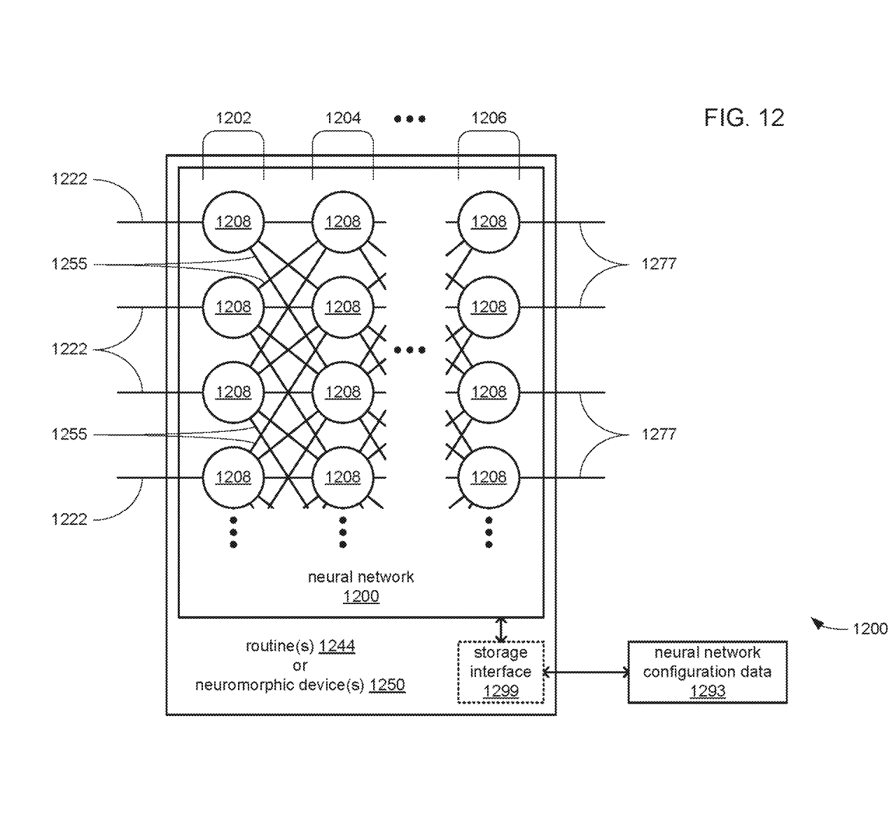

A more specific example of a machine-learning model is the neural network 1200 shown in FIG. 12. The neural network 1200 is represented as multiple layers of neurons 1208 that can exchange data between one another via connections 1255 that may be selectively instantiated thereamong. The layers include an input layer 1202 for receiving input data provided at inputs 1222, one or more hidden layers 1204, and an output layer 1206 for providing a result at outputs 1277. The hidden layer(s) 1204 are referred to as hidden because they may not be directly observable or have their inputs or outputs directly accessible during the normal functioning of the neural network 1200. Although the neural network 1200 is shown as having a specific number of layers and neurons for exemplary purposes, the neural network 1200 can have any number and combination of layers, and each layer can have any number and combination of neurons.

The neurons 1208 and connections 1255 thereamong may have numeric weights, which can be tuned during training of the neural network 1200. For example, training data can be provided to at least the inputs 1222 to the input layer 1202 of the neural network 1200, and the neural network 1200 can use the training data to tune one or more numeric weights of the neural network 1200. In some examples, the neural network 1200 can be trained using backpropagation. Backpropagation can include determining a gradient of a particular numeric weight based on a difference between an actual output of the neural network 1200 at the outputs 1277 and a desired output of the neural network 1200. Based on the gradient, one or more numeric weights of the neural network 1200 can be updated to reduce the difference therebetween, thereby increasing the accuracy of the neural network 1200. This process can be repeated multiple times to train the neural network 1200. For example, this process can be repeated hundreds or thousands of times to train the neural network 1200.

In some examples, the neural network 1200 is a feed-forward neural network. In a feed-forward neural network, the connections 1255 are instantiated and/or weighted so that every neuron 1208 only propagates an output value to a subsequent layer of the neural network 1200. For example, data may only move one direction (forward) from one neuron 1208 to the next neuron 1208 in a feed-forward neural network. Such a "forward" direction may be defined as proceeding from the input layer 1202 through the one or more hidden layers 1204, and toward the output layer 1206.

In other examples, the neural network 1200 may be a recurrent neural network. A recurrent neural network can include one or more feedback loops among the connections 1255, thereby allowing data to propagate in both forward and backward through the neural network 1200. Such a "backward" direction may be defined as proceeding in the opposite direction of forward, such as from the output layer 1206 through the one or more hidden layers 1204, and toward the input layer 1202. This can allow for information to persist within the recurrent neural network. For example, a recurrent neural network can determine an output based at least partially on information that the recurrent neural network has seen before, giving the recurrent neural network the ability to use previous input to inform the output.

In some examples, the neural network 1200 operates by receiving a vector of numbers from one layer; transforming the vector of numbers into a new vector of numbers using a matrix of numeric weights, a nonlinearity, or both; and providing the new vector of numbers to a subsequent layer ("subsequent" in the sense of moving "forward") of the neural network 1200. Each subsequent layer of the neural network 1200 can repeat this process until the neural network 1200 outputs a final result at the outputs 1277 of the output layer 1206. For example, the neural network 1200 can receive a vector of numbers at the inputs 1222 of the input layer 1202. The neural network 1200 can multiply the vector of numbers by a matrix of numeric weights to determine a weighted vector. The matrix of numeric weights can be tuned during the training of the neural network 1200. The neural network 1200 can transform the weighted vector using a nonlinearity, such as a sigmoid tangent or the hyperbolic tangent. In some examples, the nonlinearity can include a rectified linear unit, which can be expressed using the equation y = max(x, 0) where y is the output and x is an input value from the weighted vector. The transformed output can be supplied to a subsequent layer (e.g., a hidden layer 1204) of the neural network 1200. The subsequent layer of the neural network 1200 can receive the transformed output, multiply the transformed output by a matrix of numeric weights and a nonlinearity, and provide the result to yet another layer of the neural network 1200 (e.g., another, subsequent, hidden layer 1204). This process continues until the neural network 1200 outputs a final result at the outputs 1277 of the output layer 1206.

As also depicted in FIG. 12, the neural network 1200 may be implemented either through the execution of the instructions of one or more routines 1244 by central processing units (CPUs), or through the use of one or more neuromorphic devices 1250 that incorporate a set of memristors (or other similar components) that each function to implement one of the neurons 1208 in hardware. Where multiple neuromorphic devices 1250 are used, they may be interconnected in a depth-wise manner to enable implementing neural networks with greater quantities of layers, and/or in a width-wise manner to enable implementing neural networks having greater quantities of neurons 1208 per layer.

The neuromorphic device 1250 may incorporate a storage interface 1299 by which neural network configuration data 1293 that is descriptive of various parameters and hyper parameters of the neural network 1200 may be stored and/or retrieved. More specifically, the neural network configuration data 1293 may include such parameters as weighting and/or biasing values derived through the training of the neural network 1200, as has been described. Alternatively, or additionally, the neural network configuration data 1293 may include such hyperparameters as the manner in which the neurons 1208 are to be interconnected (e.g., feed-forward or recurrent), the trigger function to be implemented within the neurons 1208, the quantity of layers and/or the overall quantity of the neurons 1208. The neural network configuration data 1293 may provide such information for more than one neuromorphic device 1250 where multiple ones have been interconnected to support larger neural networks.

Other examples of the present disclosure may include any number and combination of machine-learning models having any number and combination of characteristics. The machine-learning model(s) can be trained in a supervised, semi-supervised, or unsupervised manner, or any combination of these. The machine-learning model(s) can be implemented using a single computing device or multiple computing devices, such as the communications grid computing system 400 discussed above.

Implementing some examples of the present disclosure at least in part by using machine-learning models can reduce the total number of processing iterations, time, memory, electrical power, or any combination of these consumed by a computing device when analyzing data. For example, a neural network may more readily identify patterns in data than other approaches. This may enable the neural network to analyze the data using fewer processing cycles and less memory than other approaches, while obtaining a similar or greater level of accuracy.

Some machine-learning approaches may be more efficiently and speedily executed and processed with machine-learning specific processors (e.g., not a generic CPU). Such processors may also provide an energy savings when compared to generic CPUs. For example, some of these processors can include a graphical processing unit (GPU), an application-specific integrated circuit (ASIC), a field-programmable gate array (FPGA), an artificial intelligence (AI) accelerator, a neural computing core, a neural computing engine, a neural processing unit, a purpose-built chip architecture for deep learning, and/or some other machine-learning specific processor that implements a machine learning approach or one or more neural networks using semiconductor (e.g., silicon (Si), gallium arsenide(GaAs)) devices. These processors may also be employed in heterogeneous computing architectures with a number of and/or a variety of different types of cores, engines, nodes, and/or layers to achieve various energy efficiencies, processing speed improvements, data communication speed improvements, and/or data efficiency targets and improvements throughout various parts of the system when compared to a homogeneous computing architecture that employs CPUs for general purpose computing.

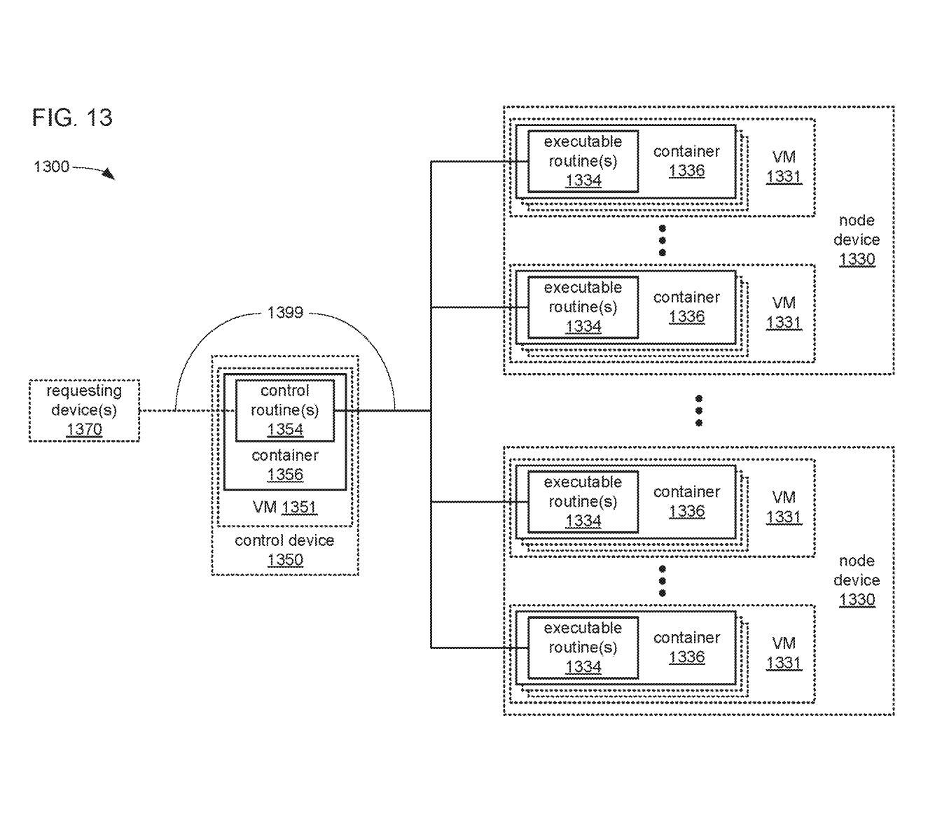

FIG. 13 illustrates various aspects of the use of containers 1336 as a mechanism to allocate processing, storage and/or other resources of a processing system 1300 to the performance of various analyses. More specifically, in a processing system 1300 that includes one or more node devices 1330 (e.g., the aforedescribed grid system 400), the processing, storage and/or other resources of each node device 1330 may be allocated through the instantiation and/or maintenance of multiple containers 1336 within the node devices 1330 to support the performance(s) of one or more analyses. As each container 1336 is instantiated, predetermined amounts of processing, storage and/or other resources may be allocated thereto as part of creating an execution environment therein in which one or more executable routines 1334 may be executed to cause the performance of part or all of each analysis that is requested to be performed.

It may be that at least a subset of the containers 1336 are each allocated a similar combination and amounts of resources so that each is of a similar configuration with a similar range of capabilities, and therefore, are interchangeable. This may be done in embodiments in which it is desired to have at least such a subset of the containers 1336 already instantiated prior to the receipt of requests to perform analyses, and thus, prior to the specific resource requirements of each of those analyses being known.

Alternatively, or additionally, it may be that at least a subset of the containers 1336 are not instantiated until after the processing system 1300 receives requests to perform analyses where each request may include indications of the resources required for one of those analyses. Such information concerning resource requirements may then be used to guide the selection of resources and/or the amount of each resource allocated to each such container 1336. As a result, it may be that one or more of the containers 1336 are caused to have somewhat specialized configurations such that there may be differing types of containers to support the performance of different analyses and/or different portions of analyses.

It may be that the entirety of the logic of a requested analysis is implemented within a single executable routine 1334. In such embodiments, it may be that the entirety of that analysis is performed within a single container 1336 as that single executable routine 1334 is executed therein. However, it may be that such a single executable routine 1334, when executed, is at least intended to cause the instantiation of multiple instances of itself that are intended to be executed at least partially in parallel. This may result in the execution of multiple instances of such an executable routine 1334 within a single container 1336 and/or across multiple containers 1336.

Alternatively, or additionally, it may be that the logic of a requested analysis is implemented with multiple differing executable routines 1334. In such embodiments, it may be that at least a subset of such differing executable routines 1334 are executed within a single container 1336. However, it may be that the execution of at least a subset of such differing executable routines 1334 is distributed across multiple containers 1336.

Where an executable routine 1334 of an analysis is under development, and/or is under scrutiny to confirm its functionality, it may be that the container 1336 within which that executable routine 1334 is to be executed is additionally configured assist in limiting and/or monitoring aspects of the functionality of that executable routine 1334. More specifically, the execution environment provided by such a container 1336 may be configured to enforce limitations on accesses that are allowed to be made to memory and/or I/O addresses to control what storage locations and/or I/O devices may be accessible to that executable routine 1334. Such limitations may be derived based on comments within the programming code of the executable routine 1334 and/or other information that describes what functionality the executable routine 1334 is expected to have, including what memory and/or I/O accesses are expected to be made when the executable routine 1334 is executed. Then, when the executable routine 1334 is executed within such a container 1336, the accesses that are attempted to be made by the executable routine 1334 may be monitored to identify any behavior that deviates from what is expected.

Where the possibility exists that different executable routines 1334 may be written in different programming languages, it may be that different subsets of containers 1336 are configured to support different programming languages. In such embodiments, it may be that each executable routine 1334 is analyzed to identify what programming language it is written in, and then what container 1336 is assigned to support the execution of that executable routine 1334 may be at least partially based on the identified programming language. Where the possibility exists that a single requested analysis may be based on the execution of multiple executable routines 1334 that may each be written in a different programming language, it may be that at least a subset of the containers 1336 are configured to support the performance of various data structure and/or data format conversion operations to enable a data object output by one executable routine 1334 written in one programming language to be accepted as an input to another executable routine 1334 written in another programming language.

As depicted, at least a subset of the containers 1336 may be instantiated within one or more VMs 1331 that may be instantiated within one or more node devices 1330. Thus, in some embodiments, it may be that the processing, storage and/or other resources of at least one node device 1330 may be partially allocated through the instantiation of one or more VMs 1331, and then in turn, may be further allocated within at least one VM 1331 through the instantiation of one or more containers 1336.

In some embodiments, it may be that such a nested allocation of resources may be carried out to affect an allocation of resources based on two differing criteria. By way of example, it may be that the instantiation of VMs 1331 is used to allocate the resources of a node device 1330 to multiple users or groups of users in accordance with any of a variety of service agreements by which amounts of processing, storage and/or other resources are paid for each such user or group of users. Then, within each VM 1331 or set of VMs 1331 that is allocated to a particular user or group of users, containers 1336 may be allocated to distribute the resources allocated to each VM 1331 among various analyses that are requested to be performed by that particular user or group of users.

As depicted, where the processing system 1300 includes more than one node device 1330, the processing system 1300 may also include at least one control device 1350 within which one or more control routines 1354 may be executed to control various aspects of the use of the node device(s) 1330 to perform requested analyses. By way of example, it may be that at least one control routine 1354 implements logic to control the allocation of the processing, storage and/or other resources of each node device 1300 to each VM 1331 and/or container 1336 that is instantiated therein. Thus, it may be the control device(s) 1350 that effects a nested allocation of resources, such as the aforedescribed example allocation of resources based on two differing criteria.

As also depicted, the processing system 1300 may also include one or more distinct requesting devices 1370 from which requests to perform analyses may be received by the control device(s) 1350. Thus, and by way of example, it may be that at least one control routine 1354 implements logic to monitor for the receipt of requests from authorized users and/or groups of users for various analyses to be performed using the processing, storage and/or other resources of the node device(s) 1330 of the processing system 1300. The control device(s) 1350 may receive indications of the availability of resources, the status of the performances of analyses that are already underway, and/or still other status information from the node device(s) 1330 in response to polling, at a recurring interval of time, and/or in response to the occurrence of various preselected events. More specifically, the control device(s) 1350 may receive indications of status for each container 1336, each VM 1331 and/or each node device 1330. At least one control routine 1354 may implement logic that may use such information to select container(s) 1336, VM(s) 1331 and/or node device(s) 1330 that are to be used in the execution of the executable routine(s) 1334 associated with each requested analysis.

As further depicted, in some embodiments, the one or more control routines 1354 may be executed within one or more containers 1356 and/or within one or more VMs 1351 that may be instantiated within the one or more control devices 1350. It may be that multiple instances of one or more varieties of control routine 1354 may be executed within separate containers 1356, within separate VMs 1351 and/or within separate control devices 1350 to better enable parallelized control over parallel performances of requested analyses, to provide improved redundancy against failures for such control functions, and/or to separate differing ones of the control routines 1354 that perform different functions. By way of example, it may be that multiple instances of a first variety of control routine 1354 that communicate with the requesting device(s) 1370 are executed in a first set of containers 1356 instantiated within a first VM 1351, while multiple instances of a second variety of control routine 1354 that control the allocation of resources of the node device(s) 1330 are executed in a second set of containers 1356 instantiated within a second VM 1351. It may be that the control of the allocation of resources for performing requested analyses may include deriving an order of performance of portions of each requested analysis based on such factors as data dependencies thereamong, as well as allocating the use of containers 1336 in a manner that effectuates such a derived order of performance.

Where multiple instances of control routine 1354 are used to control the allocation of resources for performing requested analyses, such as the assignment of individual ones of the containers 1336 to be used in executing executable routines 1334 of each of multiple requested analyses, it may be that each requested analysis is assigned to be controlled by just one of the instances of control routine 1354. This may be done as part of treating each requested analysis as one or more "ACID transactions" that each have the four properties of atomicity, consistency, isolation and durability such that a single instance of control routine 1354 is given full control over the entirety of each such transaction to better ensure that either all of each such transaction is either entirely performed or is entirely not performed. As will be familiar to those skilled in the art, allowing partial performances to occur may cause cache incoherencies and/or data corruption issues.

As additionally depicted, the control device(s) 1350 may communicate with the requesting device(s) 1370 and with the node device(s) 1330 through portions of a network 1399 extending thereamong. Again, such a network as the depicted network 1399 may be based on any of a variety of wired and/or wireless technologies and may employ any of a variety of protocols by which commands, status, data and/or still other varieties of information may be exchanged. It may be that one or more instances of a control routine 1354 cause the instantiation and maintenance of a web portal or other variety of portal that is based on any of a variety of communication protocols, etc. (e.g., a restful API). Through such a portal, requests for the performance of various analyses may be received from requesting device(s) 1370, and/or the results of such requested analyses may be provided thereto. Alternatively, or additionally, it may be that one or more instances of a control routine 1354 cause the instantiation of and maintenance of a message passing interface and/or message queues. Through such an interface and/or queues, individual containers 1336 may each be assigned to execute at least one executable routine 1334 associated with a requested analysis to cause the performance of at least a portion of that analysis.

Although not specifically depicted, it may be that at least one control routine 1354 may include logic to implement a form of management of the containers 1336 based on the Kubernetes container management platform promulgated by Could Native Computing Foundation of San Francisco, CA, USA. In such embodiments, containers 1336 in which executable routines 1334 of requested analyses may be instantiated within "pods" (not specifically shown) in which other containers may also be instantiated for the execution of other supporting routines. Such supporting routines may cooperate with control routine(s) 1354 to implement a communications protocol with the control device(s) 1350 via the network 1399 (e.g., a message passing interface, one or more message queues, etc.). Alternatively, or additionally, such supporting routines may serve to provide access to one or more storage repositories (not specifically shown) in which at least data objects may be stored for use in performing the requested analyses.

### ASSOCIATED PROCESSES

Retrieval-augmented generation (RAG) may refer to an architectural framework that enhances the performance of a language model by combining generative language modeling with information retrieval techniques. For instance, performing RAG may involve a language model receiving a user query, retrieving embeddings from a vector database that are semantically similar to the user query, and using those embeddings to generate a response to the user query. These embeddings may be derived from a data source, which may ground the response in the logic of the data sources (e.g., as opposed to the internal logic of the language model, which may be more prone to hallucinations). Setting up RAG may generally involve ingesting a data source, extracting text from the data source, segmenting the extracted text into chunks, generating vector embeddings for each of the chunks, and storing the vector embeddings in a vector database. The systems involved in setting up RAG (e.g., from source ingestion to storage of vector embeddings in a vector database) may be collectively referred to as a vectorization pipeline or a vectorization service.

Configuring a vectorization pipeline may generally involve manually coordinating each of the separate systems within the vectorization pipeline. For instance, getting each of these systems to work together may involve writing scripts that call and configure a given system (e.g., a text chunking system) within the vectorization pipeline and modifies the output of the given system to provide as input to a subsequent system (e.g., an embedding model) within the vectorization pipeline. This manual vectorization pipeline setup process may limit vectorization pipeline configuration only to users who have technical knowledge associated with writing scripts. Additionally, manually invoking and coordinating these systems may introduce vulnerabilities related to human-introduced errors involved in writing the scripts.

Additionally, it should be noted that certain vectorization pipeline configurations may be associated with higher performance (e.g., increased retrieval accuracy, increased response quality, reduced resource usage) as compared to other vectorization pipeline configurations. Thus, it is possible that RAG applications that utilize predefined vectorization pipeline configurations may have reduced performance as compared to RAG applications using other configurations for the vectorization pipeline. Additionally, statically configured vectorization pipelines may fail to capture changes in performance as characteristics associated with a given RAG application vary (e.g., if the source documents from which embeddings are generated are modified, if new source documents are added, or if any current source documents are removed). Accordingly, it may be beneficial to include an integrated mechanism for evaluating multiple vectorization pipeline configurations or for determining which configuration yields superior retrieval-augmented performance under evolving application conditions.

The disclosed RAG application development pipeline, by contrast, may automate configuration, evaluation and deployment of RAG applications. For instance, the disclosed RAG application development pipeline may include a first stage associated with setting up a vectorization pipeline and generating vector embeddings via the vectorization pipeline, a second stage associated with evaluating a RAG application that uses the generated embeddings, and a third stage associated with deploying the RAG application. The first stage may involve displaying a graphical user interface, receiving an indication of configuration parameters for a vectorization pipeline through the graphical user interface, and generating vector embeddings via the vectorization pipeline according to the indicated configuration parameters. The second stage may involve assessing a performance of a RAG application using vector embeddings generated via a vectorization pipeline set up in the first stage. In examples where multiple vectorization pipelines are configured in the first stage, the second stage may further include comparing the performance of the RAG application when using vector embeddings for each vectorization pipeline and selecting one of the vectorization pipelines for deployment with the RAG application (e.g., the one associated with the highest performance of the RAG application). The third stage may involve deploying the RAG application with vector embeddings generated according to the selected vectorization pipeline. In this manner, the disclosed RAG application development pipeline may provide an automated means of configuring a vectorization pipeline that prevents user-introduced error associated with manually configuring the vectorization pipeline. Further, the disclosed RAG application may enable comparison of vectorization pipelines such that the vectorization pipeline with the highest performance may be selected for integration into a RAG application.

By implementing configuration, evaluation, and deployment of RAG applications in three stages, the RAG application development pipeline as described herein may provide a modular automation framework that allows these stages to operate independently while remaining integrated through a unified interface. Separating these stages in this manner may enable improved scalability. For instance, having independent first and second stages may enable vector embeddings to be generated for a new vectorization pipeline configuration in the first stage while a currently existing vectorization pipeline configuration is evaluated in the second stage, thus reducing latency as compared to performing one task after the other. For instance, the first stage may meet a latency constraint when scaled horizontally across multiple nodes, whereas the second stage may meet latency constraints without the same degree of parallelization, thus allowing some of the nodes used in the first stage to be allocated towards other tasks. Further, separating these stages in this manner may improve system resilience. For instance, if the first stage of the RAG application development pipeline fails such that a user is no longer able to generate a new vector configuration object, the user may still evaluate currently existing vector configuration objects using the second stage and may deploy RAG applications according to the currently existing vector configuration objects.

In some examples, each component of the vectorization pipeline (e.g., OCR processing, table extraction, text extraction, chunking, embedding model selection, compression and quantization parameters, and vector database update strategies) may be configurable through a unified no-code interface, enabling users to create and modify vectorization pipelines without generating any scripts. This unified interface may further allow users to configure multiple vectorization pipelines in parallel and evaluate them within the same development environment, permitting experimentation with alternative configurations. Such a no-code approach may enable accelerated experimentation with vectorization pipeline configurations and may reduce technical barriers for RAG application development.

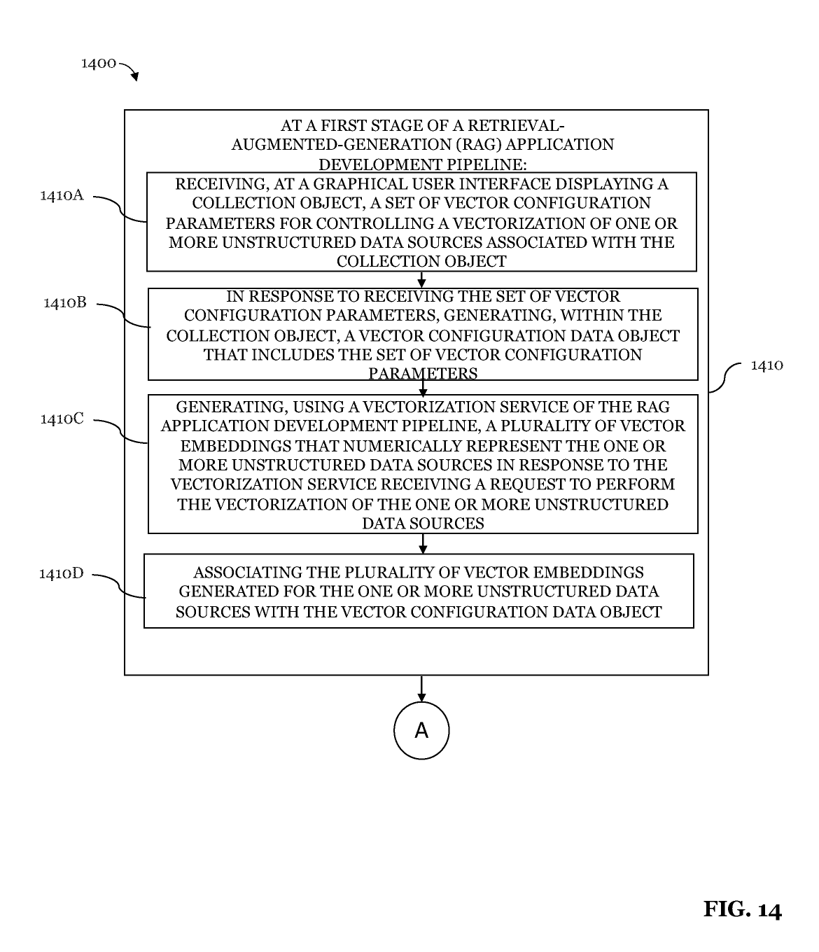

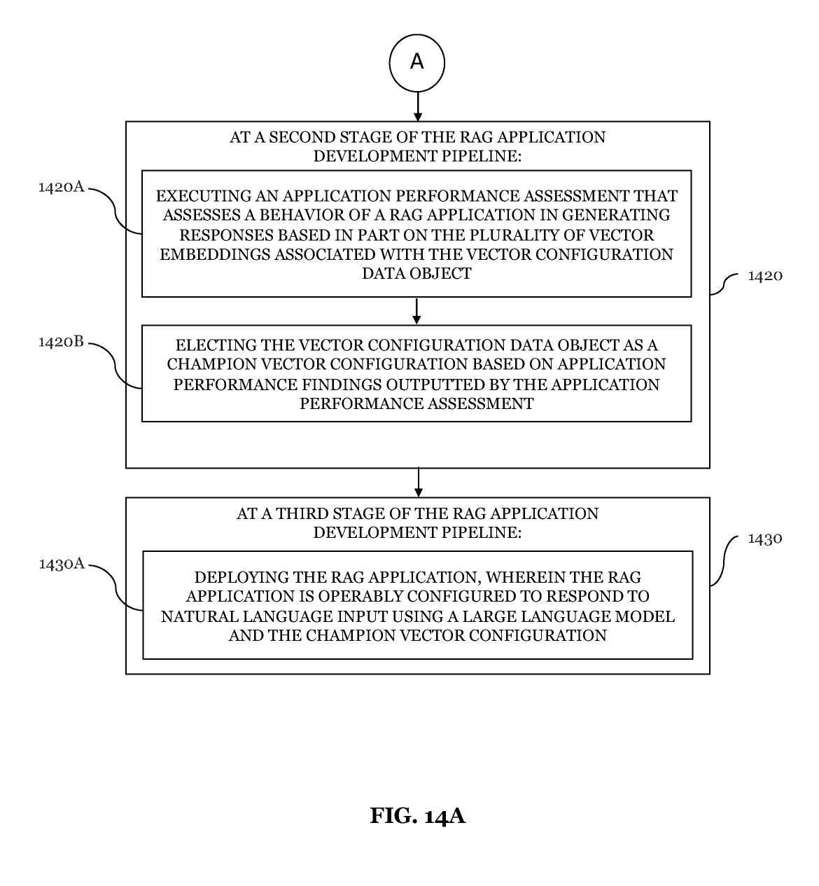

FIGS. 14 and 14A illustrate one embodiment of method 1400. It shall be appreciated that other embodiments contemplated within the scope of the present disclosure may involve more processes, fewer processes, different processes, or a different order of processes than illustrated in FIGS. 14 and 14A. It should be noted that a computer-program product may include a non-transitory machine-readable storage medium storing computer instructions that, when executed by one or more operations, may perform operations corresponding to the processes and sub-processes of method 1400. Additionally, or alternatively, a computer-implemented method may include operations corresponding to processes and sub-processes of method 1400. Additionally, or alternatively, a computer-implemented system may include one or more processors, a memory, and a computer-readable medium operably coupled to the one or more processors, the computer-readable medium having computer-readable instructions stored thereon that, when executed by the one or more processors, cause a computing device to perform operations corresponding to the processes and sub-processes of method 1400.

As shown in FIG. 14, process 1410 may represent operations that occur at a first stage of a RAG application development pipeline. The first stage of the RAG application development pipeline may involve configuring a vectorization pipeline and executing the vectorization pipeline in order to transform data sources into vector embeddings retrievable from a RAG application. The first stage of the RAG application development pipeline may function to enable a user to generate one or more candidate vectorization pipelines that may be evaluated at a second stage for integration into a RAG application. In some examples, the first stage of the RAG application development pipeline may be facilitated via a no-code graphical user interface that enables a user to configure and execute a vectorization pipeline without manual configuration and coordination of the associated systems involved in performing vectorization, thus improving accessibility and reducing user-introduced errors associated with performing this manual coordination and configuration.

As described herein, a “RAG application” may refer to a software application that is capable of receiving a user query, retrieving embeddings from a vector database that are semantically similar to the user query, and generating a response to the user query using the retrieved embeddings. In some examples, the RAG application may use a language model (e.g., a large language model (LLM)) to generate at least a portion of the response based on the retrieved embeddings. An “agent” may refer to a software construct that utilizes one or more RAG applications as building blocks in combination with additional control logic. For instance, an agent may include logic configured to select one or more collection objects or vector configuration objects for use in a retrieval operation, to invoke one or more tools or external application programming interfaces, and to orchestrate multiple calls to one or more LLMs as part of a multi-step reasoning process. In this manner, an agent may implement retrieval-augmented generation functionality together with decision logic that determines how retrieval operations, generation operations, and tool invocations are combined in response to a given user query.

The embeddings retrieved by the RAG application may be generated via a corresponding vectorization pipeline, where a “vectorization pipeline” may refer to a sequence of interconnected systems configured to transform one or more data sources into vector embeddings stored within a vector database for use by a RAG application. A “RAG application development pipeline” may refer to a computer-implemented system that automates the configuration, evaluation, and deployment of a RAG application. The system that implements a RAG application development pipeline may be referred to as a RAG application development service.

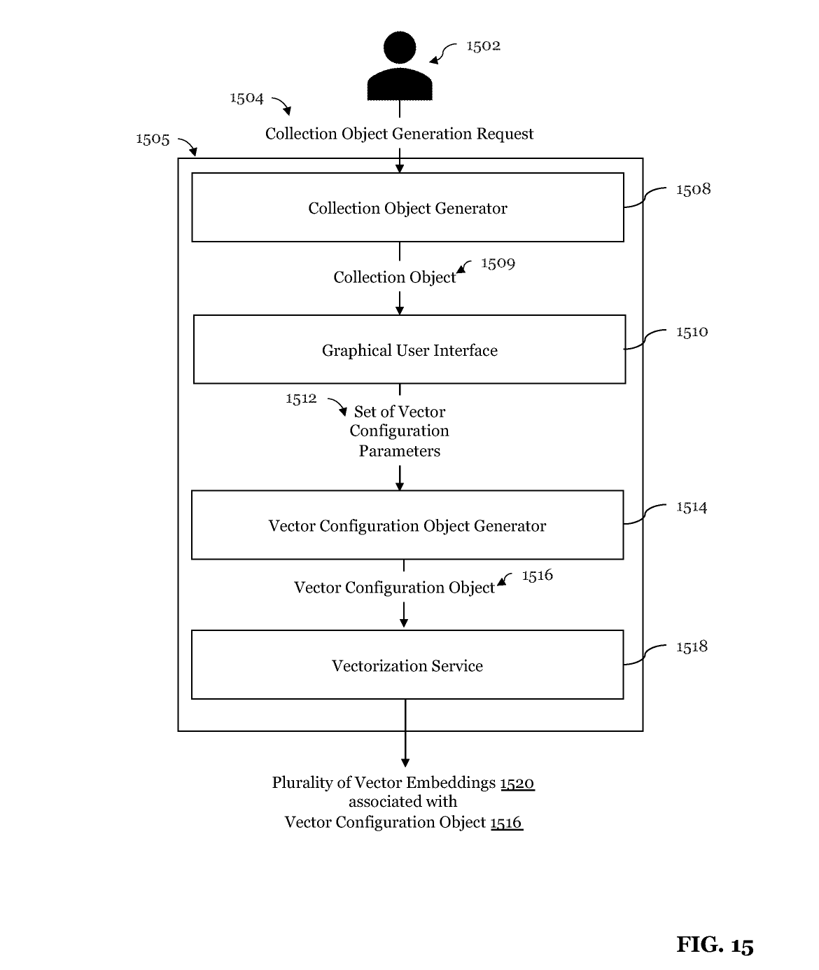

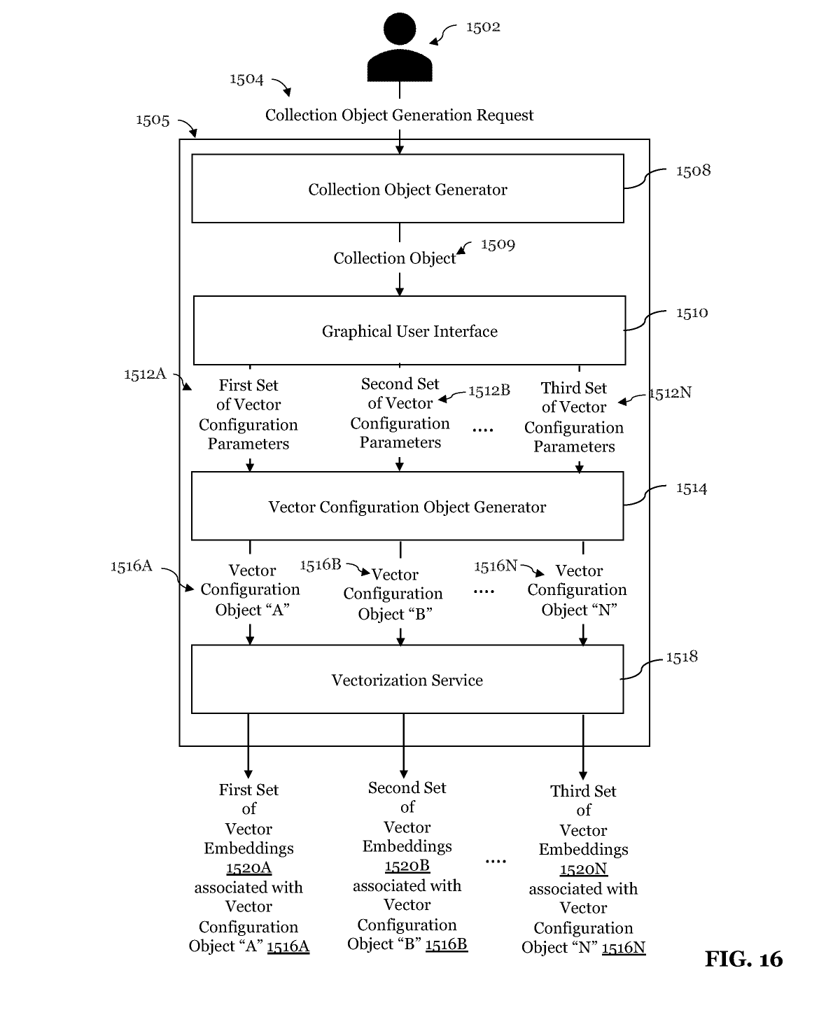

As shown in FIG. 14, sub-process 1410A of process 1410 may include receiving, at a graphical user interface displaying a collection object, a set of vector configuration parameters for controlling a vectorization of one or more unstructured data sources associated with the collection object. Receiving the set of vector configuration parameters may function to enable the RAG application deployment system to configure a new vectorization pipeline as defined by the vector configuration parameter values. Additionally, displaying a graphical user interface capable of providing the set of vector configuration parameters may provide a means for a user to specify how a new vectorization pipeline is to be configured without writing code. In a non-limiting example, as described with reference to FIG. 15, RAG application development service 1505 may include a graphical user interface 1510 configured to display a collection object 1509. The graphical user interface 1510 may additionally be configured to receive a set of vector configuration parameters 1512 for controlling a vectorization of one or more unstructured data sources associated with the collection object 1509 and may provide the set of vector configuration parameters 1512 to a vector configuration object generator 1514.

A “collection object” as described herein may refer to a data object that organizes and manages one or more data sources along with one or more vectorization pipelines that generate embeddings for the one or more data sources. Displaying the collection object may involve the graphical user interface displaying a dashboard-style view that provides information about the one or more associated data sources and the one or more associated vectorization pipelines. Additionally, displaying the collection object may involve the graphical user interface displaying user interface control elements and user interface input elements that enable vectorization parameters to be defined via user input to these user interface elements. For instance, the graphical user interface may display a new vector configuration button and may instantiate and display a vector configuration popover in response to receiving an input from a user selecting the new vector configuration button. The vector configuration popover may include a set of user interface control elements that receive the set of vector configuration parameters from the user.

In some examples, a user may request generation of a collection object. For instance, the user may provide user input to user interface input elements that configure characteristics of a collection object (e.g., which data sources are associated with the collection object) and may provide additional user input to a user interface control element in order to submit the collection object to the RAG application development service for persistence in a data store. In a non-limiting example, as described with reference to FIG. 15, user 1502 may provide a collection object generation request 1504 to a collection object generator 1508 of RAG application development service 1505. In response, the collection object generator 1508 may generate a collection object 1509 that is provided to a graphical user interface 1510 to be displayed.

The use of collection objects as described herein may provide for improved data security. For instance, when a user requests generation of a collection object, the RAG application development service may automatically generate a user access security policy controlling user access to the collection object and may automatically configure the user access security policy to include a user account of the user, which may enable the user to access, modify, and manage the collection object. Because the user access security policy controls user access, unauthorized users may not be able to gain access to the collection object, including its data sources or its vectorization pipelines. Accordingly, unauthorized users may not be able to use, for instance, embeddings generated by a vectorization pipeline in order to gain access to sensitive documents. It should be noted that the user may send requests to the RAG application development service in order to grant an additional user access to the collection object, in which the RAG application development service may adapt the user access security policy to authorize the additional user to access and modify the collection object.

A “user access security policy” may refer to a set of rules and permissions that governs which users or system identities can access, modify, or manage a collection object. When a user requests access to collection objects available to the user, the RAG application development service may check for any collection objects that include a user access security policy explicitly granting the user access. Accordingly, the RAG application development service may only display, within the graphical user interface, collection objects that are available to a user for further interaction. Alternatively, if the user attempts to access a particular collection object, the RAG application development service may only allow access to the collection object if the user is included within the corresponding user access security policy.

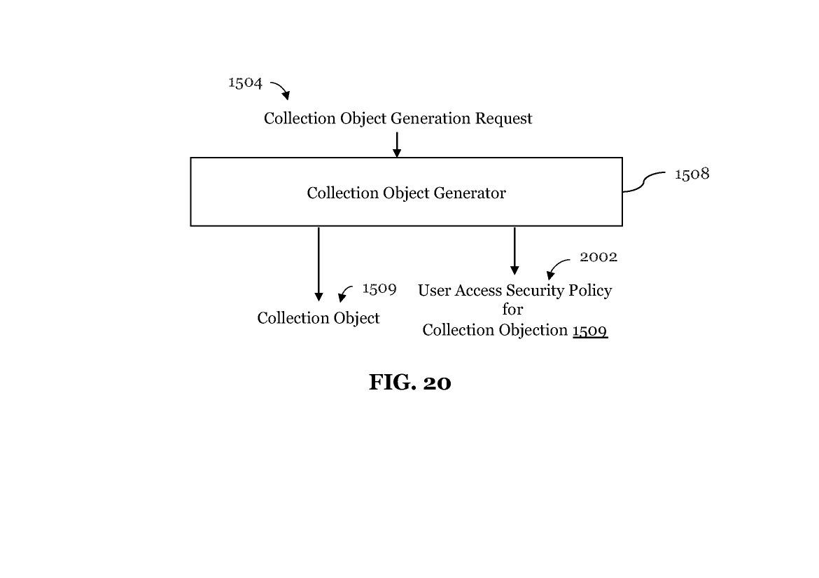

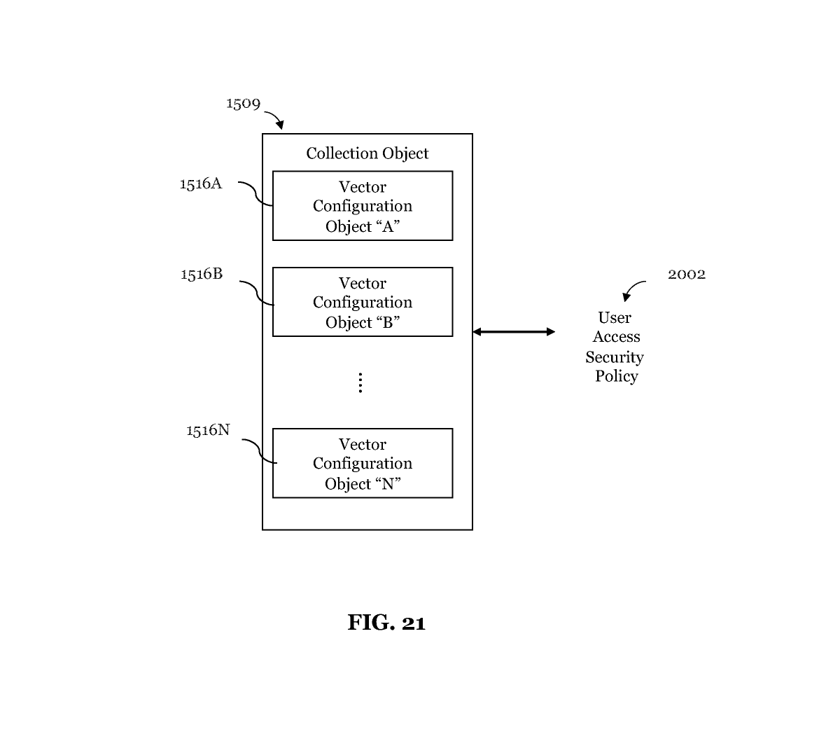

In a non-limiting example, as described with reference to FIG. 20, a collection object generator 1508 may receive a collection object generation request 1504 and may generate a collection object 1509 as well as a user access security policy 2002 for the collection object 1509. In an additional example, as described with reference to FIG. 21, the user access security policy 2002 may be applied to the collection object 1509 such that only an authorized user (user 1502) may have access to vector configurations associated with the collection object 1509 (e.g., vector configurations 1516A, 1516B, and 1516N).

In some examples, a RAG application development service may implement an access control model for large language models. The access control model may associate each available LLM with one or more user groups, such that a given LLM is accessible only to users belonging to a group authorized to utilize the LLM. For instance, when a user selects an LLM for use in a vectorization pipeline, an evaluation stage, or an agent configuration, the RAG application development service may determine whether the user is authorized to access the selected LLM based on a group associated with the user. If the user is not authorized to access the selected LLM, the RAG application development service may prevent selection of that LLM and may optionally identify one or more alternative LLMs accessible to the user based on the user’s group. In some examples, the access control model may also define a ranking of LLMs associated with a given group, enabling the RAG application development service to automatically select a fallback LLM when an LLM at a higher rank is unavailable or inaccessible. The access control model may operate independently from collection-level access control mechanisms such that an agent object may be restricted both by the collections it is permitted to access and by the LLMs it is authorized to invoke. In this manner, the RAG application development service may ensure that LLM invocation for configuration, evaluation, or agent execution complies with security policies associated with particular user groups.

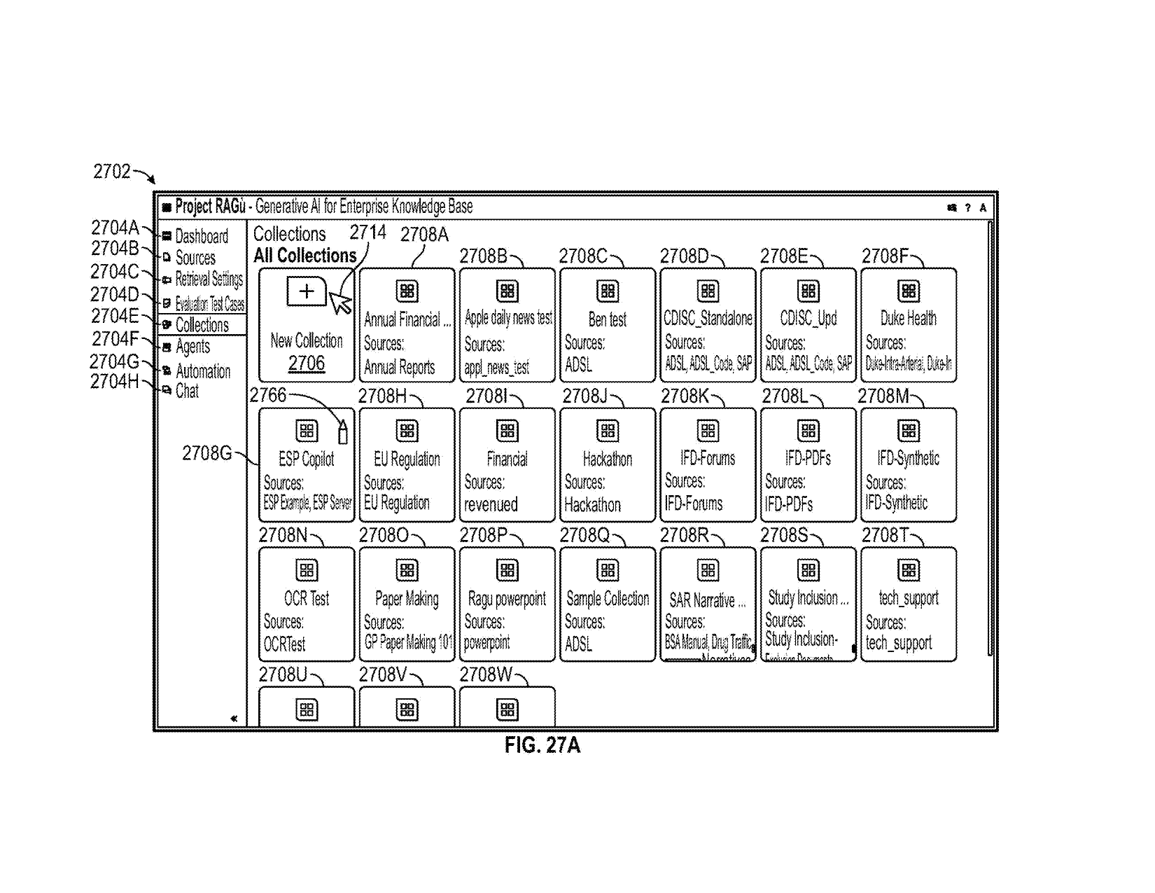

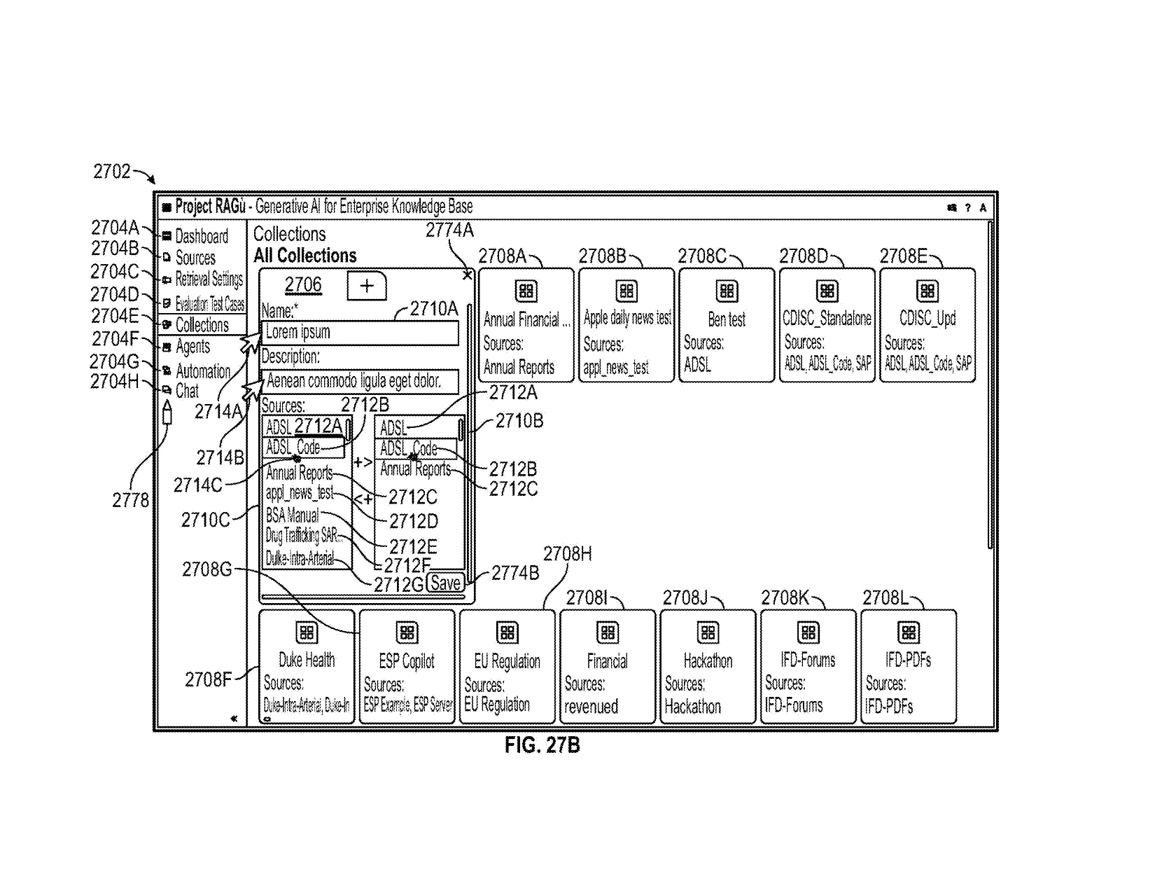

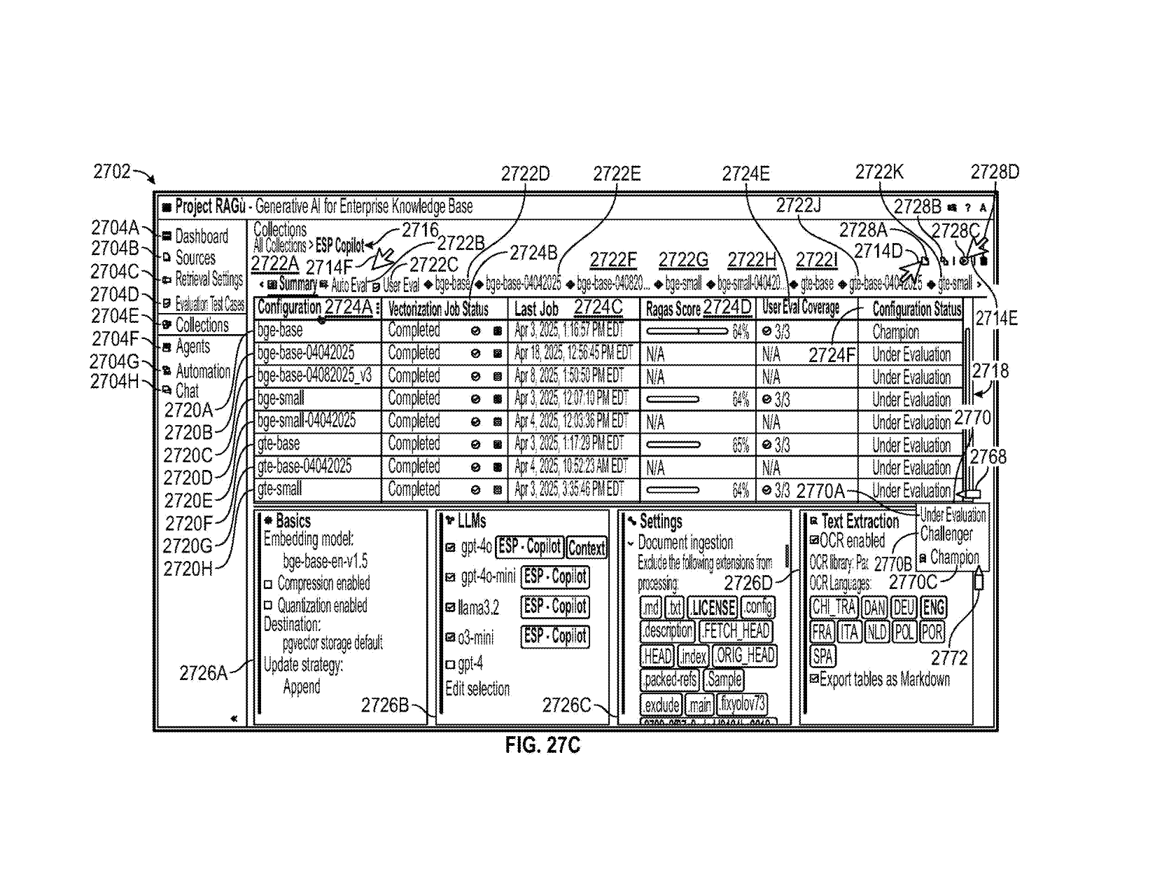

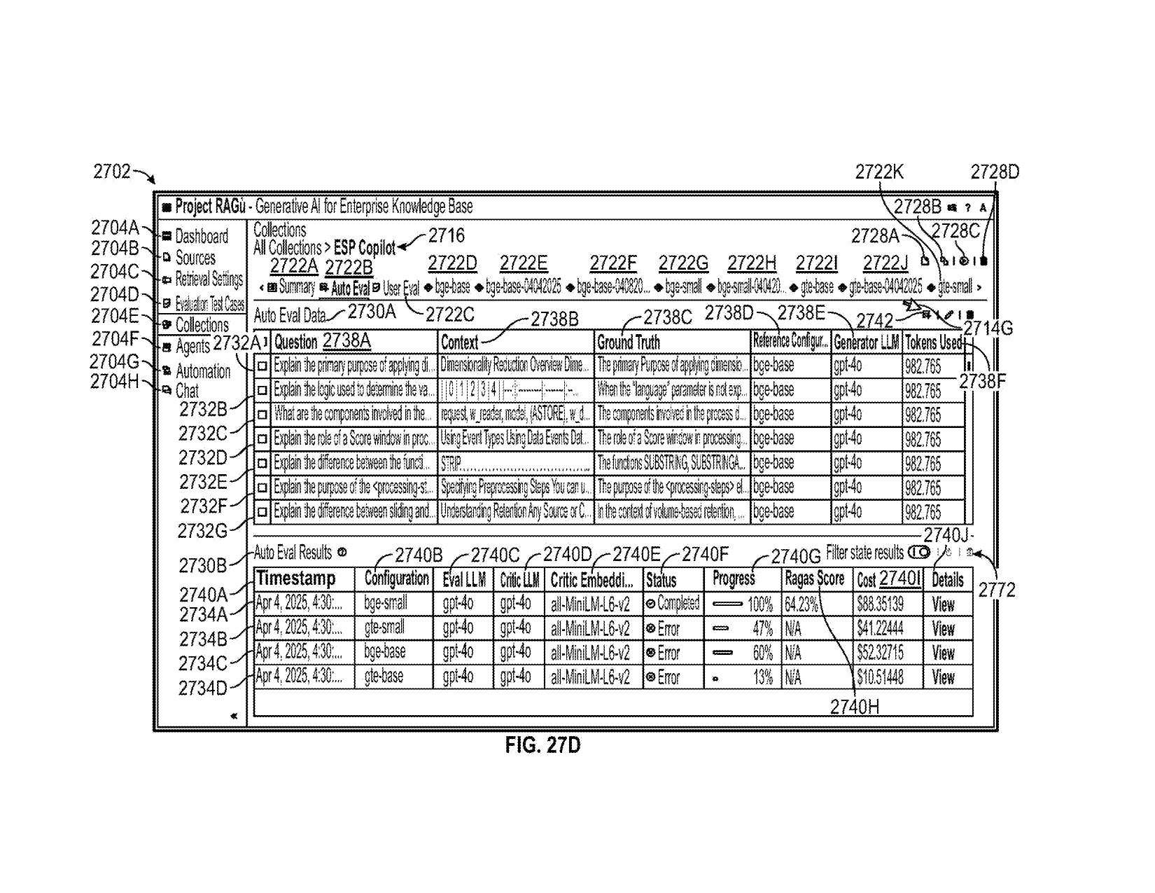

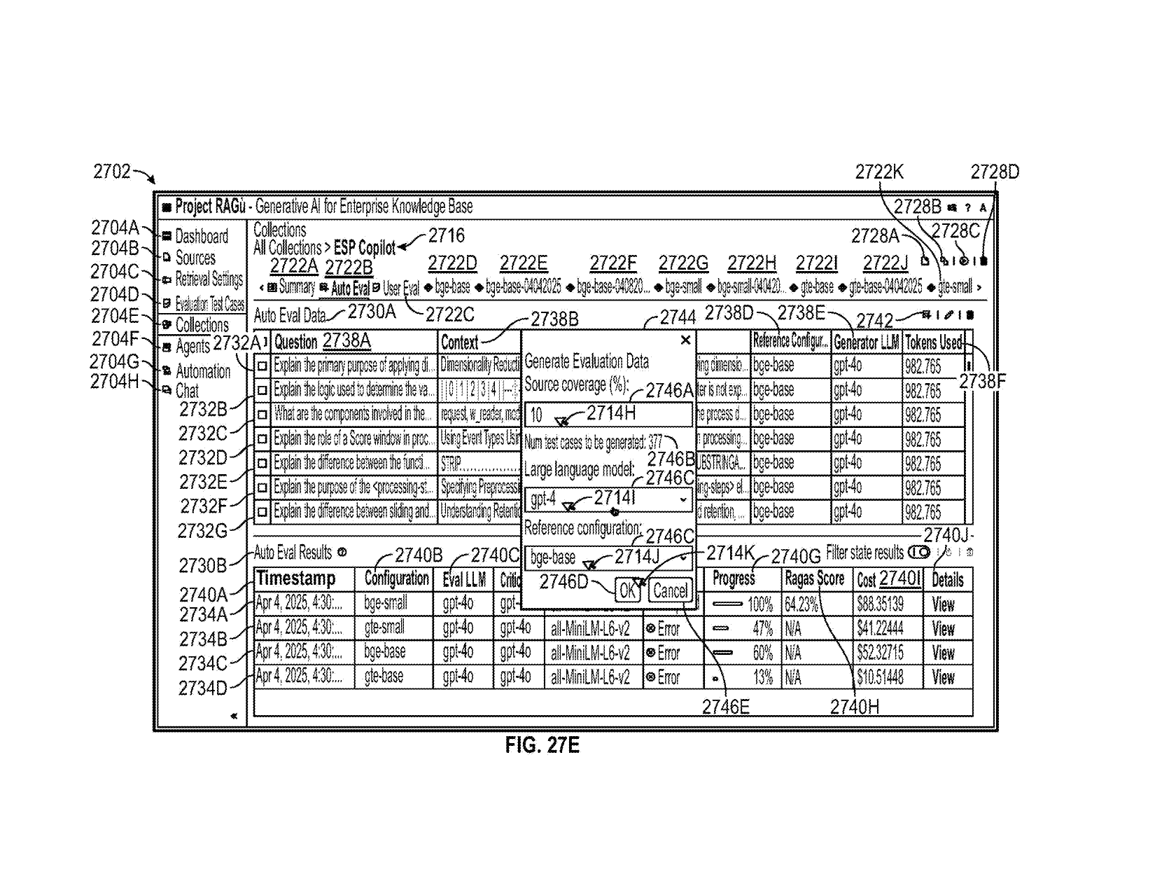

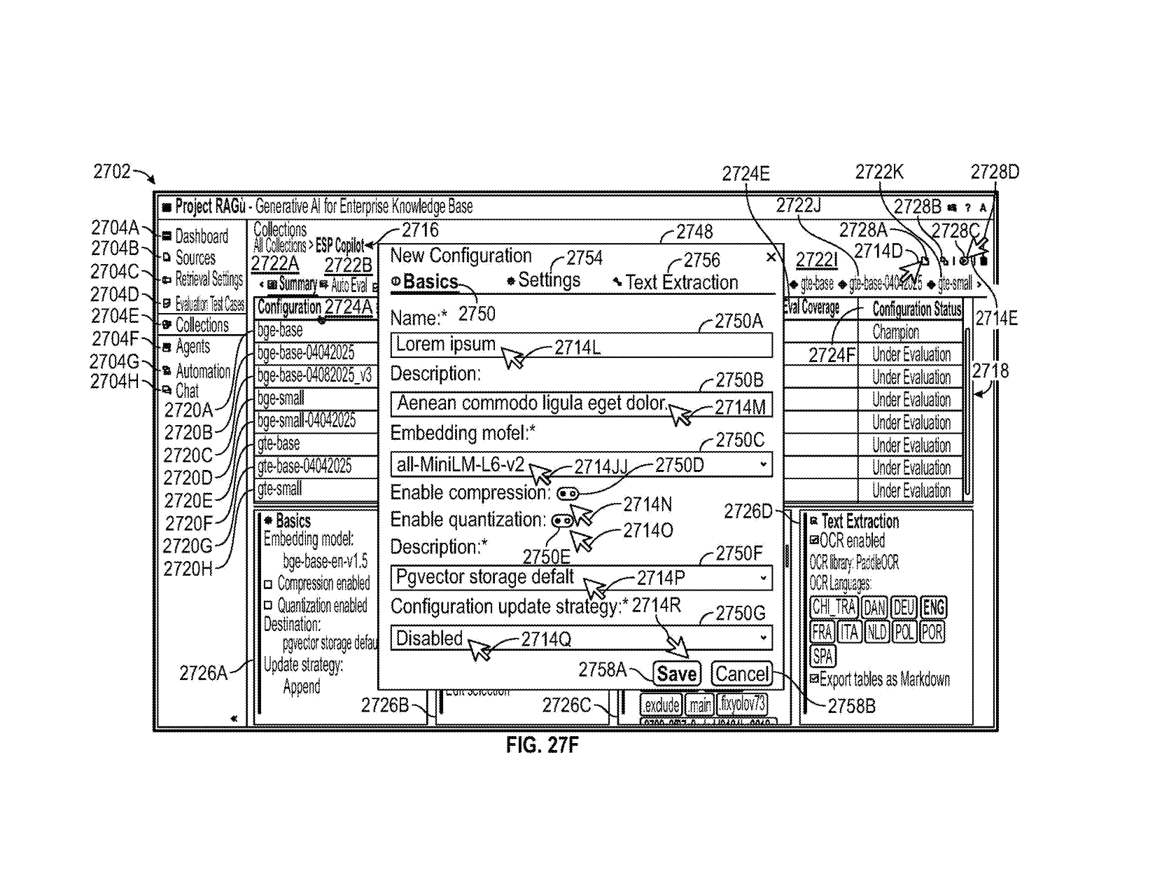

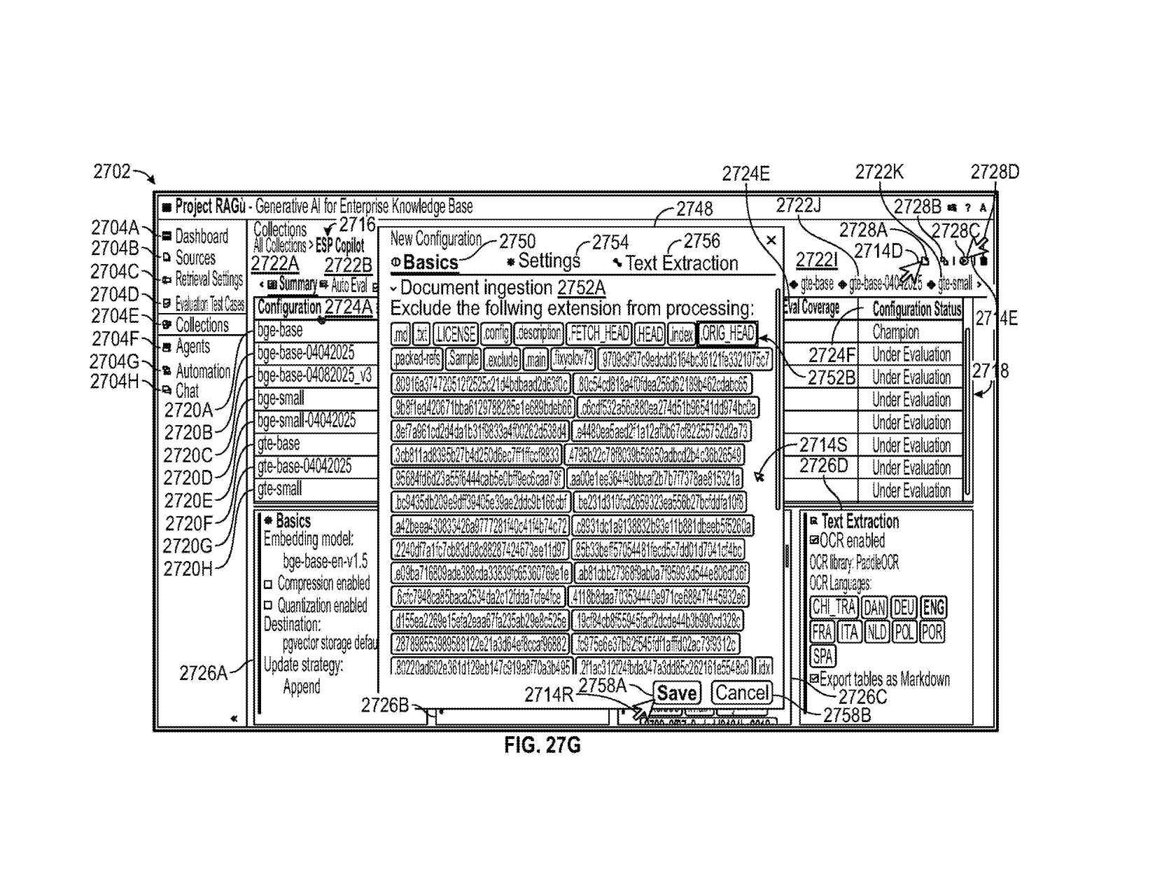

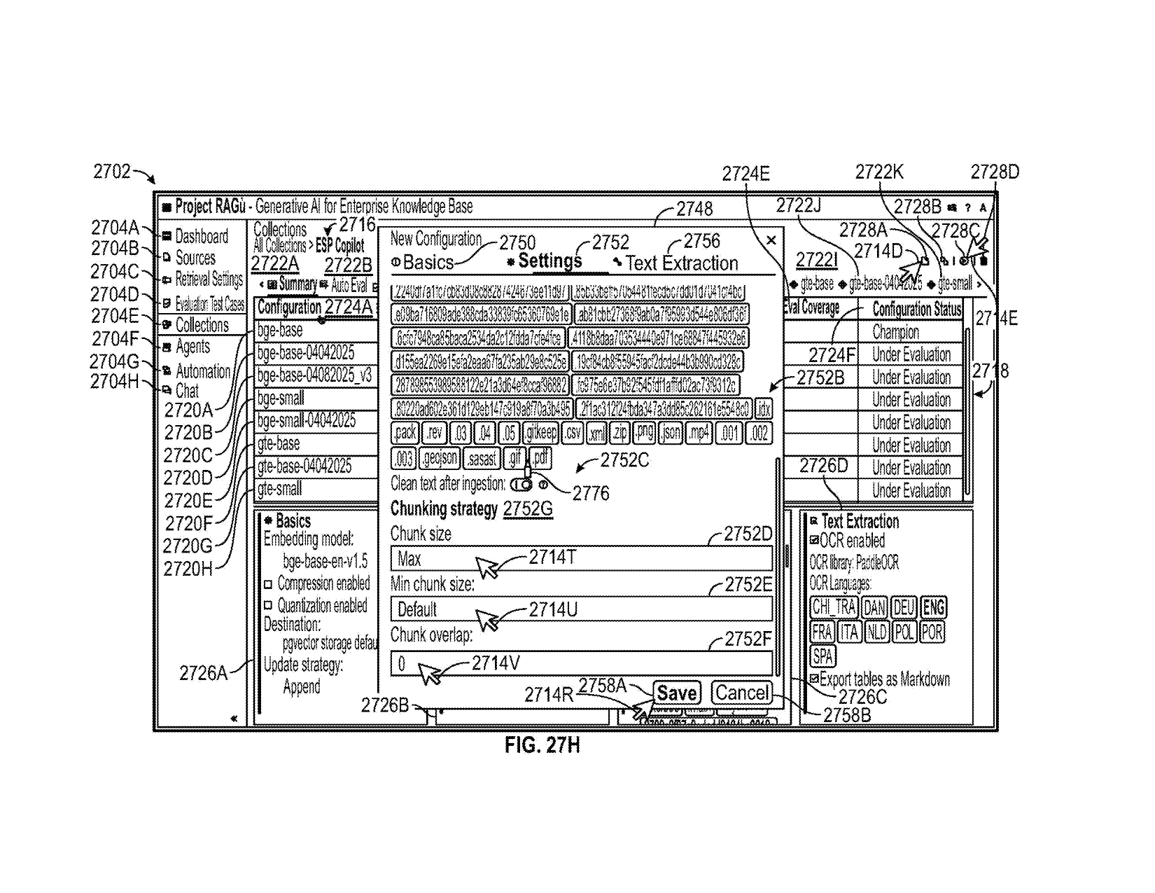

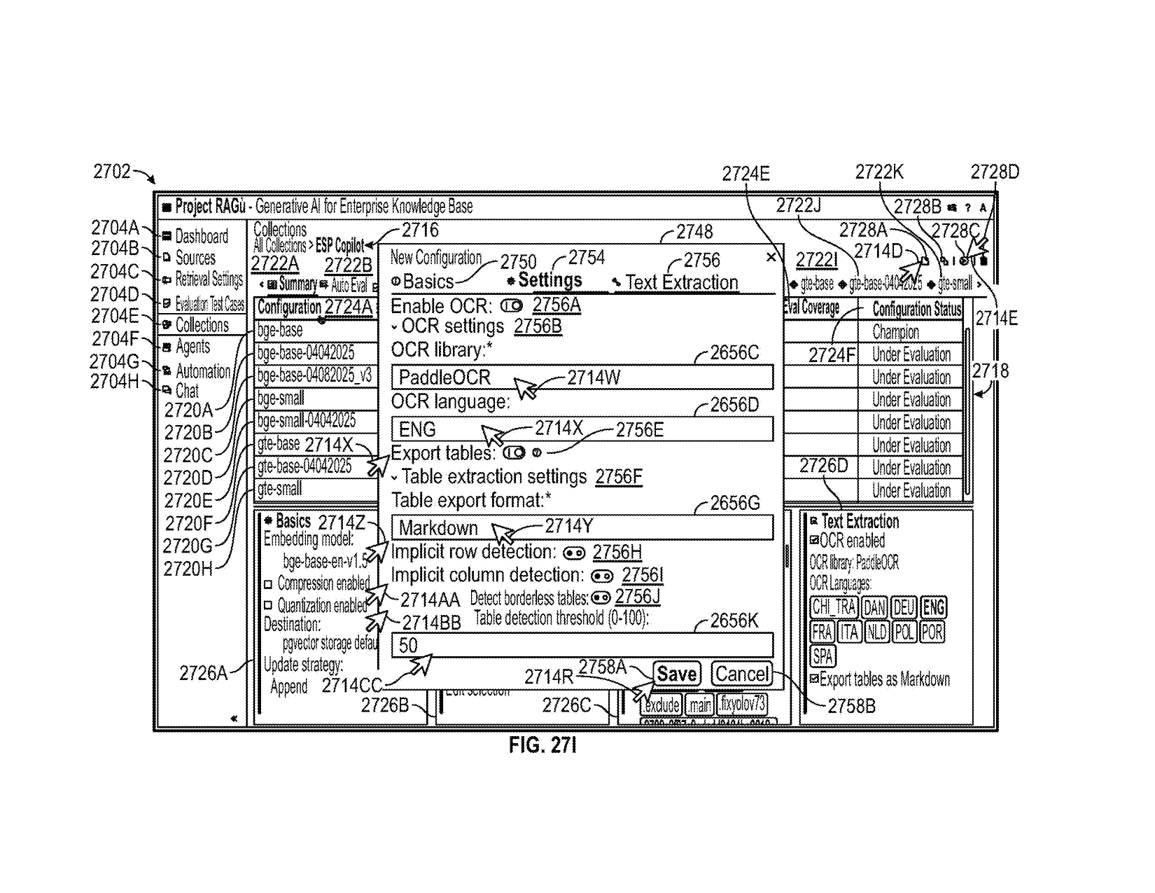

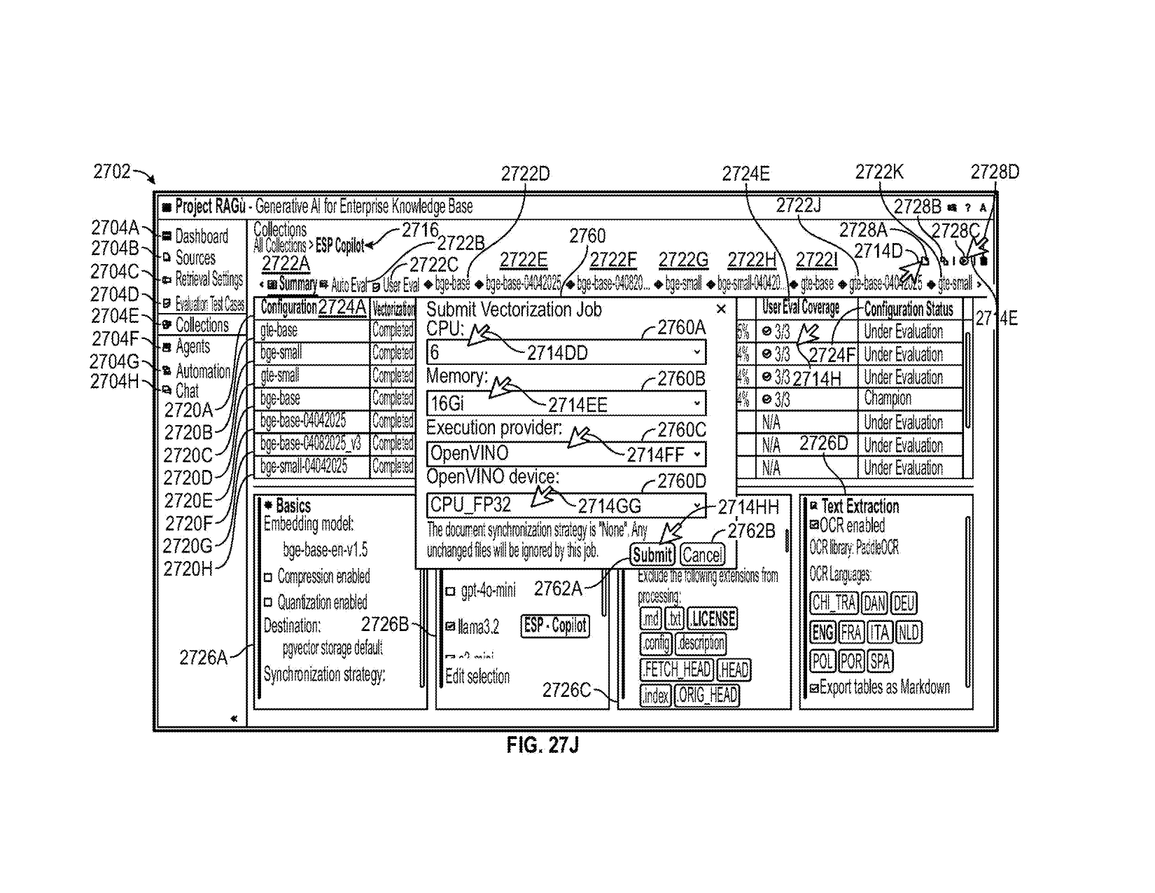

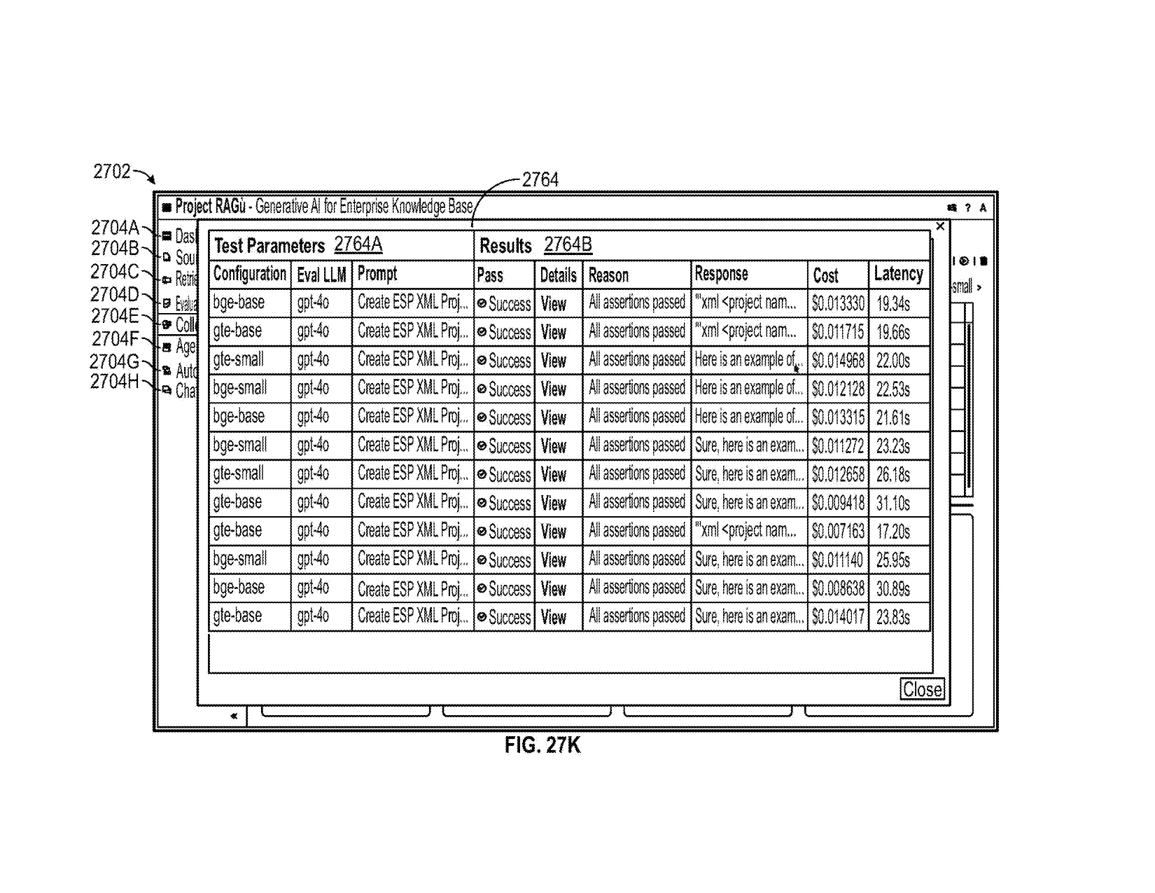

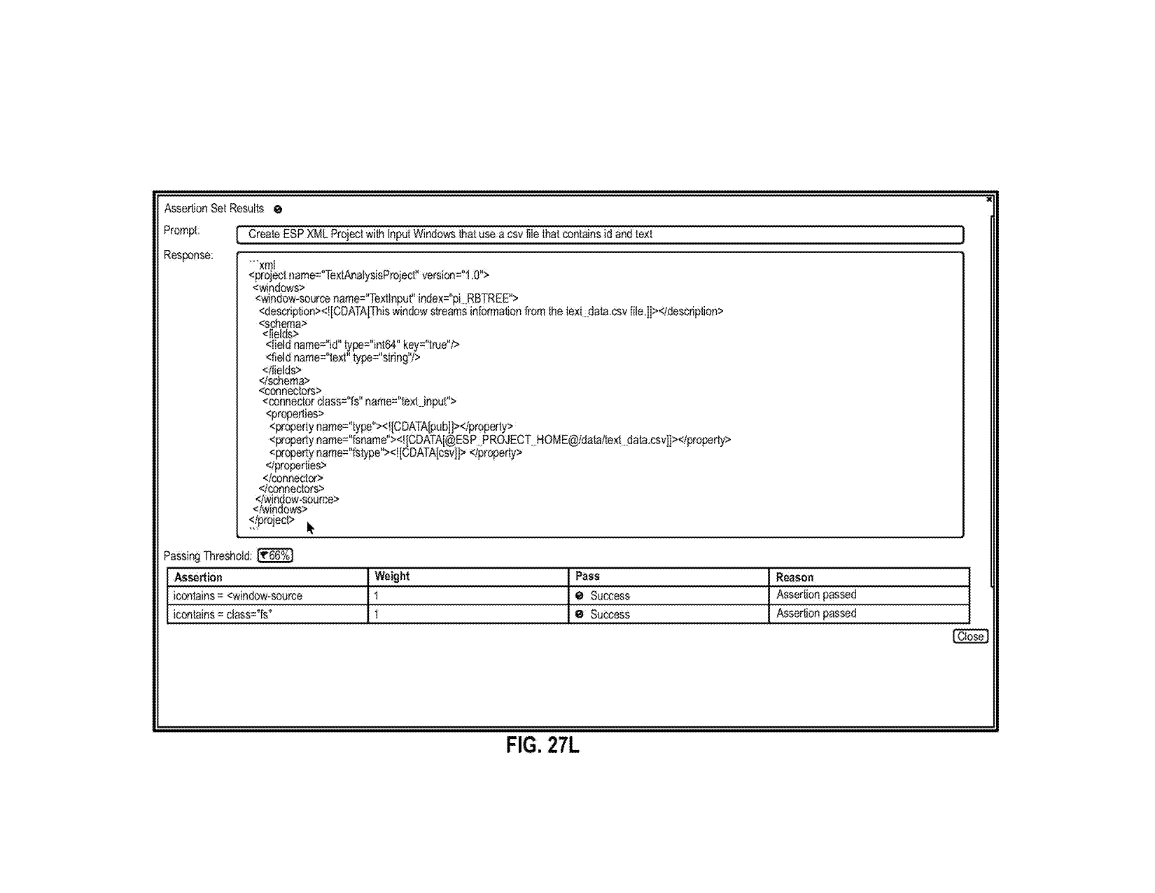

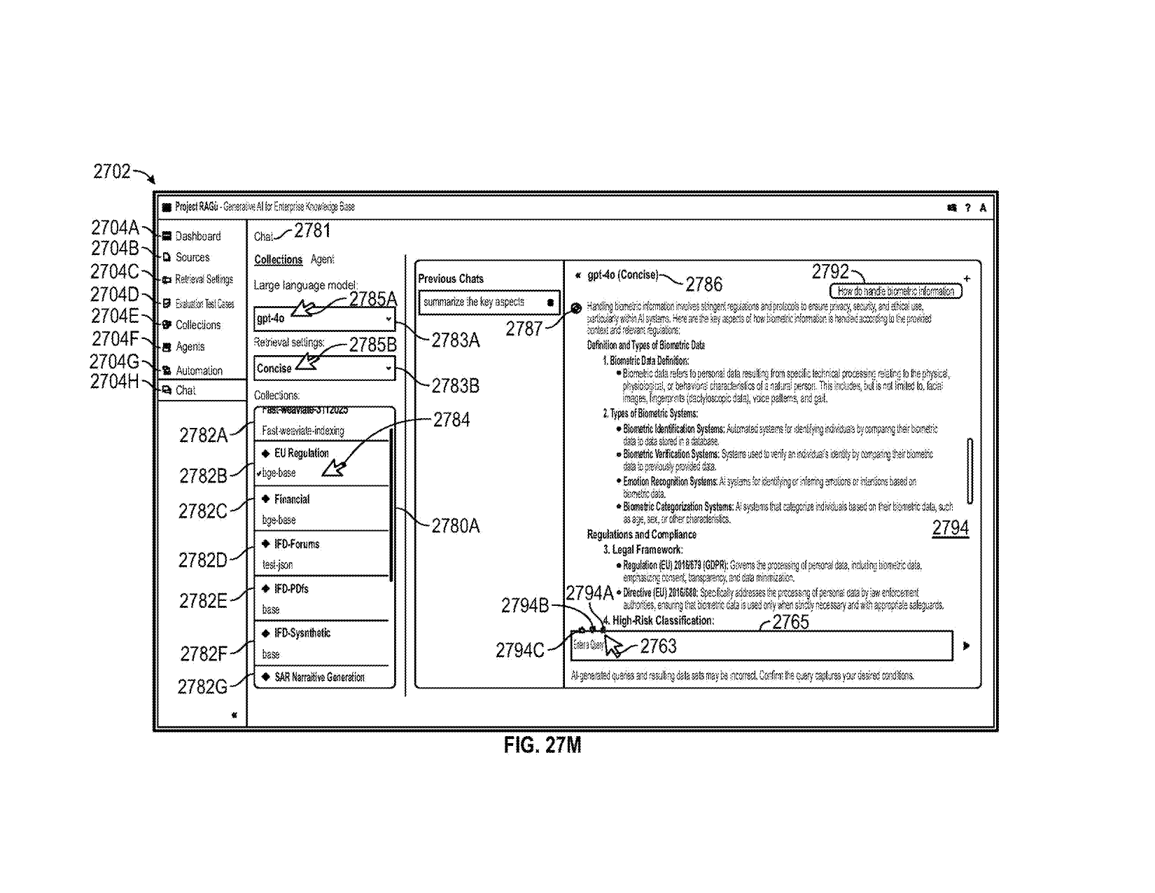

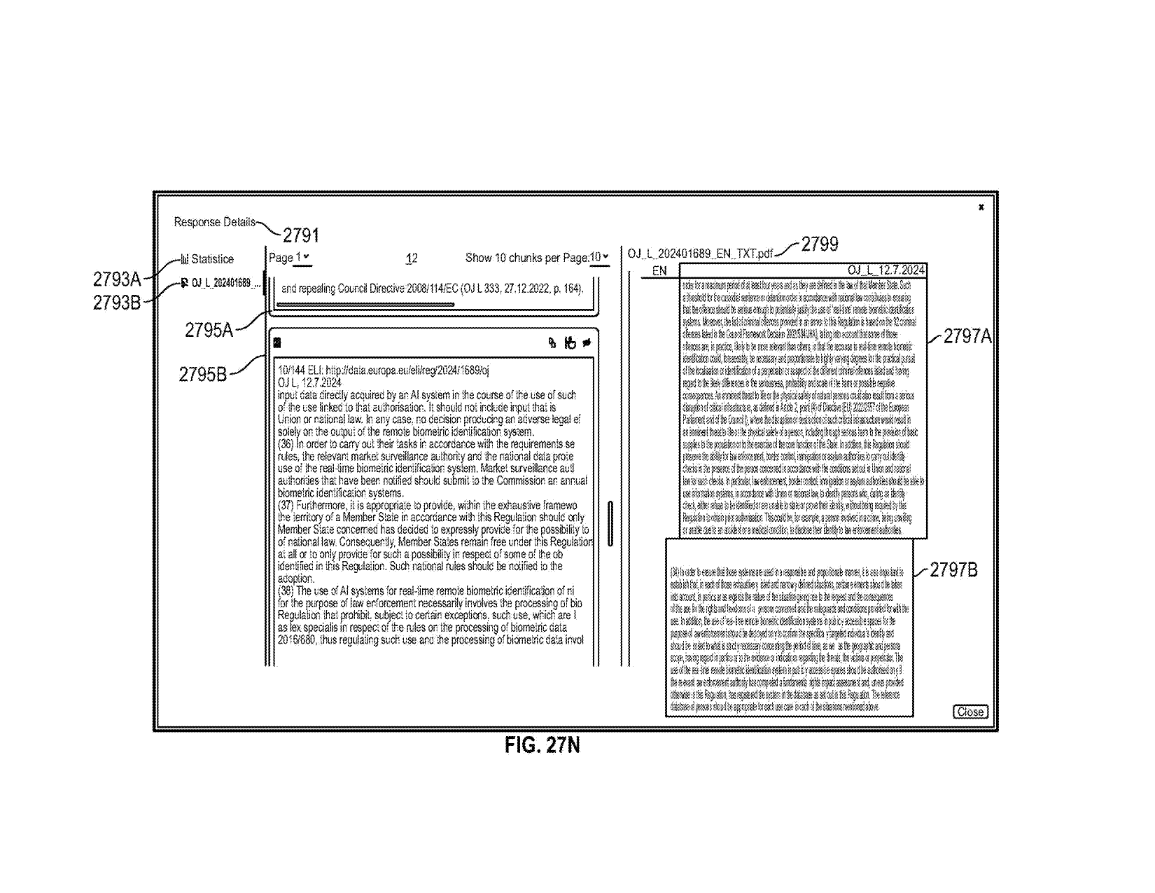

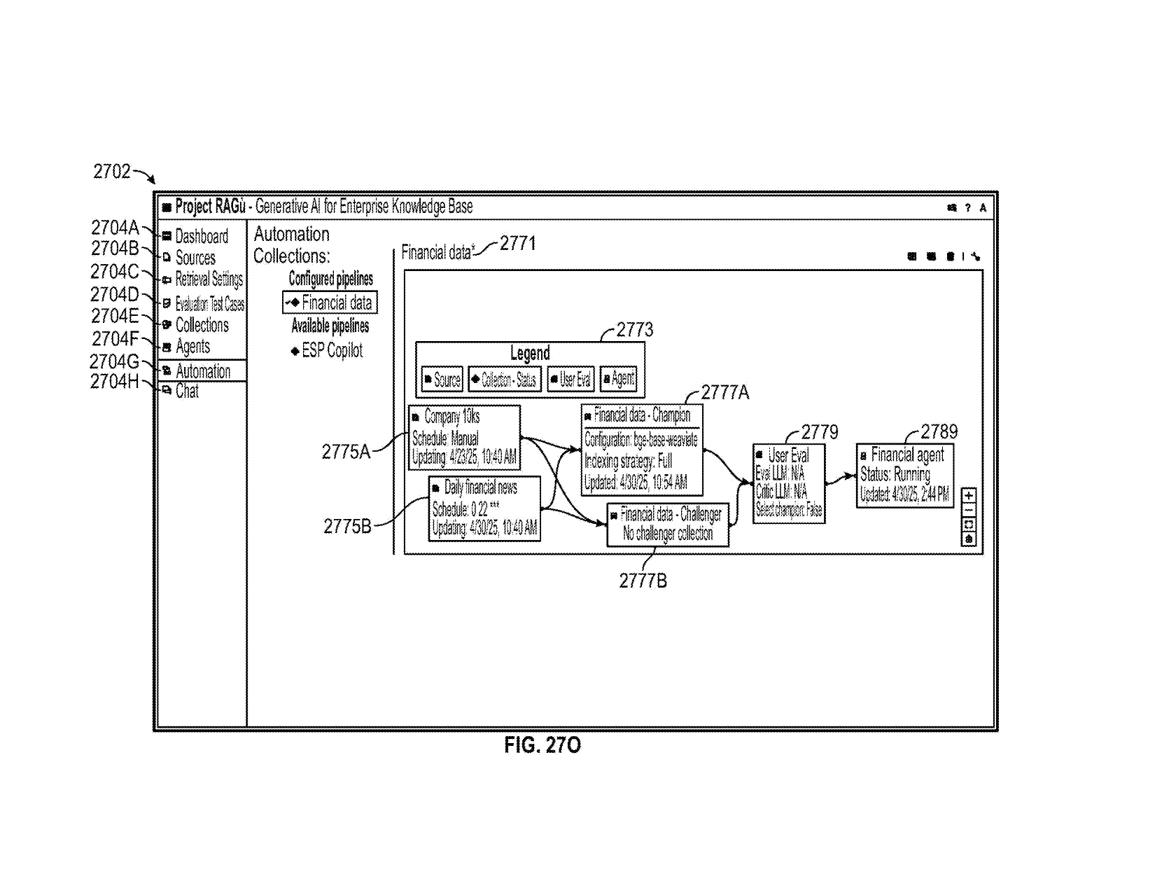

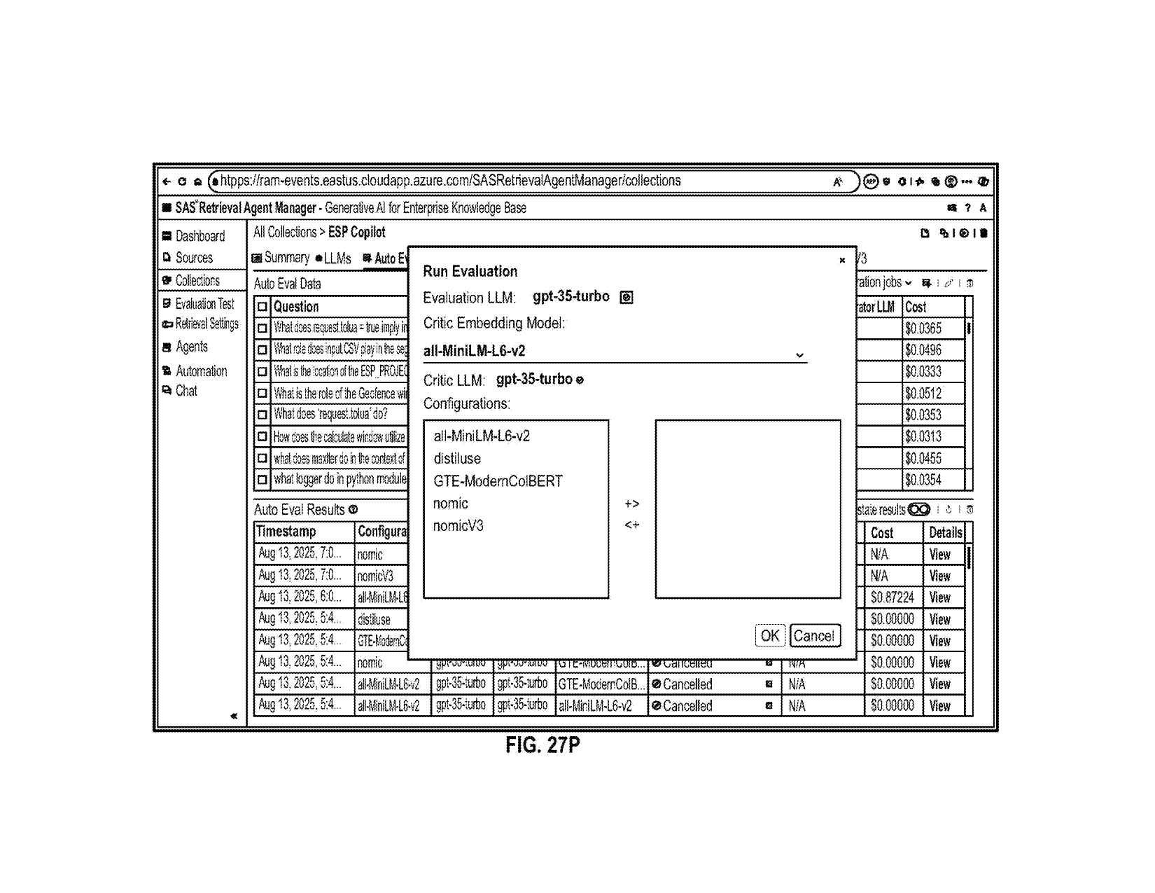

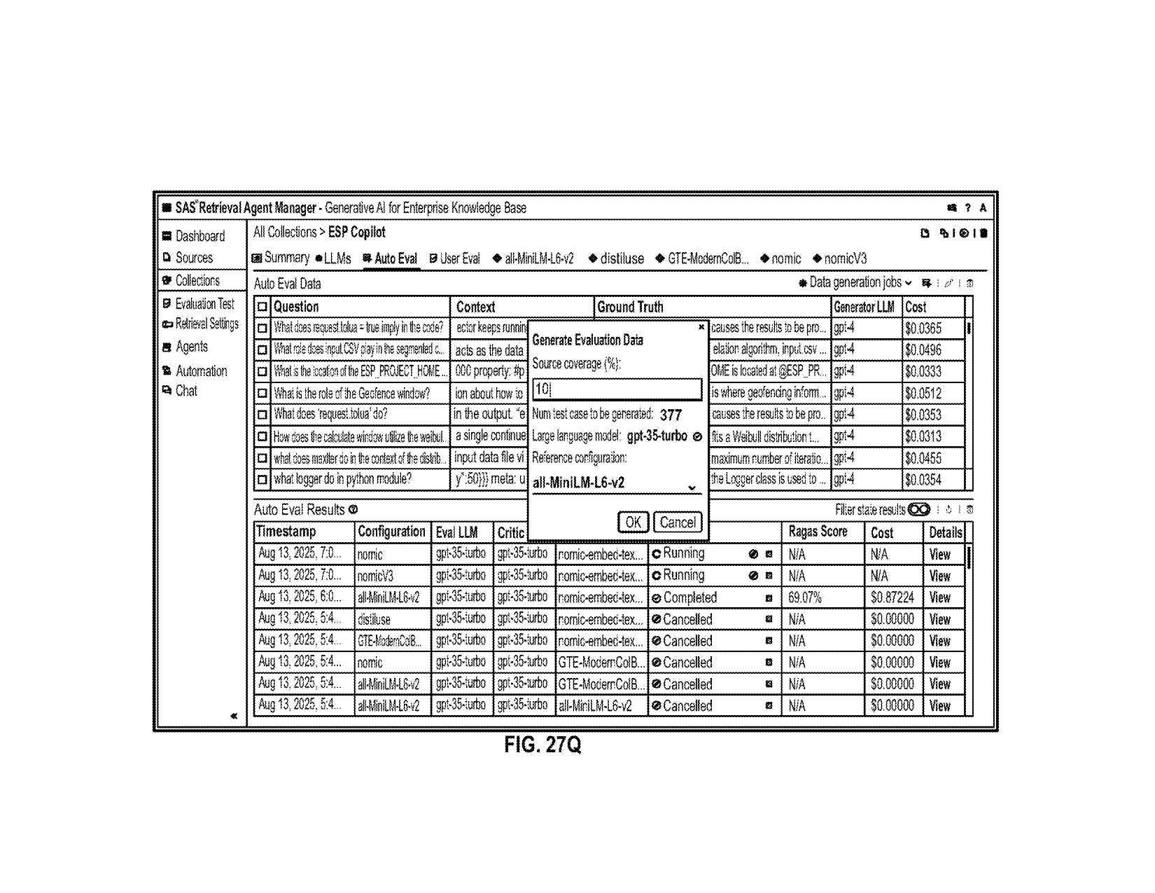

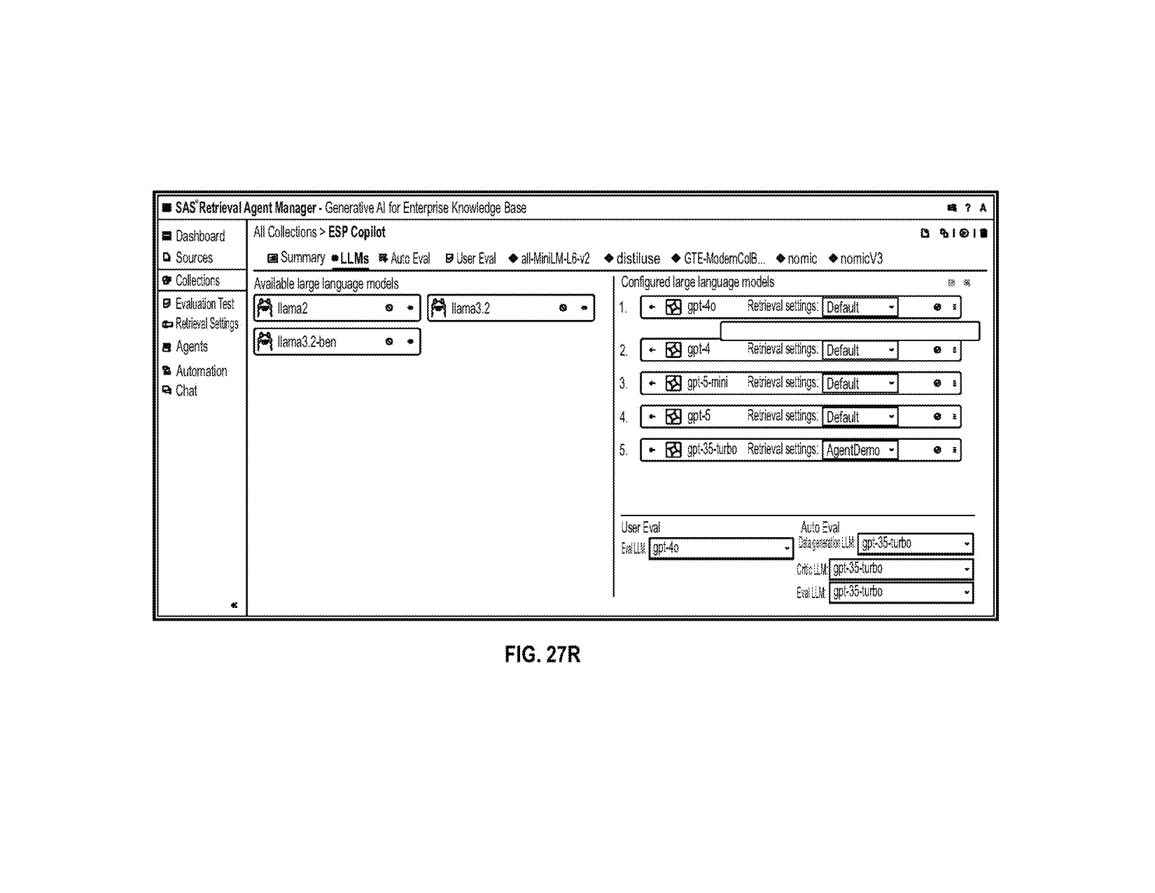

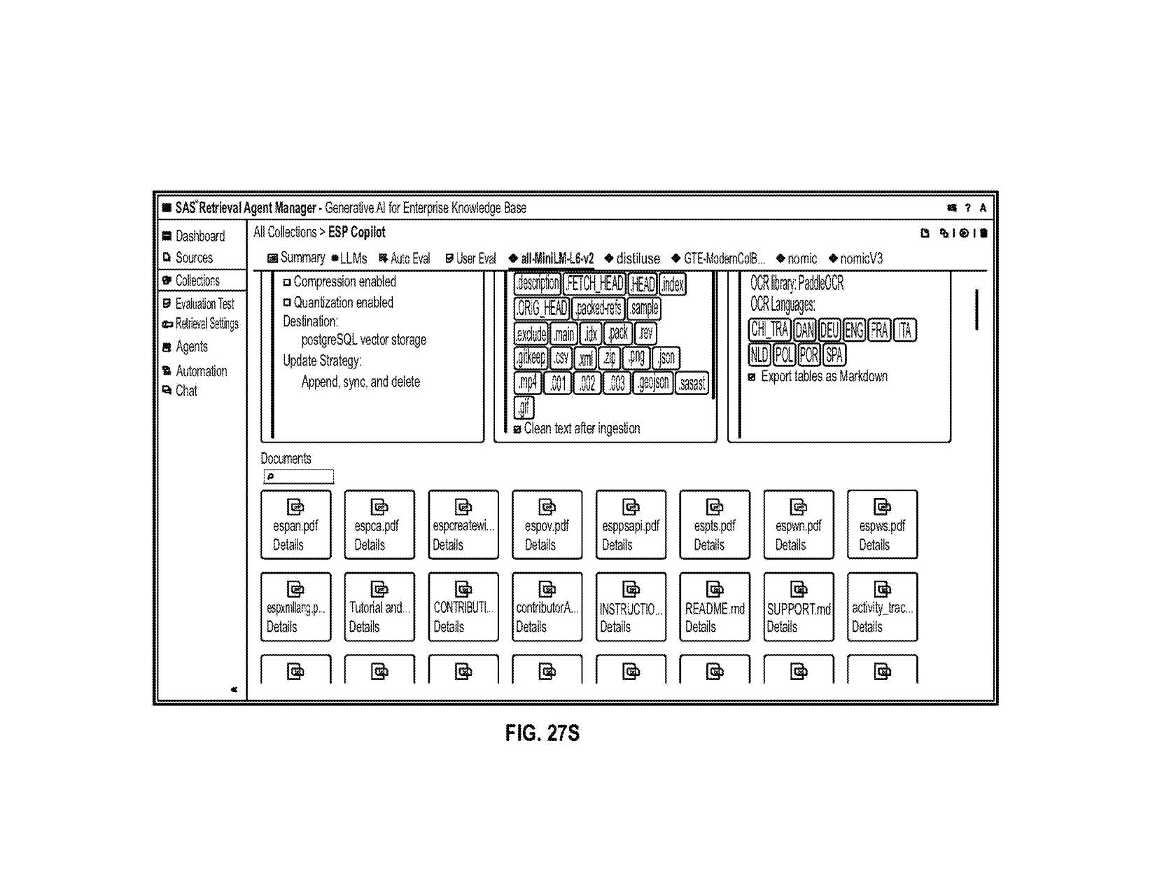

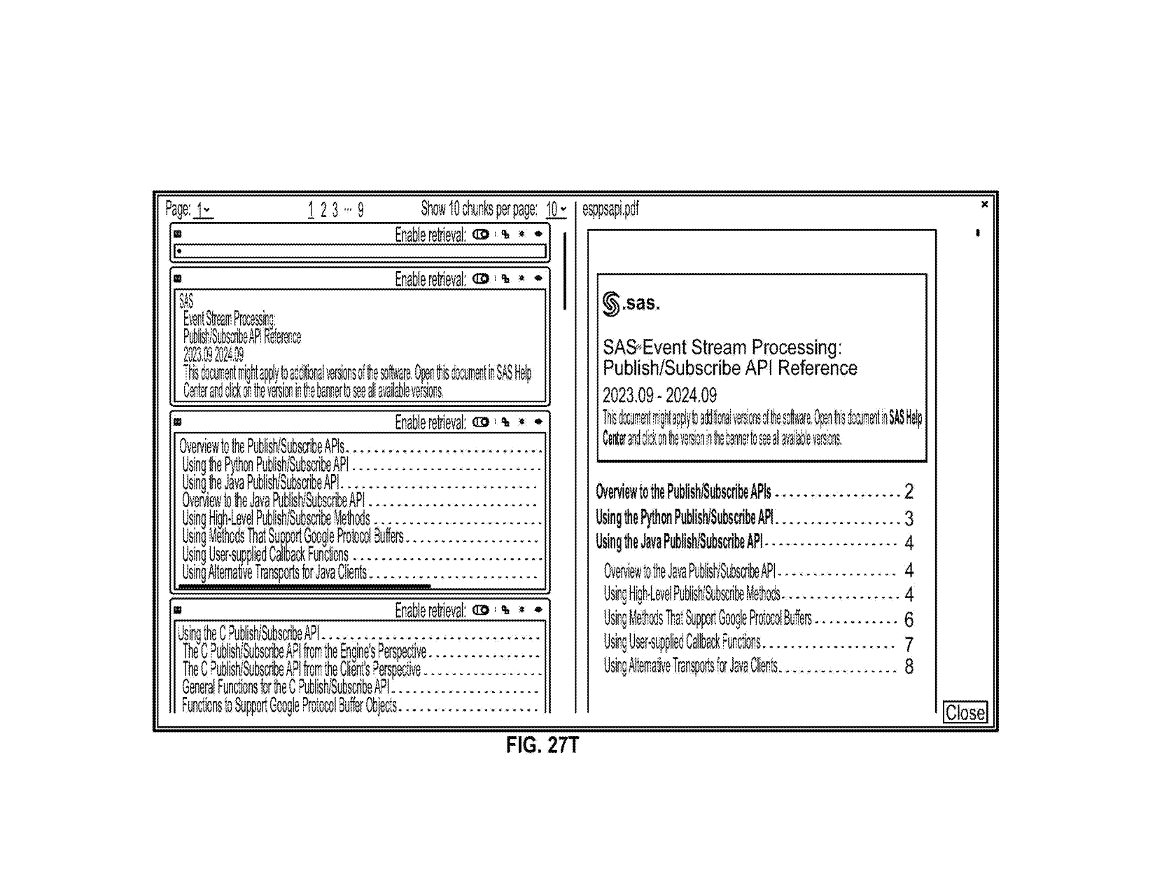

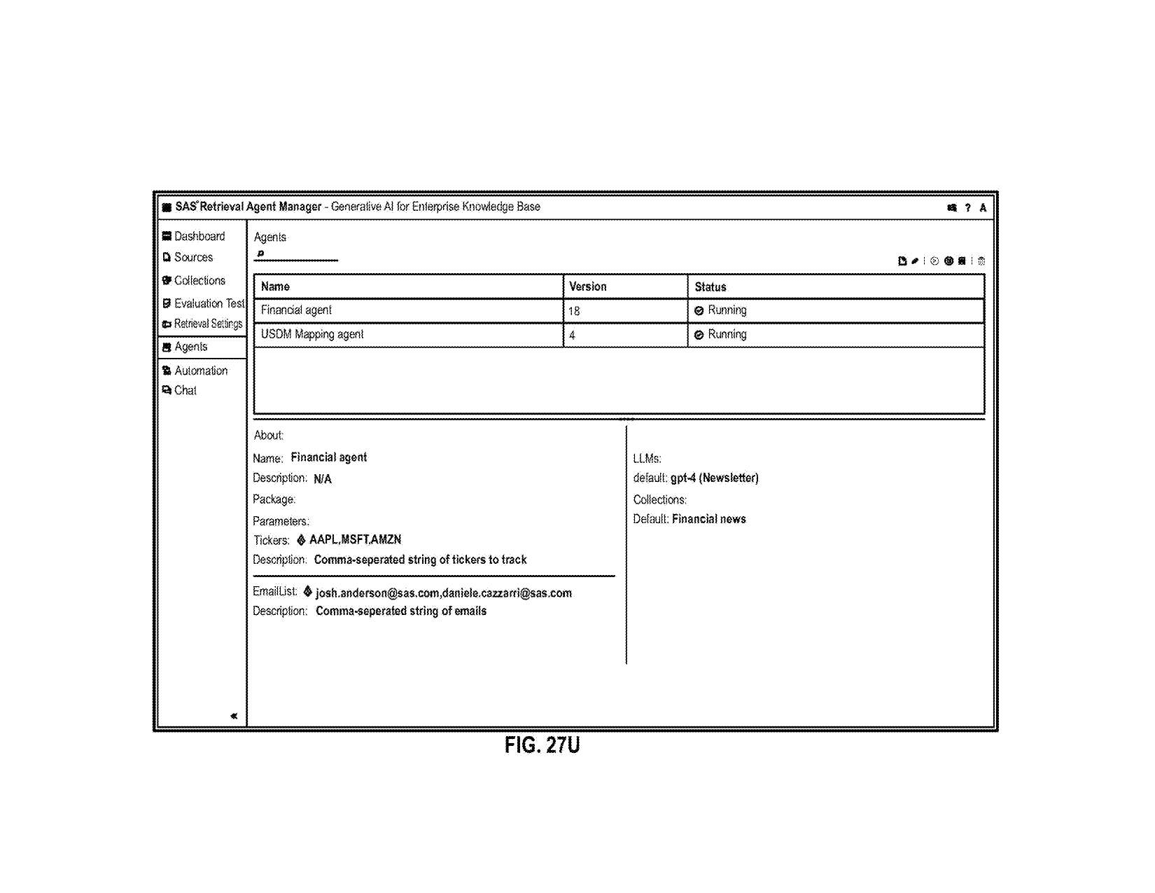

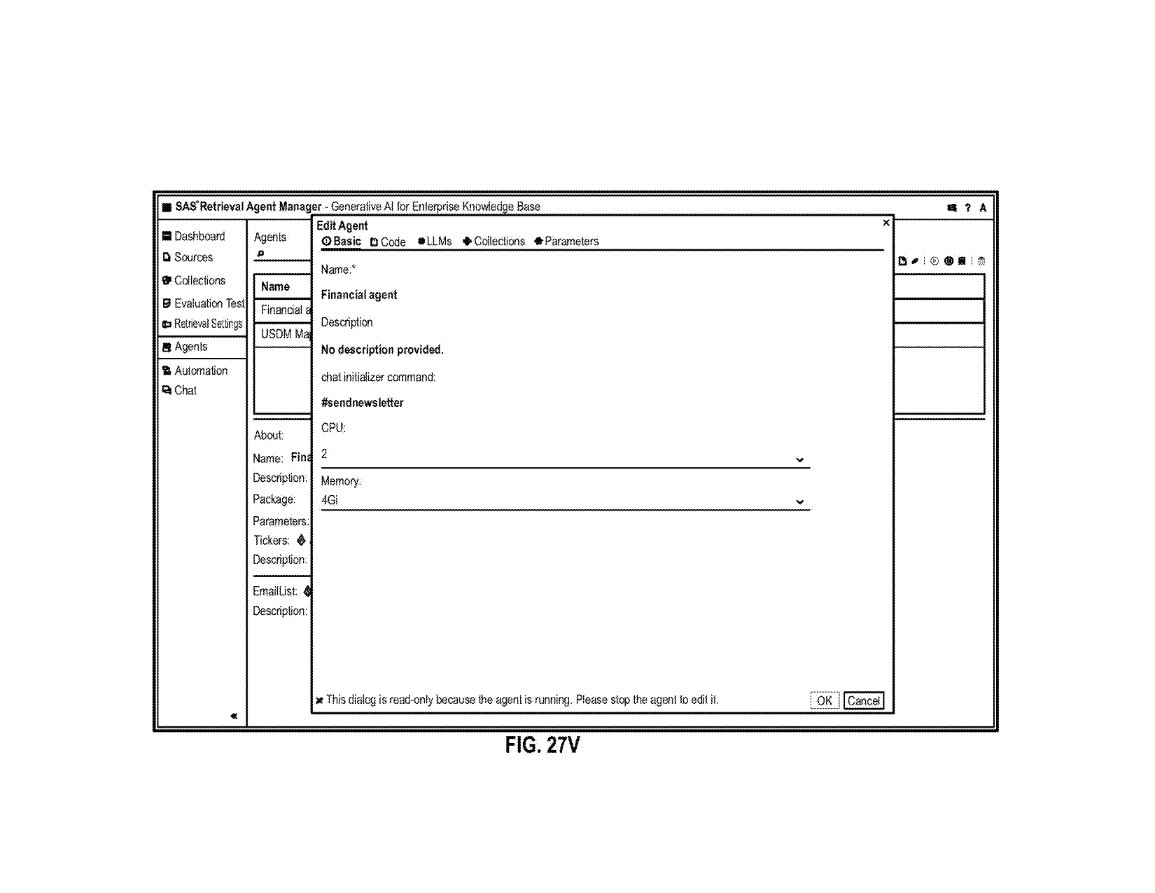

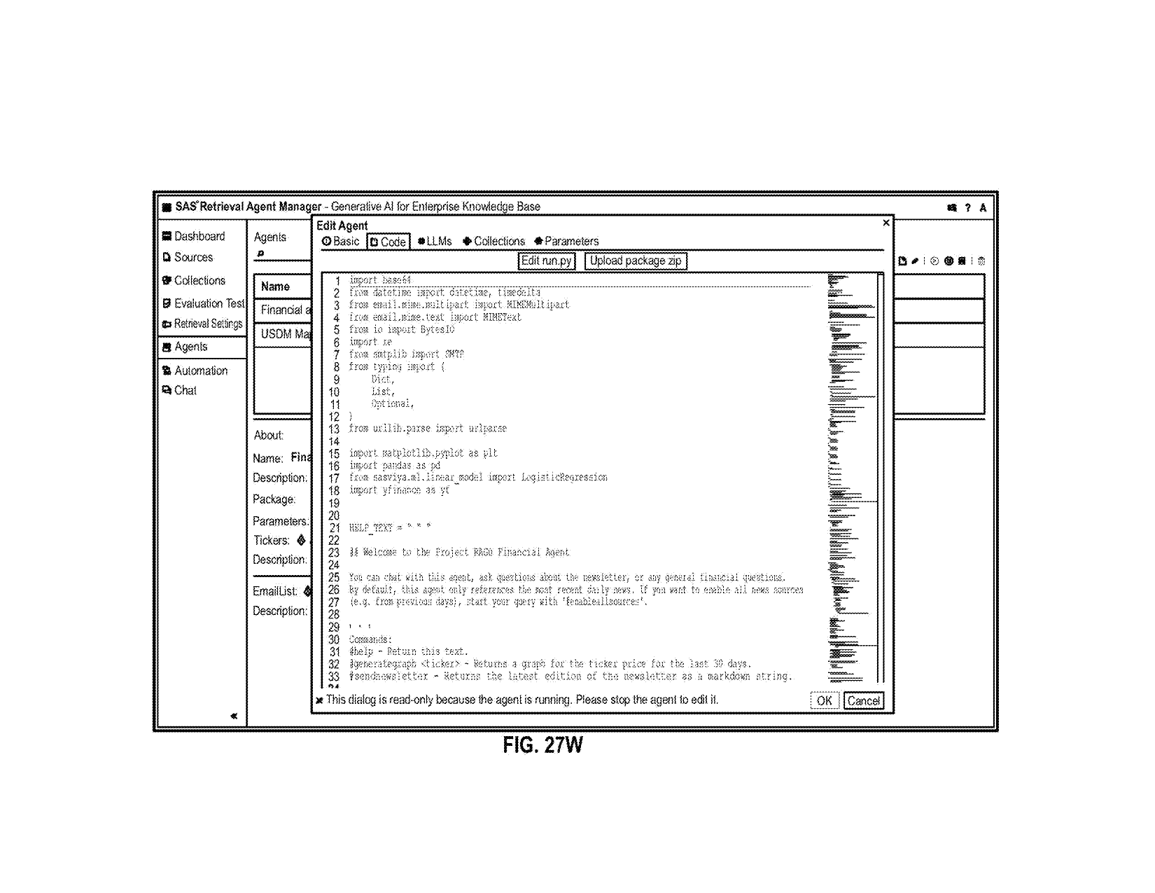

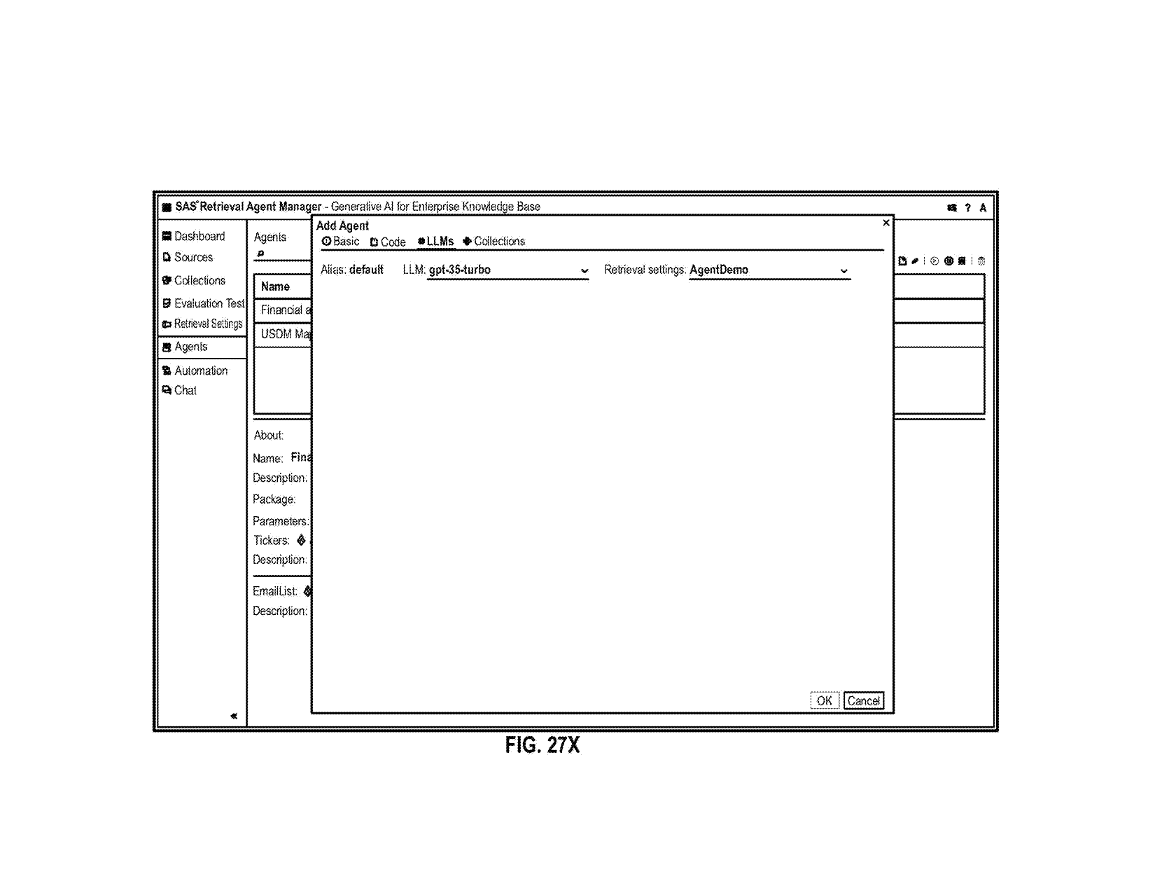

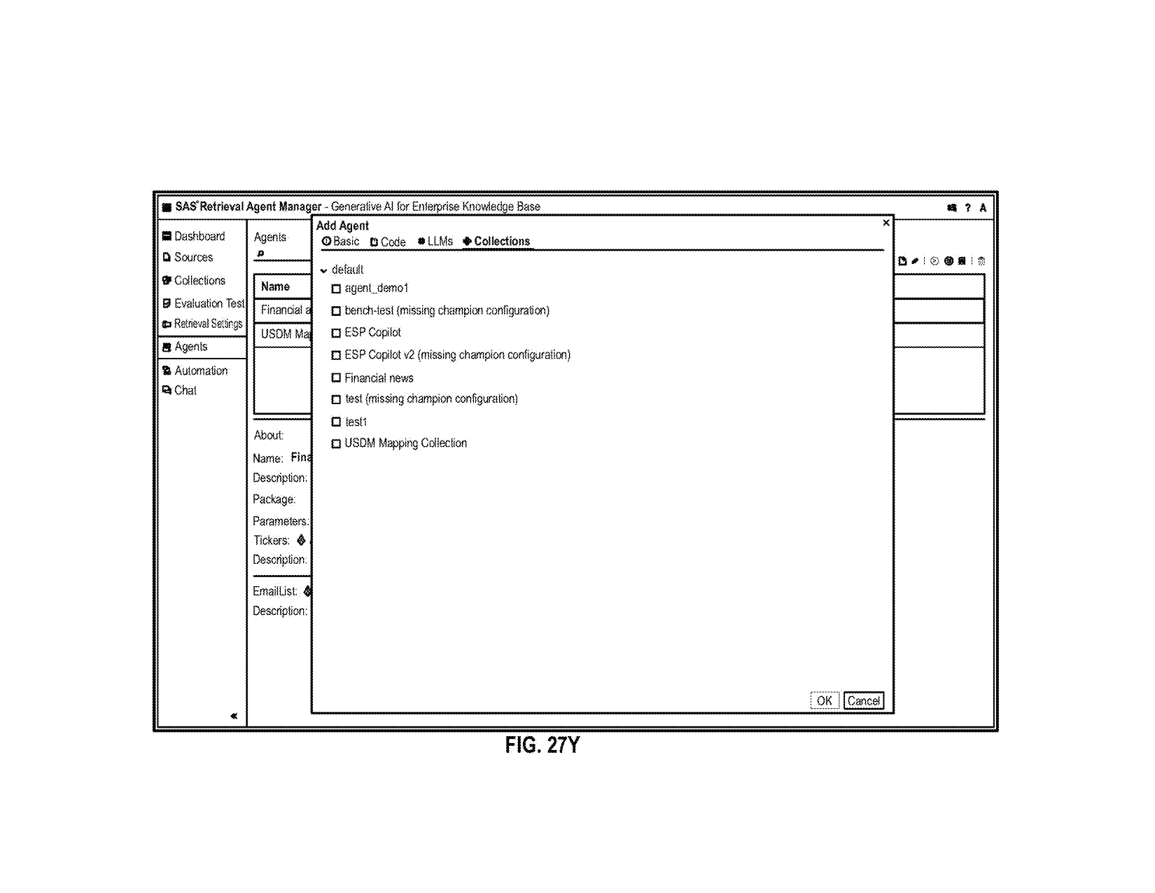

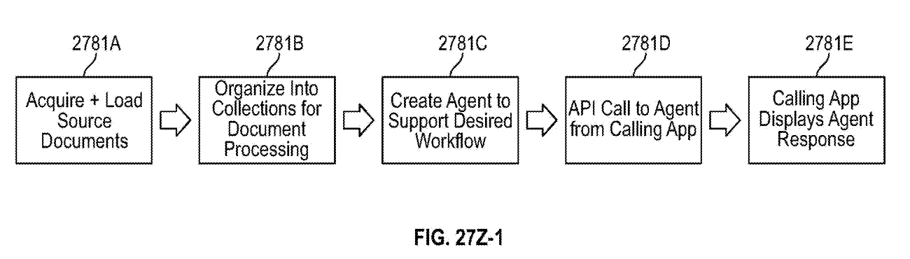

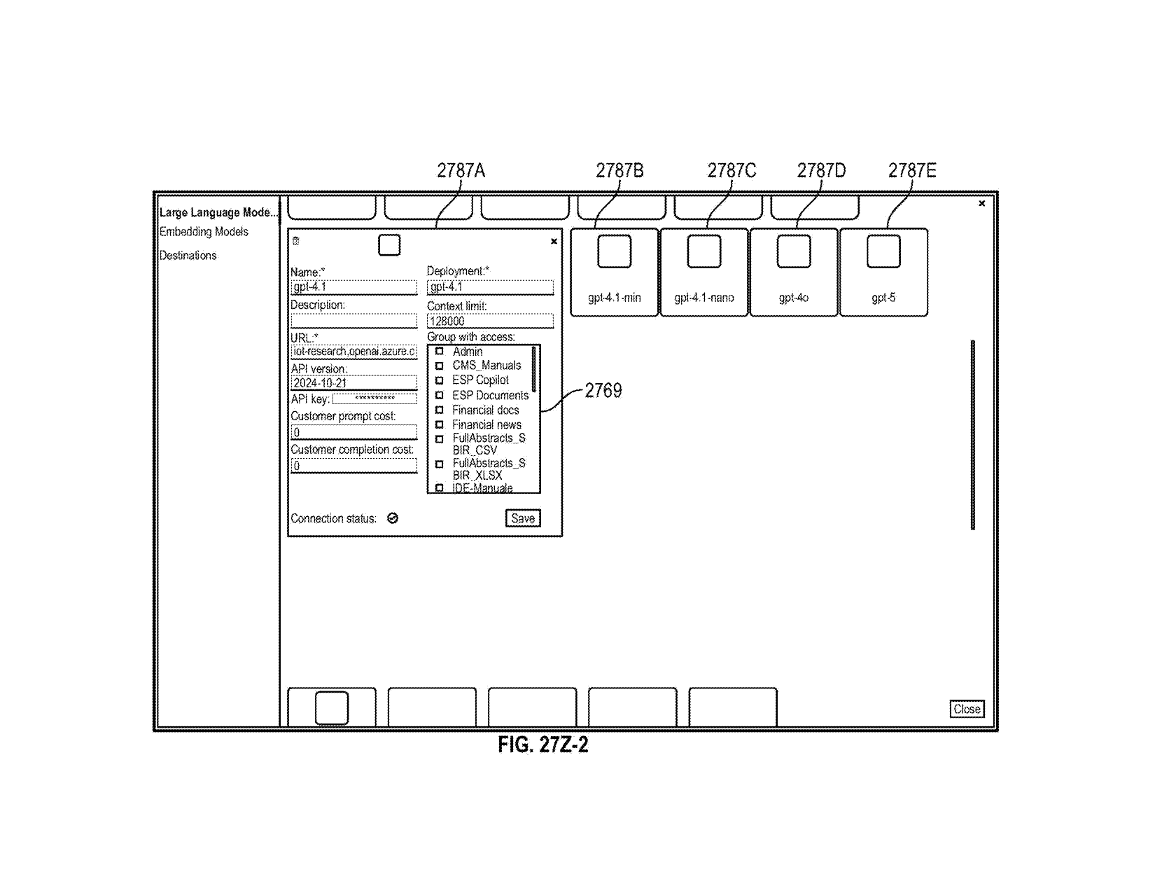

An example of LLM-based access control may be depicted with reference to FIG. 27Z-2. For instance, a user interface as depicted herein may include an LLM configuration page that may include LLM configuration objects 2787A, 2787, 2787C, 2787D, and 2787E, each LLM configuration may correspond to a respective LLM. User input provided to a respective LLM configuration object may cause the respective LLM configuration object to be expanded. The expanded LLM configuration object may include a LLM access control panel 2769 that lists out various user groups. User input provided to corresponding user interface control elements (e.g., one for each user group) may provide a signal to the system described herein indicating which groups should have access to a particular LLM. In this manner, the system described herein may detect which groups have access to a particular LLM and which groups do not have access to that LLM.

A “vector configuration parameter” may refer to a data value or setting that controls one or more operations of a vectorization pipeline. Each vector configuration parameter may define a specific aspect of how data sources are processed, transformed, represented, or stored for use in a RAG application. For instance, a vector configuration parameter may influence how data sources are ingested, how text is extracted from data sources, how text data is pre-processed once extracted, how text data is segmented into chunks, how chunks are converted into vector embeddings, or how vector embeddings are stored.

An “unstructured data source” may refer to a digital information source that contains content whose structure is distinct from any predefined schema, data model, or field structure suitable for direct machine interpretation. Examples may include natural language text documents or images containing text. Vectorization of unstructured data sources may refer to a computational process for converting text data extracted from unstructured data sources into numerical vector representations (e.g., vector embeddings). Controlling the vectorization of one or more unstructured data sources using a set of vector configuration parameters may refer to configuring a vectorization pipeline for converting the one or more unstructured data sources into vector embeddings according to the set of vector configuration parameters.

One example subset of vector configuration parameters may be a set of document ingestion parameters that specify which unstructured documents included in one or more unstructured data sources are to be vectorized by a vectorization service. The document ingestion parameters may function to provide a user with control over which data sources and what information in the data sources are to be converted into embeddings. The set of document ingestion parameters may include a set of prohibited file extensions selected by a user, where each vectorized unstructured document has a file extension that does not correspond to any file extension included in the set of prohibited file extensions. Prohibiting certain file extensions may improve vectorization performance (e.g., shortened processing time, reduced vector database storage size) by reducing a total quantity of documents for which vector embeddings are generated. Additionally, the set of document ingestion parameters may include a text cleaning parameter that instructs the vectorization service to remove characters corresponding to a target character type from the textual content. Cleaning the text of a document to remove text characters irrelevant to a content of the document (e.g., non-printable characters, redundant whitespace) may reduce a total quantity of vector embeddings that are generated for a document (e.g., due to shrinking a total quantity of characters within the text document) while preserving or improving semantic fidelity (e.g., a degree to which a vector embedding accurately captures the semantics of a source document).

Another example subset of vector configuration parameters may include a set of text extraction parameters that controls a text extraction process performed by the vectorization service, where the text extraction process extracts textual content from the unstructured documents. The set of text extraction parameters may function to provide a user with control over how a vectorization pipeline extracts text from unstructured documents that have been ingested according to the set of document ingestion parameters. For instance, the set of text extraction parameters may specify whether the text extraction process should perform additional processing to extract text from data objects which include implicit text references (e.g., image files in which the image includes visual symbols that can be converted into text). Electing to perform such text extraction may ensure that the generated vector embeddings represent a given data source more comprehensively, whereas electing to not perform text extraction may reduce total processing time associated with generating vector embeddings.

In some examples, the set of text extraction parameters may include an optical character recognition (OCR) parameter that instructs the text extraction process to extract textual content from unstructured documents by executing an OCR process, where an “OCR process” may refer to a computational procedure that analyzes images or scanned documents to detect and convert printed or handwritten text characters into machine-readable digital text. The set of text extraction parameters may further include an OCR algorithm parameter that specifies a target OCR algorithm or library of a set of predetermined OCR algorithms or libraries (e.g., PaddleOCR, Tesseract OCR, Efficient and Accurate Scene Text Detector (EAST)) and an OCR language parameter that specifies a human language (e.g., English) associated with the unstructured documents. Specifying the human language may reduce a total processing time associated with extracting text via OCR (e.g., by reducing a number of character symbols to which a particular text character could correspond to a smaller subset associated with the particular language).

The set of text extraction parameters may further include parameters related to extracting text from tables. For instance, the set of text extraction parameters may include a data table parameter that instructs the text extraction process to extract data tables from the unstructured documents by executing a tabular data extraction process, where a “tabular data extraction process” may refer to a computational procedure that detects, interprets, and converts structured table content from documents or images into machine-readable representations that preserve the rows, columns, and relationships of the original data. Merely extracting text from a table without reference to its associated table may result in text that provides insufficient context for the relationship between the table elements. Thus, the tabular data extraction process, which may add contextual information to the extracted text in order to specify the relationship of the text among the elements of the table, may function to produce text that ultimately translates into embeddings that capture these relationships and thus more accurately capture the semantic meaning of the text within the table.

The parameters related to extracting text from tables may include parameters for performing detection of tables. For instance, the parameters may include a borderless data table detection parameter that instructs the tabular data extraction process to detect and extract borderless-type data tables from the unstructured documents, an implicit row detection parameter that instructs the tabular data extraction process to detect and extract tabular rows included in the unstructured documents that are not explicitly separated by row boundaries and an implicit column detection parameter that instructs the tabular data extraction process to detect and extract tabular columns included in the unstructured documents that are not explicitly separated by column boundaries. Including these parameters may enable the detection of tables which may lack certain structural elements (e.g., borders, row boundaries, column boundaries). However, there may be certain advantages associated with disabling these types of detection. For instance, performing implicit row detection or implicit column detection may increase a risk that text that is placed close to each other within an image or document but has no relationship with each other may be misidentified as having a relationship with each other due to their proximity.

Additional parameters related to extracting text from tables may include a data table export parameter that specifies a target format (e.g., JSON, CSV, TSV, XML) for representing the data tables and the borderless-type data tables extracted from unstructured documents and a data table detection sensitivity value, where the tabular data extraction process may use the data table detection sensitivity value to control whether a respective portion of the unstructured documents is detected as a tabular data structure. For instance, the data table sensitivity value may define numeric or probabilistic thresholds within a table detection algorithm (e.g., column alignment, uniform spacing, bounding-box regularity) used to classify text regions as tables. A higher data table detection sensitivity value may result in the tabular data extraction process being more likely to classify regions as tables (e.g., regions with loosely structured text or irregular column alignments). It should be noted that a table being borderless may refer to it not having external borders, not having internal borders, or both.

Another example subset of vector configuration parameters may include a set of text chunking parameters that controls a text chunking process performed by the vectorization service, where the text chunking process segments the textual content into a set of text segments. The set of text chunking parameters may enable a user to control how extracted text output from the text extraction process is split apart into smaller units, where each unit is later converted into a respective vector embedding. Enabling a user to control the text chunking process may result in improved performance depending on how a RAG application is being used. For instance, generating shorter text chunks may improve the performance of RAG applications tasked with granular retrieval tasks (e.g., responding to a user query asking about a specific portion of a document). However, generating longer text chunks may enable fewer total embeddings to be generated and may improve performance of RAG applications tasked with broader retrieval tasks (e.g., responding to a user query related to an entire section of a document). Further, enabling overlap between text chunks may make it more likely that text chunks include sufficient relevant information to produce a meaningful vector embedding, but greater overlap may also result in a greater number of vector embeddings being generated. To support this control, the set of text chunking parameters may include a maximum text chunk size value, a minimum text chunk size value, and a text chunk overlap value. The minimum text chunk size and maximum chunk size value may instruct the text chunking process to generate each text segment between the minimum text chunk size and the maximum text chunk size. The text chunk overlap value may instruct the text chunking process to include one or more text strings of a preceding text segment in a subsequent text segment based on the text chunk overlap value.

Another example subset of vector configuration parameters may include a set of embedding generation parameters that control an embedding generation process performed by a vectorization service, where the embedding generation process generates a plurality of vector embeddings based on a plurality of text segments. The set of embedding generation parameters may function to provide a user with control over how text segments produced by the text chunking process are converted into vector embeddings. For instance, the embedding generation parameters may enable a user to select which embedding model to use to generate vector embeddings, whether vector embeddings should be compressed or quantized, and how vector embeddings should be updated if modification of the unstructured documents occurs after embedding generation.

In some examples, the set of embedding generation parameters may include an embedding model parameter that instructs the embedding generation process to generate the plurality of vector embeddings using a target embedding model. Different embedding models may be trained on distinct datasets (e.g., one on scientific documents and one on legal text), so different embedding models may result in better performance (e.g., increased semantic-similarity search accuracy and/or improved embedding quality) for different types of unstructured documents (e.g., unstructured scientific documents versus unstructured legal documents).

Additionally, the set of embedding generation parameters may include a vector compression parameter that instructs the embedding generation process to execute a vector compression operation on the plurality of vector embeddings and a vector quantization parameter that instructs the embedding generation to execute a vector quantization operation on the plurality of vector embedding. Performing compression may involve reducing a dimensionality or size of a vector embedding and performing quantization may refer to reducing a precision of a vector embedding. Performing compression and quantization may reduce an amount of storage used to store a respective set of vector embeddings but may also reduce an accuracy of semantic similarity based retrieval. Accordingly, the vector compression parameter and vector quantization parameter may enable a user to balance a trade-off between vector database storage and semantic similarity retrieval accuracy.

Additionally, the set of embedding generation parameters may include a vector storage parameter that instructs the embedding generation process to store the plurality of vector embeddings in a target vector database. Different vector databases may use different indexing strategies that may work best for particular applications. For instance, some vector databases may have indexing optimized to support approximate nearest neighbor (ANN) searches, whereas others may have indexing optimized to support exact searches (e.g., for retrieval related to legal or scientific documents). Accordingly, it may be advantageous to enable a user to select a target vector database depending on the type of unstructured documents being used for retrieval in a particular RAG application.

Additionally, the set of embedding generation parameters may include a vector synchronization parameter that instructs the vectorization service to automatically execute a vector update operation of a plurality of predefined vector update operations in response to detecting a modification to the one or more unstructured data sources. The vector synchronization parameter may enable a user to control how vector embeddings generated previously for the unstructured data sources should be updated when a document is added or removed from the unstructured data sources or when a text string within an unstructured document of the unstructured data sources is modified. Generally, the vector synchronization parameter may define whether synchronization should occur upon modification (e.g., if a new vector embedding should be generated), if synchronization should involve updating the vector embeddings for all documents or just the portions of the documents involved in an associated modification (e.g., if a new vector embedding should be appended), and if vector embeddings corresponding to modified text should co-exist with vector embedding corresponding to the original, un-modified text (e.g., if an old vector embedding should be deleted).

A first example of a predefined vector update operation may be one in which synchronization does not occur. In such examples, no new vector embeddings may be generated even if the unstructured data sources are modified. A second example of a predefined vector update operation may be one in which synchronization occurs and should involve all vector embeddings be re-generated for all documents. For instance, the vector synchronization parameter may be specified by the user such that when a new unstructured document is added to the one or more unstructured data sources, the RAG application development service may generate new vector embeddings for all of the one or more unstructured data sources. In such examples, the RAG application development service may automatically remove all of the vector embeddings previously generated for the one or more unstructured data sources from the vector database and may generate, using the target embedding model indicated by the embedding model parameter, the new vector embeddings both for the new unstructured document and the original documents of the one or more unstructured data sources. The RAG application development service may then add these newly generated vector embeddings to the target vector database specified by the vector storage parameter.

A third example of a predefined vector update operation may be one in which synchronization occurs and is only performed for the portions of documents involved in synchronization. For instance, the vector synchronization parameter may be specified by the user such that when a new unstructured document is added to the one or more unstructured data sources, the RAG application development service may generate new vector embeddings just for that unstructured document. In such examples, when a new document is added, the RAG application development service may automatically generate, using the target embedding model indicated by the embedding model parameter, a new set of vector embeddings that numerically represent the new document and may add a new set of vector embeddings for the new document to the target vector database specified by the vector storage parameter.

A fourth example of a predefined vector update operation may be one in which synchronization occurs, is performed only for the portions of documents involved in synchronization, and no deletion of previous vector embeddings occurs. For instance, the vector synchronization parameter may be specified by the user such that when a text string within an unstructured document is modified, the RAG application development service may generate a new vector embedding for the modified text string and may retain a vector embedding previously generated for the original, unmodified text string. In such examples, the RAG application development service may automatically generate, using the target embedding model indicated by the embedding model parameter, an additional vector embedding that corresponds to the modified text string and may add the additional vector embedding that numerically represents the modified text string to the target vector database specified by the vector storage parameter.

A fifth example of a predefined vector update operation may be one in which synchronization occurs, is performed only for the portions of documents involved in synchronization, and deletion of previous vector embeddings occurs. For instance, the vector synchronization parameter may be specified by the user such that when a text string within an unstructured document is modified, the RAG application development service may generate a new vector embedding for the modified text string and remove a vector embedding previously generated for the original, unmodified text string. In such examples, the RAG application development service may automatically remove, from the target vector database specified by the vector storage parameter, a respective vector embedding that corresponds to the text string of a corresponding unstructured document, may automatically generate, using the target embedding model specified by embedding model parameter, an additional vector embedding that corresponds to the modified text string, and may automatically add the additional vector embedding that numerically represents the modified text string to the target vector database.

Performing synchronization automatically to generate vector embeddings when data sources are added and modified may enable a RAG application to provide updated information in real-time, which may enable the RAG application to act as a real-time agent. For instance, it may be beneficial to automatically perform synchronization for RAG applications whose data sources are real-time feeds. However, performing synchronization every time a document is modified may use greater compute resources as compared to requesting synchronization to be performed manually. Accordingly, the capability to adjust a vector synchronization parameter may enable a user to perform a trade-off between giving a RAG application access to up-to-date vector embeddings versus reducing compute resource usage.

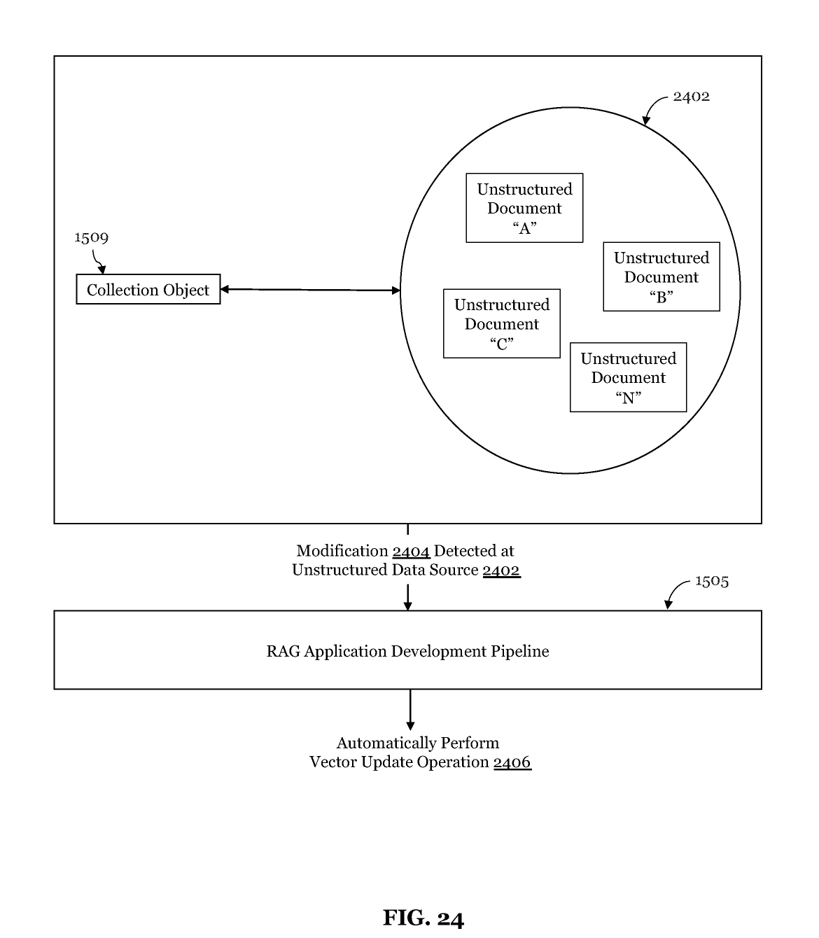

In a non-limiting example, as described with reference to FIG. 24, a collection object 1509 may be linked to one or more data sources 2404. When a modification 2404 is detected at an unstructured data source 2404, the RAG application development service 1505 may automatically perform a vector update operation 2406 as configured according to a vector synchronization parameter.

As shown in FIG. 14, sub-process 1410B of process 1410 may include generating, within the collection object, a vector configuration object that includes the set of vector configuration parameters. Generating the vector configuration object may function to create a persisted data object representing a new vectorization pipeline that may be referenced by a collection object. Creating this persisted data object may enable information about the new vectorization pipeline to be retrieved even in situations in which the graphical user interface is refreshed. In a non-limiting example, as described with reference to FIG. 15, RAG application development service 1505 may include a vector configuration object generator 1514 that may receive a set of vector configuration parameters provided by graphical user interface 1510. The vector configuration object generator 1514 may generate a vector configuration object 1516 that includes the set of vector configuration parameters 1512 and may provide the vector configuration object 1516 to a vectorization service.

A “vector configuration object” may refer to a data construct that represents a particular vectorization pipeline. For instance, the vector configuration object may include values for a respective set of vector configuration parameters as configured via sub-process 1410A. In order to create a vector configuration object, the RAG application deployment system may receive a set of vector configuration parameters from a graphical user interface (e.g., via an application programming interface (API)) and may initialize a new vector configuration object. The RAG application deployment system may populate the new vector configuration object with the received set of vector configuration parameters and may store the vector configuration object within a persistent data store.

As shown in FIG. 14, sub-process 1410C of process 1410 may include generating, using a vectorization service of the RAG application development pipeline, a plurality of vector embeddings that numerically represent the one or more unstructured data sources in response to the vectorization service receiving a request to perform the vectorization of the one or more unstructured data sources. Generating the vector embeddings may enable a performance of the corresponding new vectorization pipeline to be evaluated, as the evaluation of a vectorization pipeline may rely on the retrieval of vector embeddings generated using the vectorization pipeline. In a non-limiting example, as described with reference to FIG. 15, RAG application development service 1505 may include a vectorization service 1518 that may receive a vector configuration object 1516 from vector configuration object generator 1514. The vectorization service 1518 may generate a plurality of vector embeddings 1520 associated with vector configuration object 1516.

The term “vector embedding” may refer to a high-dimensional numerical representation that encodes the semantic meaning of data into a structured mathematical form that can be processed and compared by machine learning systems. Each vector embedding may be a fixed-length vector and may be generated by a target embedding model. Vector embeddings that represent unstructured data sources may be vector embeddings that are derived from unstructured data sources.

A “vectorization service” may refer to a computer-implemented system configured to execute a particular vectorization pipeline in order to convert unstructured data sources into vector embeddings. For instance, the vectorization service may receive a vector configuration object and may configure associated systems within the vectorization pipeline according to the associated vector configuration parameters. Then the vectorization service may execute the vectorization pipeline to generate a set of embeddings from the associated unstructured data sources.

The request to perform vectorization may, in some examples, include a dedicated signal provided from the graphical user interface via user input to a corresponding graphical user interface control element. For instance, the graphical user interface may include a graphical user interface control element that enables a user to submit particular values for a set of vector configuration parameters specified by the user in corresponding user interface input elements. Once the RAG application development service receives the request, the RAG application development service may notify the vectorization service to perform vector embedding generation as described herein.

In a non-limiting example of requesting vectorization to be performed, user input provided to a user interface control element within the graphical user interface may trigger the RAG application development service to instantiate a vectorization job configuration popover that is overlaid on the graphical user interface. A “popover” may refer to a pop-up within a graphical user interface. Within the vectorization job configuration popover may be a set of graphical user interface input elements that a user may configure in order to modify a respective set of job execution parameters. These job execution parameters may specify an execution provider responsible for generating vector embeddings via an embedding model as well as compute resources the execution provider has access to in order to generate the vector embeddings. Being able to specify compute resources may enable a user to balance a trade-off between performance of the embedding generation model (e.g., reduced total processing time) and compute resource usage. Additionally, certain execution providers may have better performance as compared to other execution providers depending on the embedding model they are applied to.

An “execution provider” as described herein may refer to a module that performs low-level computation involved in executing machine learning models, such as an embedding model. The execution provider may improve performance of the embedding model by making use of parallelism between cores and applying low-level optimizations. Additionally, some execution providers (e.g., those configured to interact with GPUs or TPUs) may improve performance by offloading computationally intensive operations from CPUs to specialized hardware-optimized runtimes (e.g., GPUs or TPUs). Non-limiting examples of execution providers may include CUDA and OpenVINO.

In order to support selection of an execution provider, the job execution parameters may include an execution provider parameter that specifies a target execution provider. Additionally, to support selection of compute resources to allocate to the execution provider, the job execution parameters may include a central processing unit parameter that specifies a total number of central processing units to allocate, a memory parameter that specifies a total amount of memory to allocate, and a device parameter that specifies a type of hardware device to use that is compatible with the target execution provider. The vectorization configuration job popover may include respective user interface input elements for each of these job execution parameters as well as user interface control element for submitting user-selected values for the job execution parameters. Upon receiving the job execution parameter values, the RAG application development service may instruct the vectorization service to configure an Open Neural Network Exchange (ONNX) inference session with the target execution provider and the corresponding allocated compute resources as defined in the job execution parameters. Upon receiving the job execution parameters, the RAG application development service may execute the associated vectorization pipeline, which may include executing the target embedding model using the ONNX inference session in order to generate vector embeddings.

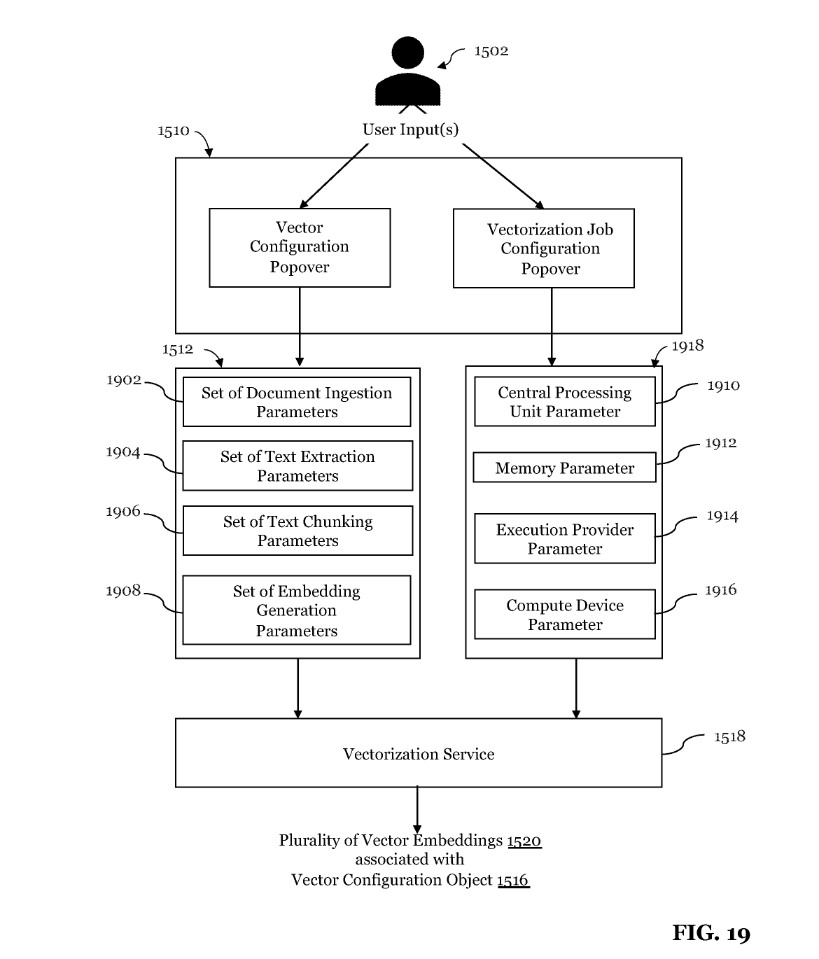

In a non-limiting example, as described with reference to FIG. 19, a user 1502 may provide user input to a vector configuration popover of graphical user interface 1510 in order to set values for one or more vector configuration parameters 1512, which may include a set of document ingestion parameters 1902, a set of text extraction parameters 1904, a set of text chunking parameters 1906, and a set of embedding generation parameters 1908. Once these values are set, the graphical user interface 1510 may provide the values for the one or more vector configuration parameters 1512 to a vectorization service 1518. Additionally, a user 1502 may provide user input to a vectorization job configuration popover in order to set values for one or more vectorization job parameters 1918. The one or more vectorization job parameters 1918 may include a central processing unit parameter 1910, a memory parameter 1912, an execution provider parameter 1914, and a compute device parameter 1916. Once these values are set, the graphical user interface 1510 may provide the values for the one or more vectorization job parameters to vectorization service 1518. Vectorization service 1518 may use the one or more vector configuration parameters 1512 and the one or more vectorization job parameters 1918 to generate a plurality of vector embeddings 1520 associated with a vector configuration object 1516.

As shown in FIG. 14, sub-process 1410D of process 1410 may include associating the plurality of vector embeddings generated for the one or more unstructured data sources with the vector configuration object. Associating a plurality of vector embeddings with a vector configuration object may refer to a process in which the plurality of vector embeddings are persistently linked to the vector configuration object. Performing this association may enable the RAG application development service to locate which vector embeddings to retrieve when performing an evaluation on a vectorization pipeline during the second stage.

In order to associate vector embeddings with a vector configuration object, the RAG application development service may tag each generated vector embedding with a unique identifier of the vector configuration object. The RAG application development service may then store these tags in one or more metadata records that the RAG application development service may later retrieve. Additionally, or alternatively, the RAG application development service may add, to the vector configuration object, a reference to a location of the vector embeddings within the vector database. When subsequent evaluation is performed, the RAG application development service may identify the location of the vector embeddings by locating the associated metadata record or looking up the location within the associated vector configuration object.

As shown in FIG. 14A, process 1420 may represent operations that occur at a second stage of a RAG application development pipeline. The second stage of the RAG application development pipeline may involve evaluating, for each vectorization pipeline created in the first stage, a performance of a RAG application using vector embeddings generated via the respective vectorization pipeline. Additionally, the second stage may involve comparing the performance of the RAG application for each of the vectorization pipelines and selecting one of them for use in deployment (e.g., the one associated with the highest performance).

As shown in FIG. 14A, sub-process 1420A of process 1410 may include executing an application performance assessment that assesses a behavior of a RAG application in generating responses based on the plurality of vector embeddings associated with the vector configuration object. Performing the application performance assessment may function to provide a metric enabling subsequent comparison between vector configuration objects for selection of a vectorization pipeline to use in a deployed RAG application.

An “application performance assessment” as described herein may refer to a computer-implemented process that evaluates how a RAG application performs when generating responses based on a set of vector embeddings associated with a given vector configuration object. Executing an application performance assessment may involve the RAG application development service retrieving a vector configuration object and the associated embeddings to be evaluated and loading in a set of application assessment tests to use to test a RAG application. The RAG application development service may then retrieve, from an application assessment test, a user query defined within the application assessment test and may convert, using an embedding model of the RAG application, the respective query to a vector embedding. The RAG application may then detect a subset of the vector embeddings associated with the given vector configuration object that are semantically similar to the vector embedding of the user query (e.g., that have a vector distance within a predefined distance threshold of the embedding value associated with the respective query) and may retrieve textual content that corresponds to the subset of vector embeddings. The RAG application may then provide the respective query of the respective application assessment test and the textual content that corresponds to the subset of vector embeddings to a large language model and may generate, using the large language model, a corresponding response to the respective query based on the large language model receiving the respective query of the respective application assessment test and the textual content that corresponds to the subset of vector embeddings. The RAG application may then output a test assessment finding indicating whether the corresponding response satisfies one or more test passage criteria. It should be noted that the large language model used to generate the response may be referred to as an “evaluation LLM.”

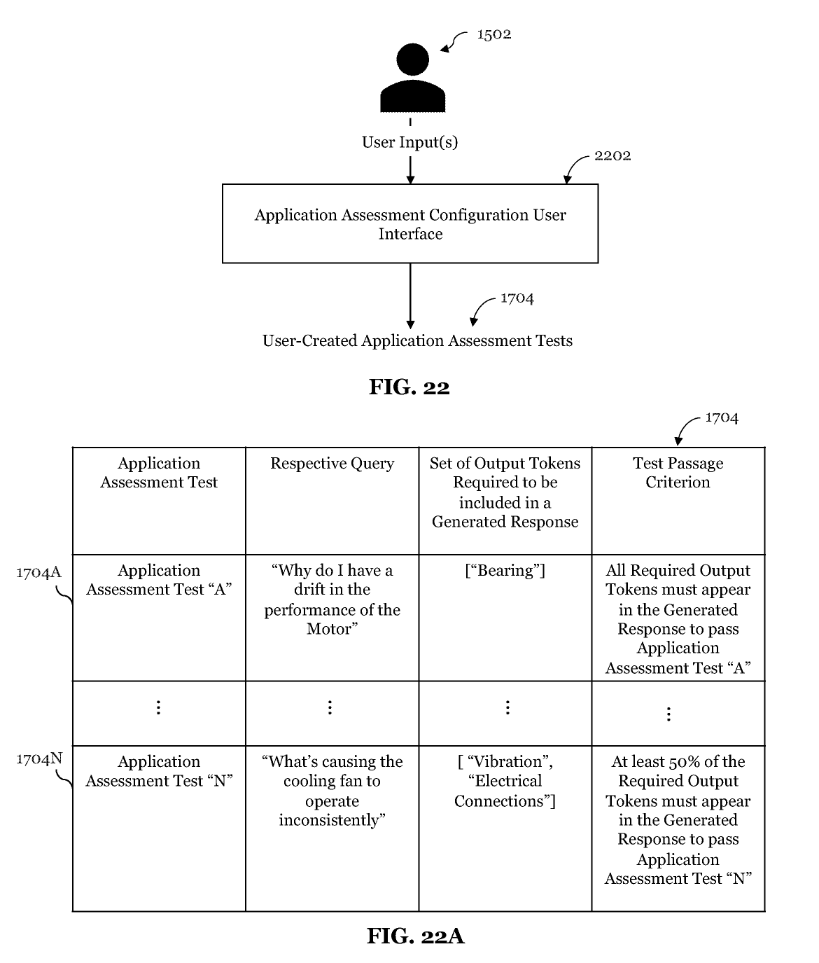

Non-limiting examples of assessment tests may be depicted with reference to FIG. 22A. For instance, FIG. 22A may depict a set of user-created application assessment tests 1704A through 1704N, where each user-created application assessment test 1704 includes a unique identifier, a respective query, one or more output tokens to be located within the response, and one or more test passage criteria.

Each of the one or more test passage criteria may specify a minimum allocation of output tokens that should be present in the response. The RAG application development service may detect whether the minimum allocation of output tokens specified by a given test passage criterion is present within the response. If the RAG application development service locates the minimum allocation of output tokens, the response may successfully satisfy the test criterion. If the RAG application development service fails to locate the minimum allocation of output tokens, the response may fail the test criterion. If a test criterion is successfully satisfied, the RAG application development service may multiply a weight assigned to that test criterion by 1. If the test criterion is not successfully satisfied, the RAG application may multiply a weight assigned to that test criterion by 0. The RAG application development service may then aggregate each of the weights and may normalize them (e.g., relative to a total number of weights). If the aggregated weights satisfy a weight threshold assigned to the associated test case, the response may successfully pass the test case. Otherwise, the response may fail the test case.

In a first non-limiting example, as depicted with reference to FIG. 22A, a user query for user-created application assessment test case 1704A may recite “Why do I have a drift in the performance of the motor?” and a set of output tokens for user-created application assessment test case 1704A may include the output token “bearing.” Additionally, the test passage criterion for user-created application assessment test case 1704A may specify that 50% output tokens should appear in the response, which may correspond to a predefined weight threshold of 1, and may assign a weight of 1 to the output token “bearing.” If the token “bearing” is present in the response to the user query, the RAG application development service may multiply the weight threshold of 1 by 1 and may determine that the total weight associated with the response satisfies the predefined weight threshold (e.g., the total weight of 1 is greater than or equal to the weight threshold of 1). In such examples, the response may pass the test passage criterion. Otherwise, the RAG application development service may multiply the weight threshold of 1 by 0 and may determine that the total weight associated with the response fails to satisfy the predefined weight threshold (e.g., the total weight of 0 is less than the weight threshold of 1). In such examples, the response may not pass the test passage criterion.

In a second non-limiting example, as depicted with reference to FIG. 22A, a user query for user-created application assessment test case 1704N may recite “What’s causing the cooling fan to operate inconsistently?” and a set of output tokens for user-created application assessment test case 1704N may include the output tokens “vibration” and “electrical connections.” Additionally, the test passage criterion for user-created application assessment test case 1704A may specify that 50% output tokens should appear in the response, which may correspond to a predefined weight threshold of .5. The test passage criterion may additionally assign a weight of 1 to the output token “vibration” and a weight of 1 to the output token “electrical connections”. If both of “vibration” and “electrical connections” are present in the response to the user query, the RAG application development service may multiply both weights by 1, may aggregate the weights (e.g., 1+1=2), and may divide the aggregated weight number by a total possible weight number (e.g., 2/2=1) in order to get a normalized weight number (e.g., 1). The RAG application development service may then determine that the normalized weight satisfies the predefined weight threshold (e.g., the normalized weight of 1 is greater than or equal to the predefined weight threshold of .5). In such examples, the test passage criterion may be passed.

Similarly, if only one of “vibration” and “electrical connections” is present in the response to the user query, the RAG application development service may multiply the weight corresponding to the located token by 1 and the weight corresponding to the unlocated token by 0, may aggregate the weights (e.g., 1+0=1), and may divide the aggregated weight number by a total possible weight number (e.g., 1/2=.5) in order to get a normalized weight number (e.g., .5). The RAG application development service may then determine that the normalized weight satisfies the predefined weight threshold (e.g., the normalized weight of .5 is greater than or equal to the predefined weight threshold of .5). In such examples, the test passage criterion may be passed.

Additionally, or alternatively, if neither of “vibration” and “electrical connections” is present in the response to the user query, the RAG application development service may multiply both weights by 0, may aggregate the weights (e.g., 0+0=0), and may divide the aggregated weight number by a total possible weight number (e.g., 0/2=0) in order to get a normalized weight number (e.g., 0). The RAG application development service may then determine that the normalized weight fails to satisfy the predefined weight threshold (e.g., the normalized weight of 0 is less than the predefined weight threshold of .5). In such examples, the test passage criterion may not be passed.

Once each test case is assessed for success or failure, the RAG application development service may generate an aggregated assessment finding that indicates a total number of application assessment tests of the set of application assessment tests passed by the RAG application relative to a total number of tests in the set of application assessment tests and may display, on the graphical user interface, a representation of the vector configuration object in association with the aggregated test assessment finding. For instance, in a non-limiting example as described with reference to FIG. 22A, if user-created application assessment tests 1704A and 1704N are the only user-created application assessment tests and both pass, then the graphical user interface may display that 2 tests out of a total number of 2 tests were passed. However, if only user-created application assessment test 1704A passed, then the graphical user interface may display that 1 test out of a total number of 2 tests were passed. If neither of user-created application assessments tests 1704A and 1704N were passed, the graphical user interface may display that 0 out of a total number of 2 tests were passed.

In some examples, the application assessment tests may be user-defined. For instance, a user may specify, for each user-defined application assessment test, a user query, one or more output tokens, and predefined test passage criterion defining whether a response to the user query passes the test. In order to facilitate user-defined application assessment tests, the RAG application development service described herein may provide an application assessment configuration user interface that a user may utilize to create a set of application assessment tests. Each of these application assessment tests may include a query to provide to the RAG application when executing an application performance assessment, a set of output tokens to be included in a target response by the RAG application when the RAG application processes the respective query, and a test passage criterion specifying a minimum percentage of output tokens that should appear in the target response to pass the respective application assessment test. In a non-limiting example as described with reference to FIG. 22, a user 1502 may provide user input to application assessment configuration user interface 2202 in order to define one or more user-created application assessment tests 1704. Once a user creates the set of application assessment tests, the user may request, via the application assessment configuration user interface, a request to execute the application assessment tests.

In some examples, application assessment tests may be defined in an automated fashion. In order to facilitate automated application assessment generation and evaluation, the RAG application development service described herein may provide an automated test generation popover that a user may utilize to select an automated test generation button which triggers the RAG application development service described herein to generate application assessment tests. Automatically generated application assessment tests may have a similar or identical format to user-defined application assessment tests (e.g., a user query, a set of output tokens, one or more test passage criteria).

Within the automated test generation popover, the user may specify a data source coverage parameter specifying a maximum percentage of content from the one or more unstructured data sources to be tested by the set of application assessment tests, a large language model parameter that specifies a target large language model for generating the set of application assessment tests, and a reference configuration parameter that specifies the vector configuration object to be used by the RAG application during execution of the set of application assessment tests. In response to receiving the one or more test generation parameters, the RAG application development service described herein may automatically generate, using the target large language model, the set of application assessment tests. The RAG application development service may then execute the application performance assessment (e.g., in a same or similar manner as for user-defined test cases described herein). Once the application performance assessment is complete, the RAG application development service may compute a RAG application performance efficacy value for the RAG application in response to executing the set of application assessment tests and may display, on the graphical user interface, a representation of the vector configuration object in association with the RAG application performance efficacy value.

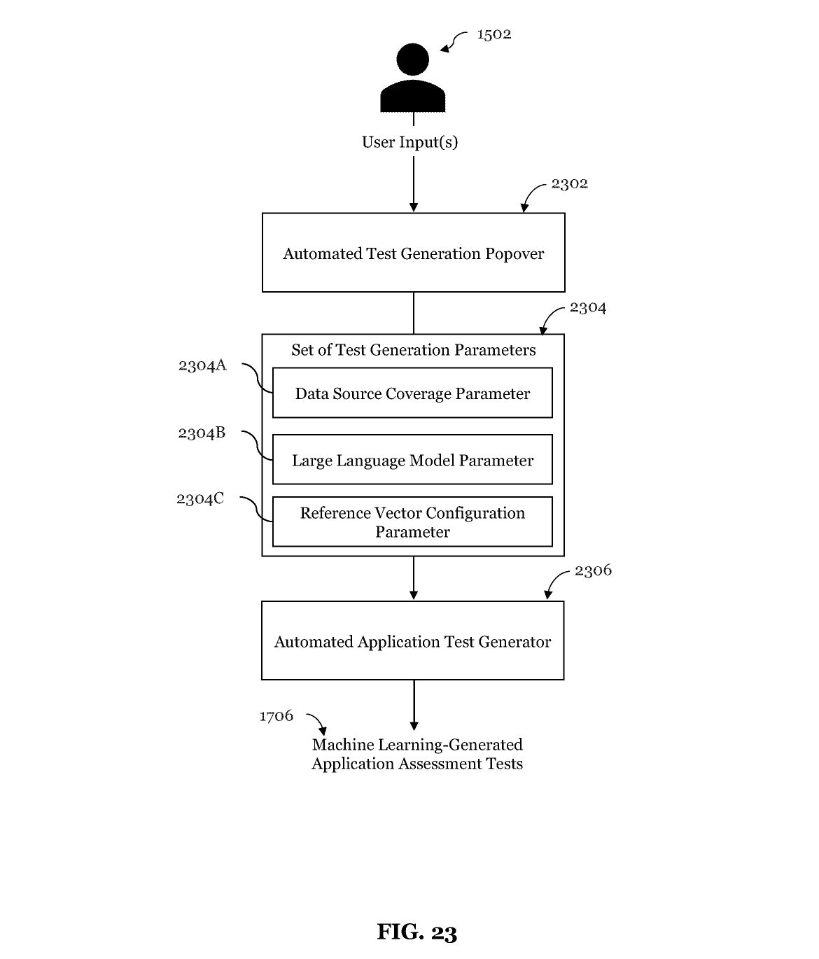

In a non-limiting example, as described with reference to FIG. 23, a user 1502 may provide user input to an automated test generation popover 2302 in order to set values for a set of test generation parameters 2304, where the set of test generation parameters 2304 may include a data source coverage parameter 2304A, a large language model parameter 2304B, and a reference vector configuration parameter 2304C. Upon setting the values for the set of test generation parameters 2304, the user may request for the automated test generation popover 2302 to provide them to automate application test generator 2306, which may create the associated machine learning-generated application assessment tests. In some examples, these may have a same or similar form as application assessment tests 1704A through 1704N (e.g., a respective query, set of output tokens, and test passage criterion) and may thus be evaluated in a similar fashion.

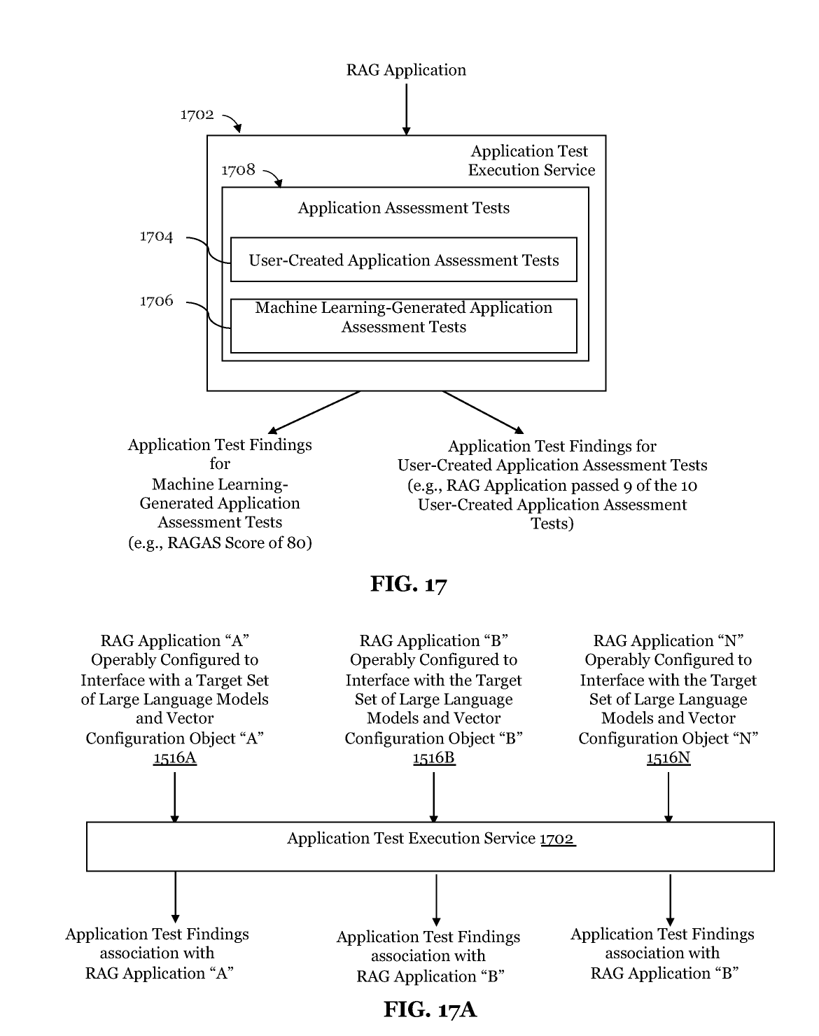

It should be noted that there may be cases where both user-defined test cases and automatically created test cases may be executed in an application performance assessment. For instance, in a non-limiting example as described with reference to FIG. 17, an application test execution service 1702 may execute application assessment tests 1708 for a RAG application, where the application assessment tests 1708 include user-created application assessment tests 1704 and machine learning-generated application assessment tests 1706. The application test execution service 1702 may output, for the user-created application assessment tests 1704, application test findings indicating how many user-created application assessment tests 1704 the RAG application passed (e.g., 9 out of 10). Additionally, the application test execution service 1702 may output, for the machine-learning-generated application assessment tests 1706, application test findings indicating a corresponding score (a RAGAS score of 80).

In some examples, application assessment tests may be performed for multiple applications. In a non-limiting example, as described with reference to FIG. 17A, a first RAG application may be configured to interface with a target set of LLMs and a first vector configuration object 1516A; a second RAG Application may be configured to interface with the target set of LLMs and a second vector configuration object 1516B; and a third RAG application may be configured to interface with the target set of LLMs and a third vector configuration object 1516N. Each of these RAG applications may be evaluated via application test execution service 1702 and respective application test findings may be output for each.

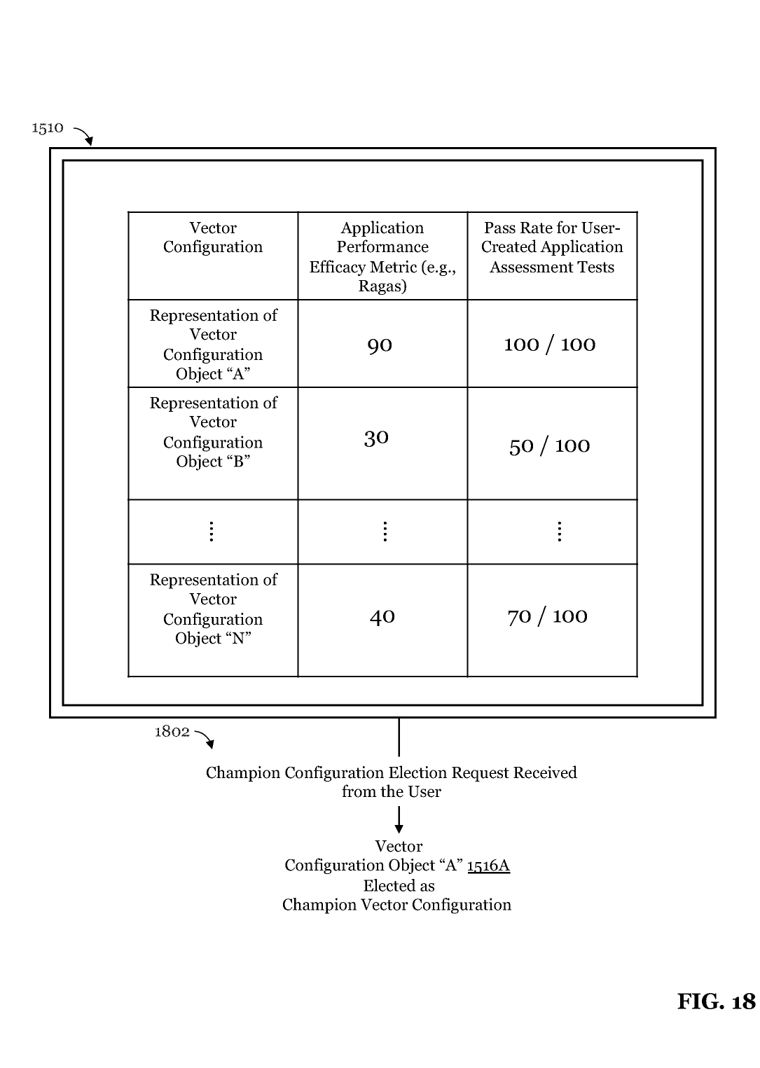

As shown in FIG. 14A, sub-process 1420B of process 1410 may include electing the vector configuration object as a champion vector configuration based on application performance findings outputted by the application performance assessment. Electing the vector configuration object may function to filter the number of vector configuration objects for a given RAG application down to just one vector configuration object to enable the corresponding embeddings for that vector configuration object to be used in the RAG application. In a non-limiting example, as described with reference to FIG. 18, graphical user interface 1510 may display results of an application performance assessment (e.g., as performed by application test execution service 1702 in FIG. 17A). The results of the application performance assessment may include metrics that may enable comparison between vector configuration objects such that a user may elect a champion configuration election request 1802. In the present example, for instance, the user may select vector configuration object 1516A as a champion vector configuration.

A “champion vector configuration” may refer to a designated vector configuration object that has been selected via user input for active use in a deployed RAG application. Electing a vector configuration object as a champion vector configuration may involve the RAG application development service receiving a user input from the graphical user interface requesting a particular vector configuration object to be promoted as a champion vector configuration. Once the user input is received, the RAG application development service may update one or more data objects to mark and/or tag the vector configuration object as the champion vector configuration. For instance, the RAG application development service may update a field in the vector configuration object to indicate that it is the champion vector configuration.

An “application performance finding” may refer to an output received from an application performance assessment that represents a quantitative or qualitative measurement of how a RAG application performed in response to application assessment tests. For instance, the application performance finding may include the performance efficacy value calculated for a given vector configuration object. Electing a vector configuration object as a champion vector configuration based on the application performance findings outputted by the application performance assessment may refer to electing the vector configuration object whose associated evaluated performance characteristics best meet one or more predefined performance criteria (e.g., the vector configuration object that has the highest performance as compared to other vector configuration objects).

In examples in which multiple vectorization pipelines are configured for a single collection object, the RAG application development service may compute a first application performance efficacy value for the RAG application in response to executing the application performance assessment for a first vectorization pipeline and a second application performance efficacy value for the RAG application in response executing the application performance assessment for a second vectorization pipeline. Upon computing the first and second application performance efficacy values, the RAG application development service may display, on the graphical user interface, a representation of the vector configuration object corresponding to the first vectorization pipeline in associated with the first application performance efficacy value and a representation of a second vector configuration object in association with the second application performance efficacy value. Additionally, the RAG application development service may indicate the vector configuration object associated with the first vectorization pipeline as being elected as the champion vector configuration based on the first application performance efficacy value being greater than the second application performance efficacy value. In some examples, each of the first and second application performance efficacy values may be a respective RAG assessment score (RAGAS) value.

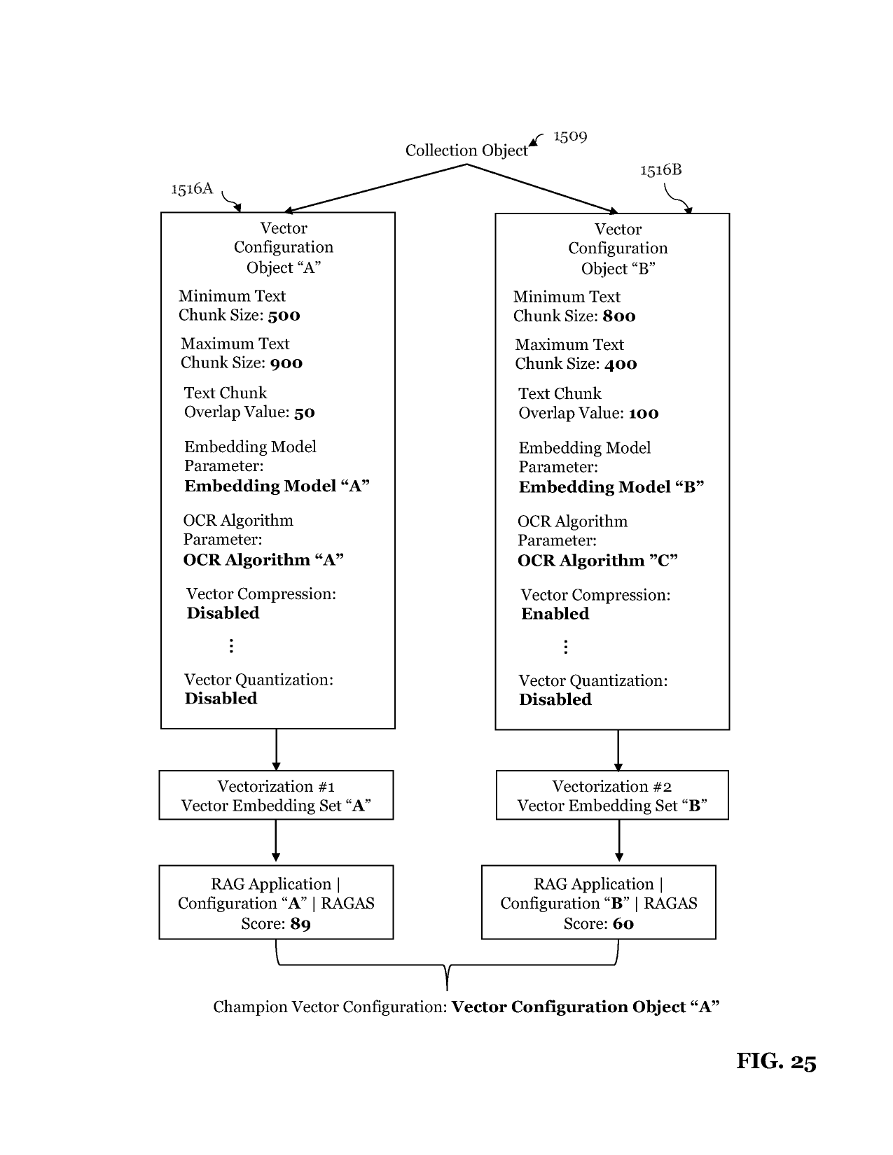

In a non-limiting example, as described with reference to FIG. 25, a collection object 1509 may include a first vector configuration object 1516A and a second vector configuration object 1516B. The first vector configuration object 1516A may have a corresponding set of vector parameter values (e.g., a minimum text chunk size of 500, a maximum text chunk size of 900, a text chunk overlap value of 50, a selection of a first embedding model, a selection of a first OCR algorithm, disabled vector compression, disabled vector quantization). Additionally, the second vector configuration object 1516B may have a corresponding set of vector parameter values (e.g., a minimum text chunk size of 300, a maximum text chunk size of 800, a text chunk overlap value of 100, a selection of a second embedding model, a selection of a second OCR algorithm, enabled vector compression, and disabled vector quantization). The vectorization service described herein may generate a first set of embeddings for the first vector configuration object 1516A according to the corresponding set of vector parameter values and may generate a second set of embeddings for the second vector configuration object 1516B according to the corresponding set of vector parameter values. Additionally, the RAG application development service may determine a first application performance efficacy value for first machine-learning generated test cases for the first vector configuration object 1516A (e.g., a RAGAS of 89) and a second application performance efficacy value for second machine-learning generated test cases for the second vector configuration object 1516B (e.g., a RAGAS of 60). In examples in which the first application performance efficacy value is higher than the second application performance efficacy value, the first vector configuration object 1516A may be elected as the champion vector configuration (e.g., for use in RAG application deployment).

As shown in FIG. 14A, process 1430 may represent operations that occur at a third stage of a RAG application development pipeline. The third stage of the RAG application development pipeline may involve deploying a RAG application with vector embeddings generated according to the champion vector configuration. The third stage of the RAG application development pipeline may function to incorporate a vector configuration object with the champion vector configuration status into a live RAG application ready to generate a response grounded in the associated vector embeddings.

As shown in FIG. 14A, sub-process 1430A of process 1430 may include deploying the RAG application, where the RAG application is operably configured to respond to natural language input using a large language model and the champion vector configuration. In order to deploy a RAG application, the RAG application development service may load embeddings corresponding to a champion vector configuration object into a vector database and may configure a connection between the vector database and the large language model. The RAG application development service may then initialize a retrieval layer configured to convert an incoming user query into embeddings using a same embedding model used to generate the stored vector embeddings and performs a similarity search to retrieve the most relevant vector embeddings from the vector database. Additionally, the RAG application development service may initialize a generation layer that supplies retrieved vector embeddings along with the user query to the large language model, which then generates a response grounded in the content of the retrieved vector embeddings. Once the generation layer and retrieval layer are initialized, the RAG application development service may expose an endpoint for providing user queries from the retrieval layer and receiving responses from the generation layer.

Retrieval-augmented generation (RAG) applications combine information retrieval and generative modeling to produce responses that are grounded in an external corpus of data. Setting up a RAG application may include ingesting documents from data sources, extracting text from the documents, segmenting the extracted text into segments (e.g., chunks), and transforming each segment into vector embeddings that are then stored in a vector database for later retrieval by the RAG application in response to a received user query. Typically, performing each of these steps may involve coordination between multiple systems that collectively may be referred to as a vectorization pipeline or a vectorization service. For instance, a vectorization pipeline may include a first service for extracting text from a document and a second service for segmenting the extracted text into segments. However, implementing such coordination may involve manual configuration of the associated systems, which may each rely on distinct frameworks, data formats, and configuration protocols. Accordingly, the process of setting up a vectorization pipeline may only be accessible to users who are capable of writing code that manually links these systems together. Further, any changes to the vectorization pipeline may involve manually performing corresponding changes to the code, which may generate overhead that limits how many vectorization pipeline configurations can be tested within a given timespan.

By contrast, the RAG application development service described herein provides for a computer-implemented framework that enables a user to design, configure, evaluate and deploy vectorization pipelines through a no-code user interface that unifies all the systems within the pipeline under a cohesive graphical control layer. For instance, the interface may enable users to select which systems associated with RAG setup to utilize for a given vectorization pipeline and to configure such systems with related parameters. Once the user performs this selection and configuration, the interface may notify the RAG application development service, which may automatically set up and coordinate the various systems as specified by the user. By automatically configuring coordination between these systems, the RAG application development service described herein may reduce overhead associated with setting up vectorization pipelines. Additionally, by providing for a no-code user interface, the vectorization pipelines deployment system described herein may improve user accessibility.

It should be further noted that the RAG application development service described herein may enable evaluation and comparison of multiple candidate configurations for a vectorization pipeline. Additionally, the RAG application development service may enable selection of one of the candidate configurations to become an active configuration, referred to as a champion configuration, whose associated embeddings are used by RAG applications. The comparison of candidate configurations may enable a vector configuration with the best performance characteristics (e.g., a highest retrieval accuracy and/or response quality while reducing computational resources) to be selected, whereas systems that utilize statically configured vectorization pipelines may have no such capability. Further, in the event that the data sources linked to a particular vectorization pipeline are modified or updated to include fewer or greater data sources, the user interface described herein may be used to perform an updated evaluation and select a new configuration as a champion configuration if the new configuration has the best performance after the data sources are modified or updated.

It should be noted that the RAG application development service described herein may organize groupings of data sources and candidate configurations for an associated vectorization pipeline into logical constructs referred to as collection objects. Each collection object may act as a modular workspace that enables separate vectorization pipelines to be configured for separate groupings of data sources. The performance of a particular configuration for a vectorization pipeline may depend at least in part on the documents within a particular group of data sources. For instance, a first vectorization pipeline with table extraction activated may enable improved response quality if many of the documents within an associated grouping of data sources have tables, but the same vectorization pipeline may incur additional latency relative to other vectorization pipelines without improved response quality if none of the associated grouping of data sources have tables within them. Accordingly, the capability to have separate, custom-tailored vectorization pipelines for separate groupings of data sources may enable improved performance for each of these groups of data sources as compared to a single vectorization pipeline for all data sources.

Additionally, the RAG application development service described herein may enable improved security through the application of security groups to collection objects. For instance, when a new collection object is created, the RAG application development service may automatically generate a corresponding security group and assign the creator as an authorized member. Additional users may be granted or revoked access explicitly through user interface controls. The user interface may dynamically display only collection objects and configuration data that authenticated users are authorized to view or modify. In this manner, the content of the data sources and of vectorization pipeline configurations may be protected from unauthorized users.

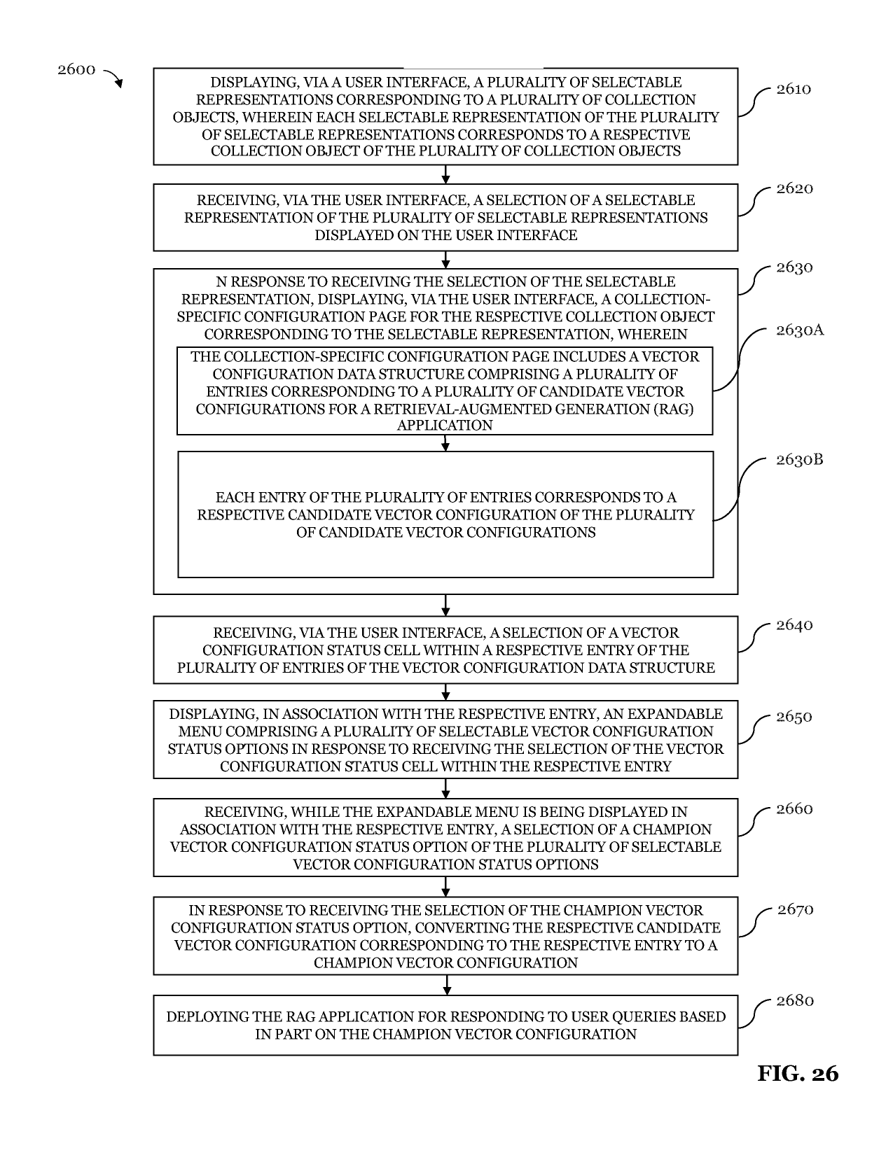

FIG. 26 illustrates one embodiment of method 2600. It shall be appreciated that other embodiments contemplated within the scope of the present disclosure may involve more processes, fewer processes, different processes, or a different order of processes than illustrated in FIG. 26. It should be noted that a computer-program product may include a non-transitory machine-readable storage medium storing computer instructions that, when executed by one or more operations, may perform operations corresponding to the processes and sub-processes of method 2600. Additionally, or alternatively, a computer-implemented method may include operations corresponding to processes and sub-processes of 2600. Additionally, or alternatively, a computer-implemented system may include one or more processors, a memory, and a computer-readable medium operably coupled to the one or more processors, the computer-readable medium having computer-readable instructions stored thereon that, when executed by the one or more processors, cause a computing device to perform operations corresponding to the processes and sub-processes of method 2600

As shown in FIG. 26, process 2610 of method 2600 may include displaying, via a user interface, a plurality of selectable representations corresponding to a plurality of collection objects. Displaying the plurality of selectable representations may function to provide a user with a visual indication of which collection objects are accessible to the user as well as to enable the user to manage and interact with the collection objects (e.g., for experimentation of vector configurations linked to that collection object and selection of a champion vector configuration for particular collection objects). Each collection object may be associated with a particular grouping of data sources. Additionally, each collection object may be associated with one or more vectorization pipeline configurations for converting text from the associated data sources into vector embeddings. Accordingly, each collection object may provide a means for linking a grouping of data sources to candidate configurations for a vectorization pipeline that generates embeddings from that grouping of data sources. In a non-limiting example, as described with reference to FIG. 27A, user interface 2702 may display a plurality of selectable representations 2708A through 2708W, where each of the plurality of selectable representations 2708A through 2708W may correspond to a respective collection object. For instance, selectable representation 2708A may correspond to a first collection object, selectable representation 2708B may correspond to a second collection object, and so on.

A “RAG application development service” may refer to a computer-implemented system configured to execute the operations corresponding to processes 2610 through 2680. In some implementations, the RAG application development service may be deployed as a cloud-based application hosted on a distributed computing infrastructure. In such examples, the RAG application development service may deliver the user interface to a user device via a web browser and may include a backend orchestration layer for processing information from and providing information to the user interface.

A “RAG application” may refer to a computer-implemented system configured to generate natural language responses to user queries by combining context retrieval from one or more data sources with language model generation. For instance, a RAG application may operate by receiving an input query, generating a corresponding vector embedding using an embedding model, performing a similarity search over a vector database containing embeddings, and retrieving embeddings corresponding to one or more context passages that are semantically related to the query. The embeddings for the retrieved context passages and the user query may then be provided to a language model that synthesizes a natural-language response based on the retrieved embeddings. It should be noted that a RAG application may also be referred to as a “RAG agent” or an “agent” without deviating from the scope of the present disclosure.

A “collection object” may refer to a logical data construct that represents a bounded workspace within which RAG-related operations are configured, executed, and evaluated. Each collection object may represent a grouping of one or more data sources, where a “data source” as described herein may refer to a digital repository, file, or content location which provides information. Examples of data source may include documents, records, datasets, or database tables that contain text or representations of text (e.g., images, audio). In some examples, a data source may provide unstructured text data, which may refer to textual information that lacks a predefined schema (e.g., natural language text).

Each collection object may further represent various configurations for a vectorization pipeline used to generate embeddings from the respective grouping of data sources. For instance, each collection object may represent a set of candidate vector configurations used to set up a RAG application that references the one or more data sources. In some examples, a collection object may further represent a set of tests for evaluating a performance of a RAG application associated with each candidate vector configuration. The set of tests may include manually configured tests (e.g., configured by a user) and/or may include automatically generated tests (e.g., automatically generated by the RAG application development system). The tests may enable a user to select which candidate vector configuration is the best-suited for a RAG application (e.g., which candidate vector configuration is a champion vector configuration).

It should be noted that each collection object of the plurality of collection objects may correspond to a different grouping of data sources, candidate vector configurations, and tests for evaluating different RAG applications. In some examples, at least some data sources, candidate vector configurations, or tests may be shared between collection objects. Additionally, or alternatively, candidate vector configurations and tests may be shared between collection objects but data sources may be different.

A “selectable representation” may refer to a graphical user interface element that visually represents an underlying data entity (e.g., a collection object) and that is configured to receive user input selecting that entity for subsequent interaction. An instance of a user input selecting a particular graphical user interface element may be referred to as a “selection.” Each selectable representation may be displayed within a user interface as an icon, card, tile, button, or other interactive control element capable of being selected through an input device (e.g., a mouse, a keyboard, a touchscreen).

In some examples, the user interface described herein may enable a user to create a new collection object, thus enabling a user to custom-select a set of data sources for a particular RAG application. In order to facilitate this, the user interface described herein may include a dedicated user interface control element configured to receive user input for initiating the creation of a new collection object (e.g., a create new collection selectable object). When the dedicated user interface control element is selected, the user interface may display a dedicated menu configured to receive user input specifying one or more data sources to be associated with the new collection object (e.g., a collection source selection element).

In a non-limiting example of new collection object creation, as described with reference to FIG. 27A, user interface 2702 may include a create new collection selectable object 2706 that is displayed concurrently with the selectable representations 2708A through 2708W. The user interface 2702 described herein may receive a selection 2714 of the create new collection selectable object 2706 and may insert a collection source selection element 2710C into the create new collection selectable object 2706, as depicted in FIG. 27B. The user interface 2702, via the collection source selection element 2710C, a user input 2714C defining one or more data sources (e.g., of data sources 2712A through 2712G) and may request to the RAG application development service to create a new collection object based on the one or more data sources defined via the collection source selection element 2710C (e.g., may create a new collection object including references to the one or more data sources or the content thereof). For instance, of data sources 2712A through 2712G, a user may select data sources 2712A, 2712B, and 2712C to be used in RAG applications configured via the new collection object. In response to creating the new collection object, the RAG application development service may request to user interface 2702 to add a new selectable representation corresponding to the new collection object.

In some examples, the user interface may enable a user to provide a name and description for a new collection object, thus enabling improved ease with which the new collection object may be distinguished from other collection objects via metadata management. In a non-limiting example, as described with reference to FIG. 27B, a collection name input element 2710A and a collection description input element 2710B may be inserted in a create new collection selectable object 2706 in response to receiving a selection 2714 of the create new collection selectable object 2706. In such examples, the RAG application development service may be configured to receive, via the collection name input element 2710A, a user input 2714A defining a name of the new collection object and may receive, via the collection description input element 2710B, a user input 2714B defining a description of the new collection object. The new collection object may be created based on the name and the description (e.g., the corresponding selectable representation may display the name and a description may become available when the selectable representation is interacted with via user input).

In some examples, the user interface may enable a user to save a new collection selectable object or to cancel the new collection selectable object. For instance, the user interface may provide a first user interface control element for saving the new collection selectable object via respective user input (e.g., a save selectable object) and a second user interface control element for canceling the new collection selectable object via respective user input (e.g., a cancel selectable object). Saving a new collection selectable object may entail executing computer instructions that instantiate a corresponding collection object in persistent storage, associate specified data sources with the collection object, and update the user interface to display the new selectable representation. Canceling a new collection selectable object may entail executing computer instructions that discard any user-provided input or temporary configuration data associated with a pending collection object and restoring the user interface to its prior state without creating or persisting a new collection object. In a non-limiting example, as described with reference to FIG. 27B, a save selectable object 2774B and a cancel selectable object 2774A may be inserted into the create new collection selectable object 2706. When the RAG application development service detects a selection 2714R of the save selectable object 2774B, the RAG application development service may create the new collection object. Additionally, when the RAG application development service detects a selection of the cancel selectable object 2774A, the RAG application development service may not create the new collection object.

In some examples, creating a collection object may generate an associated access control group that may define a security boundary for the collection object. The access control group may correspond to the user creating the collection object or to a group that the user belongs to. Accordingly, only users associated with the access control group may view, modify, or execute operations on the resources associated with the collection object (e.g., data sources, tests, vector configurations). Isolating collection objects in this manner may prevent unauthorized cross-access between RAG applications, including those hosted on the same infrastructure and may thus improve security of the RAG application development service.

As shown in FIG. 26, process 2620 of method 2600 may include receiving, via the user interface, a selection of a selectable representation of the plurality of selectable representations displayed on the user interface. The selection of the selectable representation may function to confirm to the RAG application development service that a user is requesting access to a particular collection object and may thus facilitate further interaction with the collection object. In a non-limiting example, as described with reference to FIG. 27A, a RAG application development service may receive, via user interface 2702, a selection 2766 of a selectable representation 2708G of the plurality of selectable representations 2708A through 2708W.

The selection of the selectable representation may refer to an input event received by the RAG application development service that identifies a specific selectable representation as a target of user interaction. The selection may be performed through any input mechanism capable of generating a corresponding user interface event (e.g., a mouse click, a touchscreen tap, a keyboard command, a stylus activation, a voice-recognition trigger). Once the user interface event is generated, the user interface may notify the RAG application development service of which selectable representation was selected.

As shown in FIG. 26, process 2630 of method 2600 may include displaying, in response to receiving the selection of the selectable representation and via the user interface, a collection-specific configuration page for the respective collection object corresponding to the selectable representation. The collection-specific configuration page may function to enable a user to modify aspects of a particular collection object. For instance, the collection-specific configuration page may enable a user to modify, evaluate, and test vectorization pipeline configurations within the user interface without writing code. In a non-limiting example, as described with reference to FIG. 27C, the RAG application development service, in response to receiving the selection 2766 of selectable representation 2708G (e.g., as depicted in FIG. 27A), may display, via user interface 2702, a collection-specific configuration page 2716 for the collection object corresponding to selectable representation 2708G.

A “collection-specific configuration page” as described herein may refer to a graphical user interface view dedicated to displaying, editing, and executing operations on a collection object. Each collection-specific configuration page may be dynamically generated based on underlying metadata and access permissions of the corresponding collection object. For instance, the collection-specific configuration page may retrieve and render only user interface elements and data structures that pertain to the selected collected object (e.g., rather than all collection objects in the plurality of collection objections). Accordingly, the collection-specific configuration page may constitute a context-dependent configuration interface that functions as an operational control layer for a single collection object and its inclusion may provide a means for unifying collection-level management into one view.

As shown in FIG. 26, sub-process 2630A of process 2630 may include displaying a vector configuration data structure within the collection-specific configuration page that includes a plurality of entries corresponding to a plurality of candidate vector configurations for a retrieval-augmented generation (RAG) application. The vector configuration data structure may function to provide a centralized location where a user may receive information about each vectorization pipeline configuration linked to a particular collection object. In a non-limiting example, as described with reference to FIG. 27C, the RAG application development service may display a vector configuration data structure 2718 within the collection-specific configuration page 2716 that includes a plurality of entries 2720A through 2720H corresponding to a plurality of candidate vector configurations for a RAG application. Additionally, when a particular entry is selected, collection-specific configuration page 2716 may depict configuration windows 2726A through 2726D for configuring the associated vector configuration (e.g., configuration window 2726A may include same or similar functionalities to vector configuration update strategy section 2750 of FIG. 27F, configuration window 2726C may include same or similar functionalities to data source ingestion and text chunking section 2752 of FIG. 27F, and configuration window 2726D may include same or similar functionalities to text extraction section 2756 of FIG. 27F).

A “vector configuration data structure” may refer to a data representation that organizes, indexes, and exposes information for each candidate vector configuration associated with a particular collection object. The vector configuration data structure may be persisted in memory or storage and may be rendered in the user interface as a table or equivalent structured view. In a non-limiting example, as described with reference to FIG. 27C, each entry of entries 2720A through 2720H may be represented as a row within vector configuration data structure 2718 and may include entry-specific values within cells 2724A through 2724F.

A “vector configuration” as described herein may refer to a set of parameters that govern how a vectorization pipeline is to be configured. Such parameters may indicate how the RAG application development service is to perform operations involved in generating embeddings, such as document ingestion, text extraction, text pre-processing (e.g., text chunking), embedding generation, embedding storage, and/or model execution. It should be noted that a vector configuration may be described as a “vectorization pipeline configuration” without deviating from the scope of the present disclosure.

A respective vector configuration being a “candidate vector configuration” may refer to that vector configuration being in a non-promoted state, whereas a respective vector configuration being a “champion vector configuration” may refer to the vector configuration being in a promoted state. The vector configuration labeled as the champion vector configuration may be automatically used in a RAG application when the RAG application selects the associated collection object for use in the RAG application unless otherwise specified by the user. A vector configuration may be in the non-promoted state when no user input has yet been provided promoting the vector configuration (e.g., it is a default state) or when explicit user input demotes the vector configuration from the champion vector configuration. A vector configuration may be in the promoted state when user input is provided to the user interface promoting the vector configuration. Alternatively, it should be noted that there may be examples where a vector configuration may be promoted to a champion vector configuration in an automated fashion (e.g., whichever vector configuration is associated with most favorable performance metrics may automatically be labeled as the champion vector configuration whereas the remaining vector configurations may be candidate vector configurations).

As shown in FIG. 26, sub-process 2630B of method 2600 may include displaying, within the vector configuration data structure, that each entry of the plurality of entries corresponds to a respective candidate vector configuration of the plurality of candidate vector configurations. Displaying this mapping may ensure that later processes (e.g., promotion to champion in process 2660) are traceable to particular entries within the vector configuration data structure. In a non-limiting example, as described with reference to FIG. 27C, each of entries 2720A through 2720H may include a configuration cell 2724A indicating an identifier of a vector configuration corresponding to that entry.

Each entry within the vector configuration data structure may include information related to whether a vectorization job has been performed for the associated vector configuration. A “vectorization job” may refer to a computer-executed process that performs transformation of unstructured text data from one or more data sources into vector embeddings using a given vector configuration. If the unstructured text data from the one or more data sources has already been converted into embeddings for the given vector configuration, the information within the vector configuration data structure may indicate that the vectorization job has been completed. However, if the vector configuration has been defined but has not yet been used to convert the unstructured text from the one or more data sources into embeddings, the information within the vector configuration data structure may indicate that the vectorization job has not been completed yet. In a non-limiting example, as described with reference to FIG. 27C, each of entries 2720A through 2720H may include a vectorization job status cell 2724B that indicates a completion status of a vectorization job associated with a respective candidate vector configuration linked to that entry. In the present example, the vectorization job status cell 2724B for each of entries 2720A through 2720H may indicate a complete vectorization job. It should be noted that each of entries 2720A through 2720H may include a last job cell which may indicate a timestamp indicating a more recent timestamp at which a vectorization job was initiated or completed.

Additionally, each entry within the vector configuration data structure may include information related to the performance of a RAG application using a specific vector configuration. A performance of the RAG application or a specific vector configuration used by the RAG application may be defined according to one or more quantitative metrics which may be referred to as RAG efficacy values. A RAG efficacy value may be derived from one or more automated or manual evaluation processes that measure how accurately and reliably a RAG application retrieves relevant content and generates contextually relevant responses based on user queries or test inputs. Performing an evaluation process may allow the RAG deployment system to identify inefficiencies or inaccuracies within the vectorization pipeline that may not be observable during configuration and may serve as a control mechanism that enables a user to select a candidate vector configuration associated with a best accuracy or reliability relative to other vector configurations, thus reducing factual errors, hallucinations and/or context drift that may arise in RAG applications. For instance, the improved accuracy may reduce a number of redundant retrieval and generation operations used in correcting or verifying results, leading to overall lower processing latency and/or reduced resource utilization.

Performing a manual evaluation process may involve providing one or more user-defined queries as input to a RAG application associated with a specific vector configuration. The RAG application development service may detect whether the response generated to each user-defined query includes one or more respective user-defined keywords. Each user-defined query and corresponding one or more user-defined keywords may in conjunction be referred to as a respective user-defined test case. A user-defined test case may be successfully passed when a response includes all or a specified subset of the user-defined keywords for a given user-defined query and may fail otherwise. The RAG application development service may then display within the vector configuration data structure a proportion (e.g., a fraction, a ratio) of user-defined test cases that were successfully passed as compared to the total number of user-defined test cases. In a non-limiting example, as described with reference to FIG. 27C, each of entries 2720A through 2720H may include a RAG efficacy value cell 2724E that indicates results of a manual evaluation process via a fraction indicating a number of user-defined test cases that passed out of a total plurality of user-defined test cases. For instance, entry 2720H may indicate that 3 user-defined test cases out of 3 total user-defined test cases were successfully passed when the associated vector configuration was used to generate embeddings.

It should be noted that the number of user-defined test cases that passed out of the plurality of user-defined test cases may be selectable to display test parameters and results associated with the plurality of user-defined test cases. For instance, in a non-limiting example as described with reference to FIGS. 27C and 27K, user input provided to RAG efficacy value cell 2724E for entry 2720A may trigger user interface 2702 to display a user-defined test case popover 2764 that displays test parameters table 2764A and results table 2764B. Each entry (e.g., row) within the test parameters table 2764A may indicate a respective vector configuration, a test prompt provided for that vector configuration, and an evaluation LLM used to generate a response from the test prompt and retrieved embeddings. Each entry (e.g., each row of the table 2764B) may correspond to a respective entry within the test parameters table 2764A (e.g., the entry on the same row) and may include a response to the corresponding test prompt as well as information on whether that response passes user-defined criteria. Each entry within the results table 2764B may further include one or more of a reason for passing or failing, a cost associated with generating the response, a latency associated with generating the response, and a user-selectable element to for pulling up an additional-detail window that gives more details about a particular result.

An example of an additional-detail window that is generated when selecting the user-selectable element may be demonstrated with reference to FIG. 27L. The additional-detail window may be generated when selecting the user-selectable element within the user-defined test case popover 2764 illustrated in FIG. 27K. The additional-detail window may include a test prompt, the response generated by an evaluation LLM for that test prompt, and an assertion table where each entry (e.g., row) represents a user-defined criterion and whether the response meets the user-defined criteria. For instance, the assertion table may display a first criterion specifying that the response should include the keywords “icontains = <window-source>” and a second criterion specifying that the response should include the keywords “icontains = class=”fs””. Each of these user-defined criteria may be given a total weight which in aggregation may be added up to determine if they pass a passing threshold. For instance, as there are two user-defined criteria and both are successfully satisfied, the score associated with the user-defined criterion may be 100%, which may be higher than a predefined passing threshold of 66%. Accordingly, the response passes the user defined criteria. If only one of the user-defined criteria was satisfied, the score associated with the response may be 50%, which may be lower than the predefined passing threshold of 66%. Accordingly, the response in this case would not pass the user defined criteria.

Performing an automated evaluation process, meanwhile, may include the RAG application development service generating test cases which may each include an input query, a ground-truth response, and contextual data derived from one or more data sources. A “ground-truth response” as described herein may refer to a reference answer that represents a correct output in response to a given input query. The contextual data may include one or more retrieved text passages, document fragments, or content segments obtained from the data sources associated with a collection object.

For each test case, the RAG application development service may retrieve relevant embeddings generated using the associated vector configuration, generate a response via a language model (e.g., an evaluation LLM) using the input query and the retrieved embeddings, and compare the generated response to the ground-truth response using a critic LLM. For instance, the evaluation LLM may be used to generate a candidate response for an input query using vector embeddings derived from a given vector configuration object and the critic LLM may subsequently evaluate the candidate response by comparing the candidate response to the ground-truth response and by determining, for example, whether the candidate response is relevant, complete, or consistent with the ground truth. In some examples, the critic LLM may output one or more binary or categorical determinations (e.g., “relevant,” “not relevant,” “correct,” “incorrect”) that may be aggregated into a numerical score for the test case. The system may then compute a composite RAG efficacy value representing the aggregated performance across all test cases and may display the RAG efficacy value in the vector configuration data structure (e.g., as a percentage). Additionally, or alternatively, the RAG application development service may indicate how many test cases have been tested, which the user interface may display visually (e.g., as a horizontal progress bar). In a non-limiting example, as described with reference to FIG. 27C, each of entries 2720A through 2720H may include a RAG efficacy value cell 2724D that indicates a performance of the RAG application on a set of automatically generated test cases, where the RAG efficacy cell 2724D presents the performance using a combination of a horizontal progress bar and a percentage label.

It should be noted that the test cases for the automated evaluation process may be generated using one or more LLMs or rule-based generation routines configured to produce query-answer pairs grounded in the content of the data sources associated with a particular collection object. For instance, the RAG application development service may analyze text data ingested from the data sources to identify topics, entities, and relationships and may construct corresponding candidate queries that target the informational scope of the text data. For each generated query, the system may extract passages from the data sources and produce a ground-truth response. An LLM used to generate test cases may be referred to as a generator LLM.

Supporting both the manual evaluation process and the automated evaluation process within the RAG application development service may enable a more robust assessment of the RAG application as compared to performing one or the other alone. For instance, the manual evaluation process may capture contextual and semantic correctness that depends on user-specific criteria (e.g., as determined by a user), whereas the automated evaluation process may use statistical rigor to ensure that a vector configuration more generally performs well relative to other vector configurations.

In order to facilitate automated RAG evaluation processes, the collection-specific configuration page may include a workspace summary view that displays the vector configuration data structure and an automated evaluation view which enables a user to manage and observe results of an automated evaluation process. A “view” as described herein may refer to a graphical display context within a user interface that presents a defined subset of system data, interactive elements, and/or operational controls relevant to a particular functional task or workflow (e.g., the workspace summary view may function to display high-level information about vector configurations and the automated evaluation view may function to enable automated evaluation of vector configurations). Having both the workspace summary view and the automated evaluation view within the collection-specific configuration page may enable the RAG application development service to reduce memory utilization and interface rendering by loading only relevant data structures within an active view, thus reducing computational overhead as compared to a view that includes both.

In a non-limiting example of navigating between views within the user interface, as described with reference to FIG. 27C, the RAG application development service may receive, via the user interface 2702, a first user input 2715F for navigating from a workspace summary view 2722A to an automated evaluation view 2722B. Accordingly, the user interface 2702 may cease displaying, in the collection-specific configuration page 2716, the vector configuration data structure 2718 in response to receiving the first user input 2714F and may instead display an automated evaluation data table 2730A and/or an automated evaluation results data table 2730B.

The automated evaluation view may include a dedicated user interface control element for creating automated test cases to be utilized in the automated evaluation process (e.g., an automated evaluation selectable object). When the dedicated user interface control element is selected, the user interface may display an automated configuration popover that enables a user to configure one or more aspects of the evaluation process. A “popover” as described herein may refer to a graphical user interface element that dynamically appears in association with a current active interface component to provide in-place configuration controls related to an active task or selection.

The automated configuration popover may include a user interface input element for specifying a target percentage of coverage for the one or more data sources associated with a collection object (e.g., a source coverage input element). The target percentage of coverage, which may also be referred to as a source coverage percentage, may refer to a numerical parameter (e.g., between 0 and 100) that defines a proportion of available data sources or document content to be included when automatically generating evaluation test cases. Generally, a higher percentage of coverage may be associated with a more thorough assessment. However, a high percentage of coverage may also be associated with a higher computational expense (e.g., due to generating more test cases that may each then undergo testing). Thus, the user interface input element may enable a user to have fine-grained control over the computational expense versus the thoroughness of the automated evaluation process.

In some examples, the automated configuration popover may include a user interface input element for specifying a language model for generating the test cases (e.g., a (e.g., a generator language model selection input element that specifies a generator language model). Additionally, or alternatively, the automated configuration popover may include a user interface input element (e.g., a reference candidate vector configuration). for specifying a vector configuration whose embeddings are used by the generator language model for generating test cases. Further, the automated configuration popover may include a user interface control element (e.g., a confirm automated evaluation control) that may be selected to initiate the automated evaluation process.

In a non-limiting example of utilizing an automated configuration popover, as described with reference to FIG. 27D, the RAG application development service may receive, via user interface 2702 a user input 2714G selecting a perform automated evaluation selectable object 2742. In response to receiving the second user input 2714G, the RAG application development service may display, as illustrated in FIG. 27E, an automated configuration popover 2744 including a source coverage input element 2746A, a generator language model selection input element 2746C, a reference candidate vector configuration input element 2746F, and a confirm automated evaluation control 2746D. The RAG application development service may receive, via the source coverage input element 2746A, a user input 2714H specifying a target percentage of coverage for one or more data sources (e.g., 10%). It should be noted that a number of test cases to be generated (e.g., based on the source coverage) may be displayed within a test case user display element 2746B. Additionally, the RAG application development service may receive, via generator language model selection input element 2746C, a user input 2714I specifying a generator language model (e.g., gpt-4) and may receive, via the reference candidate vector configuration input element 2746F, a user input 2714J specifying a reference candidate vector configuration to use to generate embeddings. After receiving user inputs 2714H, 2714I, and 2714J, the RAG application development service may receive a fourth user input 2714K selecting confirm automated evaluation control 2746D and may generate, in response, a plurality of automated test cases generated to satisfy the target percentage of coverage. Automated configuration popover 2744 may further include a cancel automated evaluation control 2746E for closing automated configuration popover 2744 without generating test cases. An alternative example of an automated configuration popover being used for generating test cases for another vector configuration may be depicted with reference to FIG. 27Q.

In some examples, the automated evaluation view may display each of the automated test cases that are generated via interaction with the automated configuration popover. For instance, the automated evaluation view may include a structured data representation (e.g., an automated evaluation data table) which organizes and displays information related to automatically generated test cases. Each entry (e.g., row) within the automated evaluation data table may correspond to a respective test case generated via the automated configuration popover. Each entry may include fields such as a query for a test case, a corresponding ground-truth response for the test case, a reference vector configuration used to generate the test case, a generator model used to generate the test case, a number of tokens used to generate the ground-truth response, and contextual data retrieved based on a similarity between the query and vector embeddings associated with the reference vector configuration.

The automated evaluation data table may be initially populated and/or updated via interaction with the automated configuration popover. For instance, when a user selects the confirm automated evaluation control within the automated configuration popover, the automated configuration popover may close (e.g., may cease being displayed), the automated test cases as specified within the automated configuration popover may be generated, and the automated evaluation data table may be updated to include the automated test cases. The automated test cases may overwrite previously existing test cases within the automated evaluation data table (e.g., in cases where automated test cases had been previously generated) or may be added onto the previously existing test cases.

In a non-limiting example of updating an automated evaluation data table, as described with reference to FIGS. 27C and 27D, a user may configure a target percentage of coverage, a generator language model, and a reference vector configuration in automated configuration popover 2744 and may provide user input 2714K to confirm automated evaluation control. The RAG application development service may, in response to receiving user input 2714K selecting confirm automated evaluation control 2746D, generate a plurality of automated test cases and may update an automated evaluation data table 2730A to include a plurality of new entries 2732A through 2732G corresponding to the plurality of automated test cases. Each of the plurality of new entries 2732A through 2732G may include a question 2738A (e.g., a query) generated by the generator language model that contributes toward satisfying the target percentage of coverage. Additionally, each of the plurality of new entries 2732A through 2732G may include a context 2738B including text of one or more documents retrieved (e.g., by the generator language model) based on a similarity between the question and vector embeddings associated with the reference candidate vector configuration. Further, each of the plurality of new entries 2732A through 2732G may include a ground truth answer 2738C (e.g., a ground-truth response) that the generator language model produced based on the context 2738B and a total number of tokens 2738F used by the generator language model to produce the ground truth answer 2732C.

After the automated test cases are generated, a user may initiate the automated evaluation process of the automated test cases for a particular candidate vector configuration. For instance, a user may select a user interface control element within the automated evaluation view and the user interface may display a run evaluation popover (e.g., as depicted within FIG. 27P) that enables a user to configure the evaluation process. The run evaluation popover may include a first user interface input element for specifying an evaluation LLM, a second user interface input element for specifying a critic embedding model, a third user interface input element for specifying a critic LLM, and a fourth user interface input element for specifying which of one or more candidate vector configurations to evaluate. Additionally, the run evaluation popover may include a confirm run evaluation control element that the user may select in order to trigger evaluation for the indicated candidate vector configurations.

In some examples, the automated evaluation view may display automated evaluation results for each of vector configurations that are evaluated according to the automated test cases. For instance, the automated evaluation view may include a structured representation (e.g., an automated evaluation results table) that organizes and displays information related to automated evaluation results for each evaluated vector configuration. Each entry (e.g., row) within the automated evaluation results table may correspond to a respective vector configuration that has been evaluated or is in the process of being evaluated. Each entry may include fields such as a timestamp indicating when the evaluation process for a candidate vector configuration was initiated, an identifier of the candidate vector configuration, a corresponding evaluation LLM, a corresponding critic LLM, a critic embedding model, a status of competition of evaluation, a progress of the evaluation, a score for the evaluation, and a cost value. In a non-limiting example, as described with reference to FIG. 27D, automated evaluation view 2722B may include an automated evaluation results table 2730B that includes entries 2734A through 2734D, where each entry may include values for cells 2740A through 2740J).

The automated evaluation results table may be initially populated and/or updated via interaction with the run evaluation popover. For instance, when a user selects the confirm run evaluation control within the run evaluation popover, the run evaluation popover may close (e.g., may cease being displayed) and the automated evaluation results table may be updated to include the results of the evaluation for the indicated candidate vector configuration. The results may be added as a new entry to the automated evaluation results table.

In some examples, the collection-specific configuration page may support creation of new candidate vector configurations. For instance, the collection-specific configuration page may include a user interface control element (e.g., a create new candidate vector configuration object) displayed in associated with the vector configuration data structure that initiates the process of creating a new candidate vector configuration. The capability to create new candidate vector configurations through a no-code interface may enable users to create and evaluate new vectorization pipeline configurations without performing manual reconfiguration and redeployment of the vectorization pipeline, thus accelerating the process of optimizing vectorization pipelines for use in RAG applications. FIG. 27C may display a non-limiting example of a create new candidate vector configuration object 2728A to which a selection 2714D may be provided. It should be noted that collection-specific configuration page 2716 may include other selectable objects 2728B through 2728D with other functionalities (e.g., copying a vector configuration object, deleting a vector configuration object, running a vectorization job for a vector configuration object).

When a user requests creation of a new candidate vector configuration (e.g., via selection of the corresponding user interface control element), the RAG application development service may display a candidate vector configuration creation popover that enables a user to set up a new candidate vector configuration. The candidate vector configuration popover may include a variety of interactive elements that may each be modified by the user to assign a value to a respective parameter of the candidate vector configuration. FIG. 27F may display a non-limiting example of a candidate vector configuration creation popover 2748 that may be displayed in response to a selection 2714D of a create new candidate vector configuration object 2728A.

In some examples, the candidate vector configuration creation popover may include multiple selectable configuration sections. A “selectable configuration section” as described herein may refer to a grouped region of user interface elements displayed within the candidate vector configuration creation popover, where each region defines a specific subset of parameters used to control one or more operations of a vectorization pipeline. Each selectable configuration section may be selectable or expandable via user input and may include one or more input elements or control elements that enable entry or selection of vector configuration values. In a non-limiting example, a candidate vector configuration creation popover may include a vector configuration definition section, a text extraction section, and a data source ingestion and chunking section. However, it should be noted that these sections are merely exemplary and that the interactive elements within each of these sections may be split over a fewer or greater number of sections. Additionally, there may be examples in which all interactive elements are included within a single section. In a non-limiting example, as described with reference to FIG. 27F, a candidate vector configuration creation popover 2748 may include a vector configuration update strategy section 2750, a data source ingestion and text chunking section 2752 and a text extraction section 2754.

The vector configuration definition section may define parameters that determine how a candidate vector configuration is created, updated, and utilized within a vectorization pipeline. The parameters associated with the vector configuration definition section may define how text content from data sources is transformed into embeddings and how embeddings are managed in response to changes detected within the data sources. Additionally, the parameters may define descriptive attributes associated with the vector configuration.

As described herein, a subset of parameters for the vector configuration definition section may define how textual data extracted from one or more data sources is encoded and stored for retrieval. These parameters may include an embedding model parameter that specifies which embedding model to use to convert text into vector embeddings. Further, these parameters may include a quantization enablement parameter which defines whether vector embeddings are generated using reduced numerical precision and/or a compression enablement parameter which defines whether post-processing is to be applied to generated embeddings to reduce vector dimensionality prior to insertion into a vector database. Examples of compression techniques that may be enabled via the compression enablement parameter may include Principal Component Analysis (PCA) or Discrete Cosine Transform (DCT). In some examples, additional parameters may be utilized for selecting a level of quantization (e.g., selecting a quantity of bits or data type to which each entry in a vector embedding is to be reduced). Additionally, or alternatively, additional parameters may be utilized for selecting what type of compression to perform (e.g., PCA, DCT) and/or a level of compression (e.g., how many entries a reduced vector embedding should have). Quantizing and/or compressing vector embeddings may decrease memory consumption but may also reduce their semantic accuracy for context matching. Additionally, these parameters may include a vector database destination parameter that defines the location where vector embeddings are stored once they are generated for retrieval (e.g., which vector database). Adjusting these parameters may provide for improved inference speed and/or reduced memory utilization (e.g., by selecting quantization and/or compression or by selecting an embedding model or vector database with improved performance relative to other embedding models or vector databases). In some examples, quantization and compression may be performed as part of a same vectorization pipeline used to generate the embeddings, thereby eliminating the use of a separate code-based workflow.

Each of the embedding model parameter, quantization enablement parameter, compression enablement parameter, and vector database destination parameter may have an associated user interface element in the vector configuration definition section. For instance, as illustrated with reference to FIG. 27F, vector configuration definition section 2750 may include an embedding model selection input element 2750C configured to indicate an embedding model for a new candidate vector configuration provided via a user input 2714JJ; a quantization enablement control element 2750E configured to indicate whether to quantize vector embeddings associated with the new candidate vector configuration provided via a user input 2714O; a compression enablement control element 2750D configured to indicate whether to compress the vector embeddings associated with the new candidate vector configuration provided via a user input 2714N; and a vector database destination selection input element 2750F configured to select a vector database destination store to store the vector embeddings associated with the new candidate vector configuration provided via user input 2714P. After selecting these elements, the corresponding parameter values may be indicated to the RAG application development service upon user input 2714R being provided to save selection object 2758A. Candidate vector configuration creation popover 2748 may further include a cancel selection object 2758B for closing candidate vector configuration creation popover 2748 without creating a new vector configuration.

An additional or alternate subset of parameters for the vector configuration definition section may define how a system manages regeneration, synchronization and reuse of vector embeddings when data sources associated with a collection object (e.g., the collection object linked to the new vector configuration being created) are modified. Such parameters may include user-selectable options that determine whether embeddings are regenerated for all documents or selectively updated for changed documents. Such options may include an overwrite mode, an append mode, and a synchronization mode. The overwrite mode may perform complete re-vectorization of all data sources. The append mode may add embeddings for new documents without alerting existing embeddings. The synchronize mode may detect new changes in a document and selectively re-vectorize only affected portions of the corpus. It should be noted that combinations of these modes may be utilized together (e.g., the append mode and synchronize mode. Adjusting these user-selectable options may reduce processing time and compute utilization by avoiding re-vectorization while allowing re-vectorization to be performed in relevant applications (e.g., applications where a vector database size is limited).

Each of the modes may have an associated user interface element in the vector configuration definition section. For instance, as illustrated with reference to FIG. 27F, vector configuration definition section 2750 may include a vector configuration update strategy selectable option 2750G that may be selected via user input 2714Q. When selected, the vector configuration update strategy selectable option 2750G may expand to display a menu that includes update strategies for updating vector embeddings when changes to data sources associated with the respective collection object are detected. Each update strategy may correspond to a user-selectable option or a combination of the user-selectable options described herein. After selecting the update strategy, the corresponding one or more modes may be indicated to the RAG application development service upon user input 2714R being provided to save selection object 2758A.

An additional or alternate subset for the vector configuration definition section may define contextual attributes associated with each candidate vector configuration. For instance, such parameters may include a configuration name input parameter that defines a name or identifier for the new vector configuration and a configuration description input parameter that provides additional contextual information associated with the new vector configuration.

Each of the configuration name input parameter and the configuration description input parameter may have an associated user interface element in the vector configuration definition section. For instance, as illustrated with reference to FIG. 27F, vector configuration definition section 2750 may include a configuration name input field 2750A configured to specify a name of a new candidate vector configuration provided via user input 2714L and a configuration description input field 2750B configured to specify a description of a new candidate vector configuration provided via user input 2714M. After selecting these elements, the corresponding parameter values may be indicated to the RAG application development service upon user input 2714R being provided to save selection object 2758A.

The data source ingestion and text chunking section of the candidate vector configuration creation popover may define parameters that control how textual data from one or more data sources associated with a collection object is imported, preprocessed, and segmented prior to embedding generation within a vectorization pipeline. The parameters associated with the data source ingestion and text chunking section may govern the inclusion and preparation of document content by defining which file formats are eligible for ingestion, how text normalization or cleaning is applied, and how the resulting text is divided into discrete segments for embedding.

As described herein, a subset of parameters for the data source ingestion and text chunking section may define how document content is selected and pre-processed. For instance, the subset of parameters may include a document format selection parameter that may determine which file types are accepted for ingestion (e.g., text documents, PDFs, spreadsheets, presentation files), thereby controlling the scope and diversity of the corpus that contributes to a vector database. Additionally, the subset of parameters may include a text cleaning enablement parameter specifying whether preprocessing routines are applied to remove non-informative characters, markup, or metadata, thereby reducing memory taken up by the corresponding embeddings and ensuring only semantically relevant text is converted into embeddings.

Each of the document format selection parameter and the text cleaning enablement parameter may have an associated user interface element in the document source ingestion and text chunking section. For instance, as illustrated with reference to FIGS. 27G and 27H, document source ingestion and text chunking section 2752 may include a data source ingestion subsection 2752A, where the data source ingestion subsection includes a set of selectable document formats 2752B. Upon receiving a user input 2714S selecting a subset of the set of selectable document formats 2752B and user input 2714R being provided to save selection object 2758A, the new candidate vector configuration may be configured to ignore a subset of a set of documents that corresponds to those formats. Additionally, the data source ingestion subsection 2752A may include text cleaning selectable element 2752C. Upon receiving a user input 2776 indicating whether automatic text cleaning is enabled and user input 2714R being provided to save selection object 2758A, the new candidate vector configuration may be configured to clean a remainder of the set of documents during vectorization if user input 2714R enabled automatic text cleaning.

An additional or alternate subset of parameters for the data source ingestion and text chunking section may define how ingested and pre-processed text is segmented into discrete units for embedding generation within the vectorization pipeline. Such parameters may include a maximum chunk size parameter that defines an upper bound of text tokens or characters contained within a single segment, a minimum chunk size parameter that defines the lower bound of the text tokens or characters contained within the single segment, and a chunk overlap parameter that defines an amount of shared text between consecutive segment Defining a maximum chunk size parameter may ensure that a retrieval precision (e.g., a proportion of relevant items retrieved out of total items retrieved) associated with retrieving embeddings remains above a threshold amount, whereas defining a minimum chunk size parameter may ensure adequate context granularity within each vector embedding (e.g., enough text data is within a chunk to enable a semantically meaningful chunk to be generated). Defining the chunk overlap parameter may enable adequate preservation of semantic continuity while limiting a total quantity of chunks that are generated.

Each of the maximum chunk size parameter, minimum chunk size parameter, and chunk overlap parameter may have an associated user interface element in the vector configuration definition section. For instance, as illustrated with reference to FIG. 27H, document source ingestion and text chunking section 2752 may include a chunking policy subsection 2752G, where the chunking policy subsection 2752G includes a chunk overlap input element 2752F for specifying a chunk overlap value, a chunk size input element 2752D for specifying a maximum chunk size, and a minimum chunk size input element 2752E for specifying a minimum chunk size. Upon receiving user input 2714V at chunk overlap input element 2752G which specifies a chunk overlap value, user input 2714T at chunk size input element 2752D which specifies a maximum chunk size, and user input 2714U at minimum chunk size input element 2752E which specifies a maximum chunk size and user input 2714R being provided to save selection object 2758A, the new candidate vector configuration may be configured to segment text associated with documents from data sources in accordance with the specified chunk overlap value, maximum chunk size, and minimum chunk size.

The text extraction section may define parameters that govern how non-textual or semi-structured content within data sources is converted into textual data suitable for embedding within a vectorization pipeline. The parameters associated with the text extraction section may control the activation, configuration, and behavior of modules responsible for recognizing text in scanned or image-based documents and for detecting, parsing, and exporting tabular data from embedded or standalone tables.

As described herein, a subset of parameters for the text extraction section may define how image-based or scanned document content is processed to extract textual information for generating embeddings. For instance, the subset of parameters may include an optical character recognition (OCR) engine selection parameter which may specify which recognition framework or library is employed (e.g., a general-purpose text recognition model or a domain-specific OCR engine). Additionally, the subset of parameters may include an OCR language selection parameter which may define one or more languages for recognition.

Each of the OCR engine selection parameter and the OCR language selection parameter may have an associated user interface element in the text extraction section. For instance, as illustrated with reference to FIG. 27I, text extraction section 2756 may include an OCR control element 2756A and an OCR settings subsection 2756B that includes an OCR library selection input element 2756C and an OCR language selection input element 2756D. Upon receiving user input 2714W at OCR library selection input element specifying an OCR library and user input 2714XX at OCR language selection input element 2756D specifying an OCR language, and user input 2714R being provided to save selection object 2758A, the new candidate vector configuration may be configured to extract text from documents received from data sources using the OCR library and the OCR language.

An additional or alternate subset of parameters may define how tabular data within documents is detected, parsed, and converted into a structured textual form for generating embeddings. For instance, the subset of parameters may include a table extraction enablement parameter which may determine whether the vectorization pipeline performs table recognition during ingestion to identify and process tables. Additionally, the subset of parameters may include a table export format parameter that defines an output representation used for embedding (e.g., comma-separated values, JSON, markdown text). Additionally, the parameters may include a maximum table count parameter specifying how many tables are extracted from each document, thereby enabling control of processing scope and computational resource allocation. The subset of parameters may additionally include an implicit row detection parameter, an implicit column detection parameter, and a borderless table detection parameter, each of which may be used to identify corresponding tabular structures that lack explicit visual boundaries (e.g., rows, columns, and entire tables, respectively).

Each of the table extraction enablement parameter, the table export format parameter, the maximum table count parameter, implicit row detection parameter, the implicit column detection parameter, and the borderless table detection parameter may have an associated user interface element in the vector configuration definition section. For instance, as illustrated with reference to FIG. 27I, text extraction section 2756 may include a table extraction settings subsection 2756F, where the table extraction settings subsection 2756F includes a table detection threshold input element 2756K, a table export format selection input element 2756G, an implicit row detection control element 2756H, an implicit column detection control element 2756H, a borderless table detection control element 2756J, and an export tables control element 2756E. Upon receiving user input 2714X at export tables control element 2756E enabling table detection, user input 2714Y at table export format selection input element 2756G specifying an export format for the set of tables, user input 2714CC at table detection threshold input element 2756K specifying a maximum number of tables to extract from data sources, user input 2714Z at implicit row detection control element 2756H indicating whether implicit rows are to be detected in data sources, user input 2714AA at implicit column detection control element 2756I indicating whether implicit columns are to be detected in data sources, user input 2714BB at borderless table detection control element 2756J indicating whether borderless tables are to be detected, and user input 2714R being provided to save selection object 2758A, the new candidate vector configuration may be configured to extract text from tables (e.g., via OCR) according to the associated parameters.

Each of the OCR engine selection parameter and the OCR language selection parameter may have an associated user interface element in the text extraction section. For instance, as illustrated with reference to FIG. 27I, text extraction section 2756 may include an OCR settings subsection 2756B that includes an OCR library selection input element 2756C and an OCR language selection input element 2756D. Upon receiving user input 2714W at OCR library selection input element specifying an OCR library and user input 2714XX at OCR language selection input element 2756D specifying an OCR language, and user input 2714R being provided to save selection object 2758A, the new candidate vector configuration may be configured to extract text from documents received from data sources using the OCR library and the OCR language

It should be noted that when a collection-specific configuration page is displayed for a given collection object, the collection-specific configuration page may only display user interface elements for that specific collection object and may not display user interface elements for other collection objects. Such functional separation may ensure that configuration management, evaluation results, and champion selection processes remain collection-specific and may prevent cross-contamination of information between collection objects, thus improving data security.

In some examples, the collection-specific configuration page may include a language model configuration view that may display language models that may be used for test case generation and/or evaluation. For instance, as depicted with reference to FIG. 27R, a language model configuration view may include a user interface display section indicating which language models are currently configured for use and a user interface display section indicating which language models are not currently configured for use but are available to be configured. Additionally, language model configuration view may include a user evaluation language model configuration section in which an evaluation language model may be configured for a manual evaluation process via user input and an automated evaluation language model configuration section in which a data generation language model, a critic language model, and an evaluation language model may be configured for an automated evaluation process via user input.

In some examples, the collection-specific configuration page may include a respective vector configuration specific view for each candidate vector configuration that may be used to view information about and to update the associated vector configuration. An example of such a view may be illustrated, for instance with reference to FIG. 27S. The vector configuration specific view may provide user interface elements for updating associated vector configuration parameters and may display each document that the vector configuration extracts text from when performing embedding generation (e.g., as defined according to the document ingestion parameters as described herein). Further, the vector configuration specific view may include a search functionality for locating specific documents (e.g., via user input to an associated search bar). Non-limiting examples of vector configuration specific views may include vector configuration specific views 2722D through 2722K as illustrated with reference to FIG. 27C.

When a document is selected within a vector configuration specific view, the RAG application development service may render a text chunk window (e.g., as depicted with reference to FIG. 27T). The text chunk window may include each text chunk generated for the document and may further provide a view of the document such that the corresponding passage within the document is highlighted (e.g., when a mouse hovers over the text chunk). Further, the text chunk window may enable a user to select which text chunks should be retrievable by a RAG application when the RAG application attempts to locate embeddings for a user query. This functionality may enable a user to filter out portions of a text which may provide misleading, inaccurate, or irrelevant information if retrieved in response to a user query.

As shown in FIG. 26, process 2640 of method 2600 may include receiving, via the user interface, a selection of a vector configuration status cell within a respective entry of the plurality of entries of the vector configuration data structure. The selection of the vector configuration status cell may serve as an interaction trigger for invoking modification of a configuration status associated with a particular vector configuration (e.g., designating a particular vector configuration as a champion vector configuration). In a non-limiting example, as described with reference to FIG. .27C , the RAG application development service may receive a selection 2768 of a vector configuration status cell 2724F within entry 2720H.

A ”configuration status” as described herein may refer to a state attribute associated with each candidate vector configuration representing a current role of that vector configuration. Representative examples of configuration status options include an under review status in which a vector configuration is undergoing evaluation (e.g., and thus may be a candidate vector configuration) and a champion status in which a vector configuration is designated as an active configuration for the collection object it is associated with. An additional configuration status option may include a challenger status in which a vector configuration that has completed evaluation is being compared against the active configuration (e.g., to determine relative performance based on retrieval accuracy, latency, or RAG efficacy metrics).

As shown in FIG. 26, process 2650 of method 2600 may include displaying, in association with the respective entry, an expandable menu including a plurality of selectable vector configuration status options in response to receiving the selection of the vector configuration status cell within the respective entry. The expandable menu may serve as an interactive state management mechanism that governs configuration promotion and demotion during vector configuration evaluation. For instance, the expandable menu may allow a user to modify the configuration status of a vector configuration directly within the collection-specific configuration page. In a non-limiting example, as described with reference to FIG. 27C, user interface 2702 may display, in response to selection 2768 of vector configuration status cell 2724F associated with entry 2720H, an expandable menu 2770 including a set of selectable vector configuration status options 2770A through 2770C, where selectable vector configuration status may correspond to an under review status, selectable vector configuration status option 2770B may correspond to a challenger status, and selectable vector configuration status option 2770C may correspond to a champion status.

As described herein, the “expandable menu” may refer to a dynamic graphical user interface element that is displayed in association with a selected vector configuration status cell within a vector configuration data structure. The expandable menu may include multiple selectable options corresponding to configuration status options (e.g., under review, challenger, and champion). The expandable menu may be rendered in direct response to user input to a vector configuration status cell and may expand inline within the vector configuration data table to present the selectable options without navigation to a separate view. Presenting the options within the menu may enable improved data integrity by limiting selectable options to valid configuration states. Additionally, the menu being expandable may ensure it is rendered only as requested, which may reduce memory overhead associated with displaying it as compared to displaying it after loading the collection-specific configuration page.

Systems that enable selection of a champion vector configuration among candidate vector configurations may provide advantages over systems that are statically configured with a vector configuration. For instance, the capability to compare multiple candidate vector configurations may enable selection of a vector configuration associated with the best performance (e.g., best retrieval accuracy, highest response quality, best use of computational resources). Further, in examples where modifications to data sources linked to a collection object occur, the vector configuration with the highest performance may change. The system described herein may enable updating of the vector configuration as data sources are modified, which systems with statically configured vector configurations may not support. Further enabling a user to select a champion configuration via an expandable menu may have one or more advantages as compared to selecting champion configuration in an automated fashion. For instance, enabling user control over champion designation may reduce a risk of premature or erroneous promotion caused by incomplete automated evaluations.

In some examples, the collection-specific configuration page described herein may enable a user to issue a request that triggers a candidate vector configuration to generate corresponding embeddings. Such a request may be referred to as a vectorization job request, where a “vectorization job” may refer to a computational process that converts text data (e.g., unstructured text data) from one or more data sources into vector embeddings. Performing the vectorization job may enable candidate configuration evaluation to occur, as the evaluation may rely on the generated vector embeddings.

In order to support a user triggering a vectorization job, the collection-specific configuration page may include a dedicated user interface control element (e.g., an execute vectorization selectable object) that may trigger generation of vectorization job submission popover that enables a user to configure and initiate the execution of a vectorization job for a given candidate vector configuration. In a non-limiting example, as described with reference to FIGS. 27C and 27J, user interface 2702 may receive a user input 2714E selecting an execute vectorization selectable object displayed in association with vector configuration data structure 2718. In response to receiving the user input 2714E, the user interface 2702 may display a vectorization submission popover 2760.

In order to configure the vectorization job, the vectorization job submission popover may include a means for specifying an execution provider, where an “execution provider” as described herein may refer to a runtime framework or backend service responsible for executing an embedding model (e.g., an Open Neural Network Exchange (ONNX) provider, a Compute Unified Device Architecture (CUDA)-based GPU provider, an OpenVINO inference engine). For instance, the vectorization job submission popover may include a dedicated user interface input element (e.g., an execution provider input element) for specifying the execution provider. Different execution providers may be associated with different vectorization runtimes depending on the hardware that is used. Accordingly, certain selections of execution providers may be more efficient than others for a given vectorization job. The inclusion of an execution provider input element may enable a user to select a most efficient execution provider for a given vectorization job. In a non-limiting example, as described with reference to FIG. 27J, the vectorization job submission popover 2760 may include an execution provider input element 2760C that may indicate an execution provider as specified via user input 2714FF.

Additionally, the vectorization job submission popover may include a means for specifying a number of cores (e.g., CPU cores) allocated to performing a vectorization job. For instance, the vectorization job submission popover may include a dedicated user interface input element (e.g., a CPU allocation input element) for specifying a number of CPUs. Increasing the number of cores may result in reduced vectorization runtime, but may also utilize a greater number of compute resources and may increase a risk of resource contention, reducing overall cluster efficiency. Likewise, decreasing the number of cores may result in reduced compute resource utilization, but may increase vectorization runtimes. The inclusion of the CPU allocation input element may enable a user to select a number of cores that balances a tradeoff between compute resource usage and vectorization runtime. In a non-limiting example, as described with reference to FIG. 27J, the vectorization job submission popover 2760 may include a CPU allocation input element 2760A that may indicate a number of CPUs as specified via user input 2714DD.

Additionally, the vectorization job submission popover may include a means for specifying an amount of memory allocated to performing a vectorization job. For instance, the vectorization job submission popover may include a dedicated user interface input element (e.g., a memory allocation input element) for specifying an amount of memory. Increasing memory allocation may reduce risk of degraded performance (e.g., longer vectorization runtimes) due to having insufficient memory, but may be associated with increased resource utilization. The inclusion of the memory allocation input element may enable a user to select an amount of memory that balances a tradeoff between resource utilization and insufficient memory risk. In a non-limiting example, as described with reference to FIG. 27J, the vectorization job submission popover 2760 may include a memory allocation input element 2760B that may indicate an amount of memory as specified via user input 2714EE.

Additionally, the vectorization job submission popover may include a means for specifying a target hardware device type allocated to performing a vectorization job. For instance, the vectorization job submission popover may include a dedicated user interface input element (e.g., a hardware device input element) for specifying a target hardware device. Different target hardware types (e.g., CPUs, TPUs, FPGAs, GPUs) may have better performance (e.g., reduced vectorization runtimes) with different execution providers. The inclusion of the hardware device input element may enable selection of hardware devices most suitable for a given execution provider. In a non-limiting example, as described with reference to FIG. 27J, the vectorization job submission popover 2760 may include a hardware device input element 2760D that may indicate a target hardware device as specified via user input 2714GG.

Once the execution provider, the number of cores, the amount of memory, and the target hardware device are specified, a user may initiate a vectorization job via a respective user interface control element (e.g., a submit vectorization job selectable option. In a non-limiting example, as described with reference to FIG. 27J, a user may configure a number of CPUs via CPU allocation input element 2760A, an amount of memory via memory allocation input element 2760B, a target hardware device via hardware device input element 2760D, and an execution provider via execution provider input element 2760C. The user may then provide a user input 2714HH to submit vectorization job selectable option 2762A. Upon user input 2714HH being provided, the RAG application development service may submit a vectorization job to the execution provider specified in execution provider input element 2760C. Additionally, the RAG application development service may submit a request to the execution provider to convert one or more data sources to vector embeddings using the number of CPUs specified in the CPU allocation input element 2760A, the amount of memory indicated in memory allocation input element 2760B, and the target hardware device specified in hardware device input element 2760C.

After the vectorization job is performed, the entry for the corresponding candidate vector configuration may be updated with a new job status value indicating that the execution provider has finished the vectorization job. For instance, in a non-limiting example as described with reference to FIG. 27J, if a vectorization job is run for the candidate vector configuration associated with entry 2720H, the vectorization job status cell 2724B for entry 2720H may be updated to a new job status value indicating that the execution provider has finished the vectorization job.

As shown in FIG. 26, sub-process 2660 of method 2600 may include receiving, while the expandable menu is being displayed in association with the respective entry, a selection of a champion vector configuration status option of the plurality of selectable vector configuration status options. Selecting the champion vector configuration status option may function to confirm to the RAG application development service a request to perform a subsequent conversion of a candidate vector configuration under evaluation into a champion vector configuration in an active state for generating embeddings for a RAG application associated with the collection object. In a non-limiting example, as described with reference to FIG. 27C, the RAG application development service may receive, while expandable menu 2770 is being displayed in associated with entry 2720H, a selection 2772 of a champion vector configuration status option 2770C of the set of selectable vector configuration status options 2770A through 2770C.

Once the champion vector configuration option is selected for a given candidate configuration, the entry for the candidate vector configuration within the vector configuration data structure may be updated to reflect that the candidate vector configuration has been promoted to a champion vector configuration. For instance, in a non-limiting example as described with reference to FIG. 27C, if a user provides selection 2768 to champion vector configuration status option 2770C for entry 2720H, user interface 2702 may update vector configuration status cell 2724F in entry 2720H to a champion status value indicating that the respective candidate vector configuration corresponding to entry 2720H is designated as the champion vector configuration.

As shown in FIG. 26, sub-process 2670 of method 2600 may include converting, in response to receiving the selection of the selection of the champion vector configuration status option, the respective candidate vector configuration corresponding to the respective entry to a champion vector configuration. Converting the candidate vector configuration to the champion vector configuration may serve to propagate changes requested in the user interface to persistent storage associated with the RAG application development service. In a non-limiting example, as described with reference to FIG. 27C, the RAG application development service, in response to receiving the selection 2772 of the champion vector configuration status option 2770C, may convert the respective candidate vector configuration corresponding to entry 2720H to a champion vector configuration.

Converting the candidate vector configuration may include the user interface generating a payload indicating the selection of the champion vector status configuration and providing the payload to a backend module of the RAG application development service. The backend module may receive the payload (e.g., via an API) and may update configuration metadata associated with the vector configuration in a persistent data store. For instance, the backend module may change a configuration status field associated with the vector configuration from an under review status or a challenger status to a champion status. When the user interface is refreshed and requests information about the vector configuration, the information may be updated to include the champion status.

As shown in FIG. 26, sub-process 2680 of method 2600 may include deploying the RAG application for responding to user queries based on the champion vector configuration. Deploying a RAG application according to a champion vector configuration may ensure that the RAG application operates according to parameters as specified by a user (e.g., may ensure that the RAG application references embeddings that are generated using the champion vector configuration).

Deploying the RAG application based on the champion vector configuration may include a backend module of the RAG application development service retrieving configuration metadata from a data store which includes parameters associated with the champion vector configuration. Once the configuration metadata is retrieved, an orchestration service of the RAG application development service, may initialize or update one or more systems of the vectorization pipeline to ensure that each system operates according to the parameters defined in the champion vector configuration. The orchestration service may verify that the vector database associated with the champion configuration contains embeddings is aligned with the champion vector configuration and, if not, may update the embeddings within the vector database. Additionally, the orchestration service may update data structures such as routing tables and model registries to ensure all user queries are processed using the embeddings aligned with the champion vector configuration. Additionally, the orchestration service may deploy or update application endpoints to use the champion vector configuration.

In some examples, the RAG application development service may support configuration and testing of conversational behavior related to RAG applications using a particular vector configuration. For instance, the user interface for the RAG application development service may include a chat settings configuration page that enables users to manage how a RAG application interacts with end users during inference by controlling certain operation parameters. Such operational parameters may include the selection of a language model for generating a response to a user query, a collection object whose embeddings will be retrieved to respond to the user query, and a retrieval setting that determines how embeddings are retrieved. Additionally, the chat settings configuration page may include a chat session window in which a user may engage in which the user may provide a user query and may receive a response from the selected language model using embeddings from the selected collection object according to the selected retrieval setting.

In a non-limiting example, as described with reference to FIG. 27C, initially the collection-specific configuration page 2716 may be displayed. Upon user interface 2702 receiving a user input 2778 selecting a chat selectable object 2704H, the user interface may cease displaying the collection-specific configuration 2716 and may begin displaying a chat settings configuration page 2791 as depicted in FIG. 27M. The chat settings configuration page 2791 may include a collection selection input element 2782 displaying entries 2782A through 2782G each corresponding to a respective collection object. Additionally, the chat settings configuration page 2791 may include a language model selection input element 2783A through which a language model to test may be selected via user input 2785A and a retrieval settings input element 2783B through which a retrieval setting may be selected via user input 2785B.

When user input is provided to a respective entry within the collection selection input element 2782, a chat session window 2786 corresponding to that entry may pop up. The chat session window may include a prompt input element 2765 for providing a prompt (e.g., user queries) via user input and may further include a display section showing previous responses to prompts (response 2794) and previous prompts (e.g., user query 2792). Each user prompt 2792 may include a question and each response 2794 may be generated for a respective user prompt 2792 as generated by the language model specified in language model selection input element 2788 and using embeddings generated from the data sources associated with the respective selected entry and retrieved according to the retrieval setting configured in retrieval settings input element 2790. In the present example, user interface 2702 may receive, via collection selection input element 2782, a user input 2784 selecting entry 2782B and may display a chat session window for entry 2782B. The response 2794 may include a citation selectable object 2794A, a positive affirmation selectable object 2794C, and a negative affirmation selectable object 2794B.

In some examples, the RAG application development service may support citing what passages of a text document were used in generating a given response. For instance, the chat session window may include a dedicated user interface control element that triggers display of a citation window (e.g., a citation selectable object) upon receiving user input. The citation window may display the text chunks that were used to generate embeddings retrieved in response to a given user query and may additionally display the location within the corresponding one or more documents where each text chunk was retrieved. Generally, the citation window may be capable of surfacing citations and sourcing to provide reliable and explainable responses with an ability to link to source document sections.

In a non-limiting example, as described with reference to FIGS. 27M and 27N, user input 2763 may be provided to a citation selectable object 2794A, which may cause citation window 2791 to be rendered. Citation window 2791 may include a statistics view 2793A which may display statistical information about response 2794 and may include a citation view 2793B which may display citation information for response 2794. Citation view 2791 may include a set of text chunk windows 2795A and 2795B that show the text chunks used to generate the embeddings retrieved for response 2794. Additionally, the citation view may include a document window 2799 with text overlay elements 2797A and 2797B highlighting passages corresponding to respective text chunk windows.

In some examples, the RAG application development service may support automation flow creation via the user interface in order to automate aspects of candidate vector evaluation and champion vector selection. For instance, as depicted in FIG. 27O, the user interface 2702 may include an automation flow page 2771 that is rendered in response to user input applied to automation selectable object 2704G. Within the automation flow page, a user may create individual modules representing one or more aspects of vector configuration evaluation and deployment (e.g., as shown within legend display element 2773). For instance, the user may set up source modules 2775A and 2775B representing individual collectible objects and vector configuration modules 2777A and 2777B representing individual vector configurations. A given vector configuration module may be connected to one or more of the source modules in order to represent the one or more collections from which the vector configuration of the vector configuration module retrieves text in order to generate embeddings. Additionally, the user may initialize a user evaluation module 2779 that may be connected with one or more candidate vector modules (e.g., both of vector configuration module 2777A and 2777B) in order to determine which of the one or more candidate vector modules has the highest user evaluation score. Further, the user may initialize an agent module 2789 that may be connected with the user evaluation module 2779 to indicate that the agent module 2789 should retrieve vector embeddings from whichever candidate vector configuration is associated with the highest user evaluation score.

Automation flows may be triggered by document updates (e.g., manually or on a schedule). Such flows may initiate vectorization jobs for the updated documents, perform evaluations, and select a new champion model based on results. Automation may also enable notification to one or more agents about an availability of new data, supporting alerts (e.g., via email or SMS) or remote actions (e.g., activating a sensor or initiating data capture).

The user interface described herein may further enable a user to manage agents associated with particular vector configurations. For instance, FIG. 27U may depict an agent page that includes information about various agents that the user has access to. For instance, the agent page may include an agent table, where each entry (e.g., row) of the entry table includes an identifier of the agent, a version of the agent, and a status of the agent (e.g., whether the agent is running or inactive). When user input is provided to the entry, additional information may be displayed within the page (e.g., what language model the agent is using to generate a response, what collection the associated embeddings are being generated from).

Further, the agent page may include user control elements for adding new agents or editing currently existing agents. For instance, when selecting the user control element for editing an existing agent, an agent popover as depicted in FIG. 27V may be rendered within the user interface. FIG. 27V may depict an agent configuration view of the agent popover in which a user may specify an identifier of the agent, a description for the agent, a chat initializer command for the agent, a number of CPUs allocated to the agent, and memory allocated to the agent.

The agent popover may include additional views. For instance, the agent popover may include a code view in which a user may write code for invoking the agent (e.g., as depicted in FIG. 27W). Additionally, as depicted in FIG. 27X, the agent popover may include an LLM view in which a user may set the language model used by the agent to generate responses as well as retrieval settings for the agent (e.g., how the agent retrieves vector embeddings upon receiving a response). Further, as depicted in FIG. 27Y, the agent popover may include a collections view that may enable the user to select which sets of vector embeddings the agent has access to (e.g., via selection of the corresponding collection object).

It should be noted that there may be examples in which the RAG application development pipeline described herein includes an agentic pipeline configured to operationalize vector embeddings generated according to a configured vectorization pipeline. The term “ agentic pipeline” may refer to a sequence of operations that enables a RAG application to utilize one or more vector configuration objects in conjunction with additional agent logic. For instance, an agentic pipeline may involve receiving a selection of one or more collection objects, each collection object identifying a corresponding set of source documents and associated vector embeddings. The agentic pipeline may further involve receiving an indication of agent configuration parameters, such as a selection of a large language model, a selection of one or more tools or external application programming interfaces to be invoked by the agent, and an indication of control-flow logic governing how the agent is to respond to user queries. In response to receiving the agent configuration parameters, the agentic pipeline may generate an agent object that references the selected collection objects, the selected large language model, and any indicated tools or control-flow logic. Once generated, the agent object may be deployed as an endpoint configured to respond to user queries using the referenced vector embeddings and the indicated agent logic.

In some examples, the agentic pipeline may enable an agent object to determine, based on characteristics of a received query, which collection objects or vector configuration objects are to be used to retrieve vector embeddings for grounding a response. In additional examples, the agentic pipeline may allow an agent object to invoke multiple tools, perform multiple retrieval operations, or coordinate multiple large language model calls as part of a multi-step reasoning process. Further, the agentic pipeline may enforce access-control constraints associated with each collection object such that an agent object is prevented from accessing vector embeddings generated from source documents for which a requesting user does not have permission. In this manner, incorporating an agentic pipeline into the RAG application development pipeline may enable the creation of agents that integrate retrieval operations, large language model reasoning, and external tool invocation while preserving security constraints.

An example of an agentic workflow may be illustrated with reference to FIG. 27Z-1. At 2781A, a RAG application development service implementing the agentic workflow may acquire and load source documents and, at 2781B, the RAG application development service may organize the loaded source documents into various collections (e.g., various collection objects as described herein) for document processing. At 2781C, the RAG application development service may create an agent to support a target workflow. The uploading of source documents, the organizing of source documents into collection objects, and the creation of an agent may be performed via user input as described herein. Once the agent is created, the agent at 2781D may be capable of receiving API calls from a calling application and, upon receiving the API call, may return a response that the calling application may display at 2781E.

It shall also be noted that the system and methods of the embodiments and variations described herein can be embodied and/or implemented at least in part as a machine comprising a computer-readable medium storing computer-readable instructions. The instructions may be executed by computer-executable components integrated with the system and one or more portions of the processors and/or the controllers. The computer-readable medium can be stored on any suitable computer-readable media such as RAMs, ROMs, flash memory, EEPROMs, optical devices (CD or DVD), hard drives, floppy drives, memory sticks (e.g., SD cards, USB flash drives), cloud-based services (e.g., cloud storage), magnetic storage devices, Solid-State Drives (SSDs), or any suitable device. The computer-executable component is preferably a general or application-specific processor, but any suitable dedicated hardware or hardware/firmware combination device can alternatively or additionally execute the instructions.

It shall be noted that, in the method(s) described herein where one or more steps (e.g., processes) are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The systems and methods of the preferred embodiments may additionally, or alternatively, be implemented on an integrated data analytics software application and/or software architecture such as those offered by SAS Institute Inc. of Cary, N.C., USA. Merely for illustration, the systems and methods of the preferred embodiments may be implemented using or integrated with one or more SAS software tools such as SAS® Viya™ which is developed and provided by SAS Institute Inc. of Cary, N.C., USA.

Although omitted for conciseness, the preferred embodiments include every combination and permutation of the implementations of the systems and methods described herein in real-time or near real-time, asynchronously (e.g., sequentially), concurrently (e.g., in parallel), or in any other suitable order by and/or using one or more instances of the systems, elements, and/or entities described herein. It shall be noted that “real-time” or “near real-time” as generally used herein may refer to generating an output or performing an action within strict time constraints. For example, in one or more embodiments, real-time may be understood to be instantaneous, on the order of milliseconds, or on the order of minutes. Of course, depending on the particular temporal nature of the system in which an embodiment is implemented, other appropriate timescales may be considered acceptable for real-time or near real-time processing.

Embodiments of the system and/or method can include every combination and permutation of the various system components and the various method processes, wherein one or more instances of the method and/or processes described herein can be performed in real-time or near real-time, asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the embodiments of the application without departing from the scope of the various described embodiments.

What is claimed is:

1. A computer-program product comprising a non-transitory machine-readable storage medium storing computer instructions that, when executed by processing circuity, perform operations comprising:
at a first stage of a retrieval-augmented-generation (RAG) application development pipeline:
receiving, at a graphical user interface displaying a collection object, a set of vector configuration parameters for controlling a vectorization of one or more unstructured data sources associated with the collection object;
in response to receiving the set of vector configuration parameters, generating, within the collection object, a vector configuration data object that includes the set of vector configuration parameters;
generating, using a vectorization service of the RAG application development pipeline, a plurality of vector embeddings that numerically represent the one or more unstructured data sources in response to the vectorization service receiving a request to perform the vectorization of the one or more unstructured data sources; and
associating the plurality of vector embeddings generated for the one or more unstructured data sources with the vector configuration data object;
at a second stage of the RAG application development pipeline:
executing an application performance assessment that assesses a behavior of a RAG application in generating responses based in part on the plurality of vector embeddings associated with the vector configuration data object; and
electing the vector configuration data object as a champion vector configuration based on application performance findings outputted by the application performance assessment; and
at a third stage of the RAG application development pipeline:
deploying the RAG application, wherein the RAG application is operably configured to respond to natural language input using a large language model and the champion vector configuration.

2. The computer-program product according to claim 1, wherein the computer instructions, when executed by the processing circuity, perform operations further comprising:
instantiating a vector configuration popover in response to receiving an input from a user selecting a new vector configuration button displayed on the graphical user interface, wherein:
the graphical user interface further displays the vector configuration popover, and
the vector configuration popover includes a set of user interface control elements that receives the set of vector configuration parameters from the user.

3. The computer-program product according to claim 1, wherein the set of vector configuration parameters includes:
a set of document ingestion parameters specifying which unstructured documents included in the one or more unstructured data sources are to be vectorized by the vectorization service,
a set of text extraction parameters that controls a text extraction process performed by the vectorization service, wherein the text extraction process extracts textual content from the unstructured documents,
a set of text chunking parameters that controls a text chunking process performed by the vectorization service, wherein the text chunking process segments the textual content into a plurality of text segments, and
a set of embedding generation parameters that controls an embedding generation process performed by the vectorization service, wherein the embedding generation process generates the plurality of vector embeddings based on the plurality of text segments.

4. The computer-program product according to claim 3, wherein the set of document ingestion parameters includes:
a set of prohibited file extensions selected by a user, wherein each unstructured document of the unstructured documents has a file extension that does not correspond to any file extension included in the set of prohibited file extensions, and
a text cleaning parameter that instructs the vectorization service to remove characters corresponding to a target character type from the textual content.

5. The computer-program product according to claim 3, wherein the set of text extraction parameters includes:
an optical character recognition (OCR) parameter that instructs the text extraction process to extract the textual content from the unstructured documents by executing an OCR process;
an OCR algorithm parameter that specifies a target OCR algorithm of a plurality of predetermined OCR algorithms to be used by the OCR process for extracting the textual content from the unstructured documents, and
an OCR language parameter that specifies a human language associated with the unstructured documents.

6. The computer-program product according to claim 5, wherein the set of text extraction parameters further includes:
a data table parameter that instructs the text extraction process to extract data tables from the unstructured documents by executing a tabular data extraction process;
a borderless data table detection parameter that instructs the tabular data extraction process to detect and extract borderless-type data tables from the unstructured documents,
a data table export parameter that specifies a target format for representing the data tables and the borderless-type data tables extracted from the unstructured documents, and
a data table detection sensitivity value, wherein the tabular data extraction process uses the data table detection sensitivity value to control whether a respective portion of the unstructured documents is detected as a tabular data structure.

7. The computer-program product according to claim 6, wherein the set of text extraction parameters further includes:
an implicit row detection parameter that instructs the tabular data extraction process to detect and extract tabular rows included in the unstructured documents that are not explicitly separated by row boundaries, and
an implicit column detection parameter that instructs the tabular data extraction process to detect and extract tabular columns included in the unstructured documents that are not explicitly separated by column boundaries.

8. The computer-program product according to claim 3, wherein the set of text chunking parameters includes:
a maximum text chunk size value,
a minimum text chunk size value, and
a text chunk overlap value, wherein the maximum text chunk size value, the minimum text chunk size value, and the text chunk overlap value instruct the text chunking process to generate each of the plurality of text segments (i) between the maximum text chunk size value and the minimum text chunk size value and (ii) includes one or more text strings of a preceding text segment based on the text chunk overlap value.

9. The computer-program product according to claim 3, wherein the set of embedding generation parameters includes:
an embedding model parameter that instructs the embedding generation process to generate the plurality of vector embeddings using a target embedding model,
a vector compression parameter that instructs the embedding generation process to execute a vector compression operation on the plurality of vector embeddings,
a vector quantization parameter that instructs the embedding generation process to execute a vector quantization operation on the plurality of vector embeddings,
a vector storage parameter that instructs , and
a vector synchronization parameter that instructs the vectorization service to automatically execute a vector update operation of a plurality of predefined vector update operations in response to detecting a modification to the one or more unstructured data sources.

10. The computer-program product according to claim 9, wherein:
the modification to the one or more unstructured data sources includes adding a new document to the one or more unstructured data sources, and
in response to detecting the new document added to the one or more unstructured data sources, automatically executing the vector update operation, wherein automatically executing the vector update operation includes:
automatically generating, using the target embedding model, a new set of vector embeddings that numerically represents the new document; and
adding the new set of vector embeddings to the target vector database.

11. The computer-program product according to claim 9, wherein:
the modification to the one or more unstructured data sources includes adding a new document to the one or more unstructured data sources, and
in response to detecting the new document added to the one or more unstructured data sources, automatically executing the vector update operation, wherein automatically executing the vector update operation includes:
automatically removing, from the target vector database, the plurality of vector embeddings that corresponds to the unstructured documents;
automatically generating, using the target embedding model, a new set of vector embeddings that numerically represents the new document; and
automatically adding the new set of vector embeddings to the target vector database.

12. The computer-program product according to claim 9, wherein:
the modification to the one or more unstructured data sources includes modifying a text string included in one of the unstructured documents to a modified text string, and
in response to detecting the modification to the one of the unstructured documents, automatically executing the vector update operation, wherein automatically executing the vector update operation includes:
automatically generating, using the target embedding model, an additional vector embedding that corresponds to the modified text string; and
adding the additional vector embedding that numerically represents the modified text string to the target vector database.

13. The computer-program product according to claim 9, wherein:
the modification to the one or more unstructured data sources includes modifying a text string included in one of the unstructured documents to a modified text string, and
in response to detecting the modification to the one of the unstructured documents, automatically executing the vector update operation, wherein automatically executing the vector update operation includes:
automatically removing, from the target vector database, a respective vector embedding of the plurality of vector embeddings that corresponds to the text string of the one of the unstructured documents;
automatically generating, using the target embedding model, an additional vector embedding that corresponds to the modified text string; and
automatically adding the additional vector embedding that numerically represents the modified text string to the target vector database.

14. The computer-program product according to claim 9, wherein:
the computer instructions, when executed by the processing circuity, perform operations further comprising:
instantiating a vectorization job configuration popover that is overlaid on the graphical user interface;
receiving, at the vectorization job configuration popover, a set of job execution parameters instructing the vectorization service to configure an Open Neural Network Exchange (ONNX) inference session, wherein the set of job execution parameters include:
a central processing unit parameter that specifies a total number of central processing units to allocate to the ONNX inference session,
a memory parameter that specifies a total amount of memory to allocate to the ONNX inference session,
an execution provider parameter that specifies a target execution provider for the ONNX inference session, and
a device parameter that specifies a compute device compatible with the target execution provider; and
the request to perform the vectorization of the one or more unstructured data sources includes the set of job execution parameters.

15. The computer-program product according to claim 14, wherein the computer instructions, when executed by the processing circuity, perform operations further comprising:
in response the vectorization service receiving the request to perform the vectorization of the one or more unstructured data sources:
configuring the ONNX inference session based on the set of job execution parameters; and
executing, using the ONNX inference session, the target embedding model based on providing the plurality of text segments to the target embedding model, wherein the plurality of vector embeddings are generated in response to the target embedding model processing the plurality of text segments.

16. The computer-program product according to claim 14, wherein:
the vectorization service performs the vectorization of the one or more unstructured data sources in accordance with the set of job execution parameters and the set of vector configuration parameters.

17. The computer-program product according to claim 1, wherein the computer instructions, when executed by the processing circuity, perform operations further comprising:
before executing the application performance assessment that assesses the behavior of the RAG application:
receiving, at an application assessment configuration user interface, a set of application assessment tests created by a user, wherein a respective application assessment test of the set of application assessment tests includes:
a respective query to provide to the RAG application when executing the application performance assessment,
a set of output tokens the user requires to be included in a target response generated by the RAG application when the RAG application processes the respective query, and
a test passage criterion specifying a minimum percentage of required output tokens that must appear in the target response to pass the respective application assessment test.

18. The computer-program product according to claim 17, wherein:
executing the respective application assessment test of the set of application assessment tests includes:
providing the respective query of the respective application assessment test to the RAG application;
converting, using an embedding model of the RAG application, the respective query to an embedding value;
detecting, by the RAG application, a subset of vector embeddings of the plurality of vector embeddings that have a vector distance within a predefined distance threshold of the embedding value associated with the respective query;
retrieving, by the RAG application, textual content that corresponds to the subset of vector embeddings;
providing, by the RAG application, the respective query of the respective application assessment test and the textual content that corresponds to the subset of vector embeddings to the large language model;
generating, using the large language model of the RAG application, a corresponding response to the respective query based on the large language model receiving the respective query of the respective application assessment test and the textual content that corresponds to the subset of vector embeddings; and
outputting a test assessment finding indicating whether the corresponding response satisfies the test passage criterion.

19. The computer-program product according to claim 1, wherein:
executing the application performance assessment includes executing a set of application assessment tests created by a user,
the computer instructions, when executed by the processing circuity, perform operations further comprising:
in response to executing the set of application assessment tests created by the user, generating an aggregated test assessment finding that indicates a total number of application assessment tests of the set of application assessment tests passed by the RAG application relative to a total number of tests in the set of application assessment tests; and
displaying, on the graphical user interface, a representation of the vector configuration data object in association with the aggregated test assessment finding.

20. The computer-program product according to claim 1, wherein the computer instructions, when executed by the processing circuity, perform operations further comprising:
instantiating, within the graphical user interface displaying the collection object, an automated test generation popover in response to receiving an input from a user selecting an automated test generation button displayed on the graphical user interface;
receiving, from the user at the automated test generation popover, one or more test generation parameters that control an automated generation of a set of application assessment tests, wherein the one or more test generation parameters includes:
a data source coverage parameter specifying a maximum percentage of content from the one or more unstructured data sources to be tested by the set of application assessment tests,
a large language model parameter that specifies a target large language model for generating the set of application assessment tests, and
a reference configuration parameter that specifies the vector configuration data object to be used by the RAG application during execution of the set of application assessment tests; and
in response to the RAG application development pipeline receiving the one or more test generation parameters, automatically generating, using the target large language model, the set of application assessment tests.

21. The computer-program product according to claim 20, wherein:
executing the application performance assessment includes executing the set of application assessment tests created by the target large language model,
the computer instructions, when executed by the processing circuity, perform operations further comprising:
computing a RAG application performance efficacy value for the RAG application in response to executing the set of application assessment tests created by the target large language model, and
displaying, on the graphical user interface, a representation of the vector configuration data object in association with the RAG application performance efficacy value.

22. The computer-program product according to claim 1, wherein the computer instructions, when executed by the processing circuity, perform operations further comprising:
computing a first application performance efficacy value for the RAG application in response to executing the application performance assessment; and
before electing the vector configuration data object as the champion vector configuration:
generating, within the collection object, a second vector configuration data object based on a second set of vector configuration parameters provided by a user;
executing, using the vectorization service, a second vectorization of the one or more unstructured data sources in accordance with the second set of vector configuration parameters;
automatically associating a second plurality of vector embeddings generated from the second vectorization of the one or more unstructured data sources with the second vector configuration data object;
automatically configuring the RAG application to use the second plurality of vector embeddings associated with the second vector configuration data object instead of the plurality of vector embeddings associated with the vector configuration data object;
automatically executing a second application performance assessment that assesses a response generation behavior of the RAG application configured to use the second plurality of vector embeddings; and
automatically computing, in response to executing the second application performance assessment, a second application performance efficacy value for the RAG application configured to use the second plurality of vector embeddings.

23. The computer-program product according to claim 22, wherein the computer instructions, when executed by the processing circuity, perform operations further comprising:
displaying, on the graphical user interface displaying the collection object, (i) a representation of the vector configuration data object in association with the first application performance efficacy value and (ii) a representation of the second vector configuration data object in association with the second application performance efficacy value, wherein:
the vector configuration data object is elected as the champion vector configuration based on the first application performance efficacy value being greater than the second application performance efficacy value.

24. The computer-program product according to claim 23, wherein:
the first application performance efficacy value includes a first retrieval-augmented generation assessment score (RAGAS) value, and
the second application performance efficacy value includes a second retrieval-augmented generation assessment score (RAGAS) value.

25. The computer-program product according to claim 1, wherein the computer instructions, when executed by the processing circuity, perform operations comprising:
receiving, from a user, a request to generate the collection object, wherein the collection object is generated in response to the RAG application development pipeline receiving the request to generate the collection object; and
in response to generating the collection object:
automatically generating a user access security policy controlling user access to the collection object; and
automatically configuring the user access security policy to include a user account of the user, wherein adding the user account to the user access security policy authorizes the user to access, modify, and manage the collection object.

26. The computer-program product according to claim 25, wherein the computer instructions, when executed by the processing circuity, perform operations further comprising:
receiving, from the user, a request to grant an additional user access to the collection object; and
in response to receiving the request to grant the additional user access to the collection object, adapting the user access security policy to authorize the additional user to access and modify the collection object.

27. The computer-program product according to claim 1, wherein the computer instructions, when executed by the processing circuity, perform operations further comprising:
before electing the vector configuration data object as the champion vector configuration:
computing a respective RAG application performance efficacy value for the RAG application that generates the responses based in part on the plurality of vector embeddings associated with the vector configuration data object;
generating, within the collection object, a plurality of additional vector configuration data objects, wherein each additional vector configuration data object of the plurality of additional vector configuration data objects:
corresponds to a distinct set of vector configuration parameters received from a user via the graphical user interface, and
is associated with a distinct set of vector embeddings that numerically represent the one or more unstructured data sources, wherein the vectorization service generates the distinct set of vector embeddings by performing a respective vectorization of the one or more unstructured data sources according to the distinct set of vector configuration parameters;
executing, for each additional vector configuration data object of the plurality of additional vector configuration data objects, a respective application performance assessment assessing a response generation behavior of a corresponding instance of the RAG application operably configured to use the distinct set of vector embeddings corresponding to that additional vector configuration data object; and
attributing, to each additional vector configuration data object of the plurality of additional vector configuration data objects, a respective RAG application performance efficacy value that quantitatively represents the response generation behavior of the RAG application when using the distinct set of vector embeddings associated with that additional vector configuration data object, wherein:
the vector configuration data object associated with the plurality of vector embeddings is elected as the champion vector configuration based on the RAG application performance efficacy value computed for the vector configuration data object associated with the plurality of vector embeddings being greater than the respective RAG application performance efficacy values attributed to each of the plurality of additional vector configuration data objects.

28. The computer-program product according to claim 27, wherein:
executing the application performance assessment that assesses the behavior of the RAG application in generating the responses based in part on the plurality of vector embeddings associated with the vector configuration data object includes executing a first set of application assessment tests created by the user and a second set of application assessment tests created by a machine learning model, and
executing, for each additional vector configuration data object of the plurality of additional vector configuration data objects, the respective application performance assessment assessing the response generation behavior of the corresponding instance of the RAG application includes executing the first set of application assessment tests created by the user and the second set of application assessment tests created by the machine learning model.

29. A computer-implemented method, comprising:
at a first stage of a retrieval-augmented-generation (RAG) application development pipeline:
receiving, at a graphical user interface displaying a collection object, a set of vector configuration parameters for controlling a vectorization of one or more unstructured data sources associated with the collection object;
in response to receiving the set of vector configuration parameters, generating, within the collection object, a vector configuration data object that includes the set of vector configuration parameters;
generating, using a vectorization service of the RAG application development pipeline, a plurality of vector embeddings that numerically represent the one or more unstructured data sources in response to the vectorization service receiving a request to perform the vectorization of the one or more unstructured data sources; and
associating the plurality of vector embeddings generated for the one or more unstructured data sources with the vector configuration data object;
at a second stage of the RAG application development pipeline:
executing an application performance assessment that assesses a behavior of a RAG application in generating responses based in part on the plurality of vector embeddings associated with the vector configuration data object; and
electing the vector configuration data object as a champion vector configuration based on application performance findings outputted by the application performance assessment; and
at a third stage of the RAG application development pipeline:
deploying the RAG application, wherein the RAG application is operably configured to respond to natural language input using a large language model and the champion vector configuration.

30. A computer-implemented system comprising:
processing circuitry;
a memory; and
a computer-readable medium operably coupled to the processing circuitry the computer-readable medium having computer-readable instructions stored thereon that, when executed by the processing circuitry, cause a computing device to perform operations comprising:
at a first stage of a retrieval-augmented-generation (RAG) application development pipeline:
receiving, at a graphical user interface displaying a collection object, a set of vector configuration parameters for controlling a vectorization of one or more unstructured data sources associated with the collection object;
in response to receiving the set of vector configuration parameters, generating, within the collection object, a vector configuration data object that includes the set of vector configuration parameters;
generating, using a vectorization service of the RAG application development pipeline, a plurality of vector embeddings that numerically represent the one or more unstructured data sources in response to the vectorization service receiving a request to perform the vectorization of the one or more unstructured data sources; and
associating the plurality of vector embeddings generated for the one or more unstructured data sources with the vector configuration data object;
at a second stage of the RAG application development pipeline:
executing an application performance assessment that assesses a behavior of a RAG application in generating responses based in part on the plurality of vector embeddings associated with the vector configuration data object; and
electing the vector configuration data object as a champion vector configuration based on application performance findings outputted by the application performance assessment; and
at a third stage of the RAG application development pipeline:
deploying the RAG application, wherein the RAG application is operably configured to respond to natural language input using a large language model and the champion vector configuration.
